(19) United States
(12) Patent Application Publication
(10) Pub. No.: US 2026/0113485 A1
(43) Pub. Date: Apr. 23, 2026

(54) ENCODING METHOD, DECODING METHOD, CODE STREAM, ENCODER, DECODER, AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(73) Assignee: GUANGDONG OPPO MOBILE TELECOMMUNICATIONS CORP., LTD., Dongguan (CN)

(21) Appl. No.: 19/423,914

(22) Filed: Dec. 17, 2025

Related U.S. Application Data
(63) Continuation of application No. PCT/CN2023/106178, filed on Jul. 6, 2023.

(51) Int. Cl. H04N 19/61; H04N 19/105; H04N 19/167; H04N 19/187; H04N 19/196; H04N 19/33; H04N 19/597

(52) U.S. Cl. CPC H04N 19/61; H04N 19/105; H04N 19/167; H04N 19/187; H04N 19/196; H04N 19/33; H04N 19/597

(57) ABSTRACT

An encoding method, a decoding method and a storage medium are provided. The method includes: determining a first quantity of voxel nodes of a current unit and a second quantity of reconstruction nodes of the current unit, wherein the first quantity and the second quantity are used for determining whether to skip decoding the voxel nodes of the current unit; and on the basis of the first quantity and the second quantity, determining attribute reconstruction values of the voxel nodes of the current unit.

### CROSS-REFERENCE TO RELATED APPLICATION

This application is a continuation of International Patent Application No. PCT/CN2023/106178 filed on Jul. 6, 2023, the entire content of which is hereby incorporated by reference in its entirety.

### BACKGROUND

In the Geometry-based Point Cloud Compression (G-PCC) encoding and decoding framework, the geometric information and attribute information of the point cloud are coded separately. The attribute coding of the G-PCC may include: a Predicting Transform (PT), a Lifting Transform (LT) and a Region Adaptive Hierarchical Transform (RAHT).

During the RAHT transform, it is necessary to sequentially perform the transform, prediction, encoding and decoding and the like on nodes of each layer, which leads to an increase in the complexity of the encoding and decoding in the RAHT attribute transform, and further makes it impossible to effectively remove attribute redundancy, thereby resulting in low efficiency of attribute coding.

### SUMMARY

Embodiments of the present disclosure provide an encoding method, a decoding method and a storage medium.

The technical solutions of the embodiments of the present disclosure may be realized as follows.

In a first aspect, the embodiments of the present disclosure provide a decoding method. The method is applied to a decoder and includes the following operations.

A first number of voxel nodes of a current unit and a second number of reconstructed nodes of the current unit are determined. The first number and the second number are used to determine whether to skip decoding the voxel nodes of the current unit.

Reconstructed attribute values of the voxel nodes of the current unit are determined according to the first number and the second number.

In a second aspect, the embodiments of the present disclosure provide an encoding method.

The method is applied to an encoder and includes the following operations.

A first number of voxel nodes of a current unit and a second number of reconstructed nodes of the current unit are determined.

It is determined whether to skip encoding attribute information of the voxel nodes of the current unit according to the first number and the second number.

In a third aspect, an embodiment of the present disclosure provides a non-transitory computer-readable storage medium, having a computer program and a bitstream stored thereon. The computer program, when executed by a processor, enables the processor to perform operations of the encoding method in the second aspect to generate the bitstream.

### BRIEF DESCRIPTION OF THE DRAWINGS

FIG. 1A is a schematic diagram of a three-dimensional (3D) point cloud image.

FIG. 1B is a partial enlarged view of a three-dimensional point cloud image.

FIG. 2A is a schematic view of six viewing angles of a point cloud image.

FIG. 2B is a schematic diagram of a data storage format corresponding to a point cloud image.

FIG. 3 is a schematic diagram of a network architecture of point cloud encoding and decoding.

FIG. 4A is a schematic diagram of a component framework of a G-PCC encoder.

FIG. 4B is a schematic diagram of a component framework of a G-PCC decoder.

FIG. 5A is a schematic diagram of a position of a bottom virtual plane in a Z-axis direction.

FIG. 5B is a schematic diagram of a position of a top virtual plane in a Z-axis direction.

FIG. 6 is a schematic diagram of a sequence of node encoding.

FIG. 7A is a schematic diagram of planar mode information.

FIG. 7B is another schematic diagram of planar mode information.

FIG. 8 is a schematic diagram of sibling nodes of a current node.

FIG. 9 is a schematic diagram of the intersections of lidars and a node.

FIG. 10 is a schematic diagram of neighbouring nodes at the same partitioning depth and the same coordinates.

FIG. 11 is schematic diagrams of current nodes located at positions of the bottom virtual plane of parent nodes.

FIG. 12 is schematic diagrams of current nodes located at positions of the top virtual plane of parent nodes.

FIG. 13 is a schematic diagram of prediction coding of plane position information of a lidar point cloud.

FIG. 14 is a schematic diagram of an Infer Direct Coding Model (IDCM) coding.

FIG. 15 is a schematic diagram of coordinate transform of a point cloud obtained by a rotating lidar.

FIG. 16 is a schematic diagram of prediction coding in an X-axis direction or a Y-axis direction.

FIG. 17A is a schematic diagram of a Y-plane angle prediction through horizontal azimuth.

FIG. 17B is a schematic diagram of an X-plane angle prediction through horizontal azimuth.

FIG. 18 is another schematic diagram of prediction coding in an X-axis direction or a Y-axis direction.

FIG. 19A is a schematic diagram of three intersection points included in a sub-block.

FIG. 19B is a schematic diagram of a triangle soup (trisoup) fitted by using three intersection points.

FIG. 19C is an upsampling diagram of a trisoup.

FIG. 20 is a schematic diagram of a distance-based Level of Detail (LOD) construction process.

FIG. 21 is a schematic diagram of a visualization result of a LOD generation process.

FIG. 22 is a schematic diagram of an encoding flow of attribute prediction.

FIG. 23 is a schematic diagram of a composition of a pyramid structure.

FIG. 24 is another schematic diagram of a composition of a pyramid structure.

FIG. 25 is a schematic diagram of an LOD structure for inter-layer nearest neighbouring search.

FIG. 26 is a schematic diagram of a nearest neighbouring search structure based on a spatial relationship.

FIG. 27A is a schematic diagram of a coplanar spatial relationship.

FIG. 27B is a schematic diagram of a coplanar and collinear spatial relationship.

FIG. 27C is a schematic diagram of a coplanar, collinear and concurrent spatial relationship.

FIG. 28 is a schematic diagram of an inter-layer prediction based on fast search.

FIG. 29 is a schematic diagram of an LOD structure of intra-layer nearest neighbouring search of attributes.

FIG. 30 is a schematic diagram of intra-layer prediction based on fast search.

FIG. 31 is a schematic diagram of a block-based neighbouring search structure.

FIG. 32 is a schematic diagram of an encoding flow of a lifting transform.

FIG. 33 is a schematic diagram of a RAHT transform structure.

FIG. 34 is a schematic diagram of a transform process of a RAHT along x, y and z directions.

FIG. 35A is a schematic diagram of a process of a RAHT forward transform.

FIG. 35B is a schematic diagram of a process of a RAHT inverse transform.

FIG. 36 is a schematic structural diagram of an attribute coding block.

FIG. 37 is an overall flow diagram of a RAHT attribute prediction transform coding.

FIG. 38 is a schematic diagram of a neighbouring prediction relationship of a current block.

FIG. 39 is a schematic diagram of a calculation process of an attribute transform coefficient.

FIG. 40 is a schematic structural diagram of a RAHT attribute inter-prediction coding.

FIG. 41 is a first schematic flowchart of a decoding method according to an embodiment of the present disclosure.

FIG. 42 is a schematic structural diagram of an RAHT attribute coding layer according to an embodiment of the present disclosure.

FIG. 43 is a second schematic flowchart of a decoding method according to an embodiment of the present disclosure.

FIG. 44 is a first schematic flowchart of an encoding method according to an embodiment of the present disclosure.

FIG. 45 is a second schematic flowchart of an encoding method according to an embodiment of the present disclosure.

FIG. 46 is a third schematic flowchart of an encoding method according to an embodiment of the present disclosure.

FIG. 47 is a schematic diagram of a structural composition of an encoder according to an embodiment of the present disclosure.

FIG. 48 is a schematic diagram of a specific hardware structure of an encoder according to an embodiment of the present disclosure.

FIG. 49 is a schematic diagram of a structural composition of a decoder according to an embodiment of the present disclosure.

FIG. 50 is a schematic diagram of a specific hardware structure of a decoder according to an embodiment of the present disclosure.

FIG. 51 is a schematic diagram of a structural composition of an encoding and decoding system according to an embodiment of the present disclosure.

### DETAILED DESCRIPTION

In order to enable a more detailed understanding of the features and technical contents of the embodiments of the present disclosure, implementations of the embodiments of the present disclosure will be described in detail below in conjunction with the accompanying drawings. The accompanying drawings are provided solely for purposes of reference and illustration and are not intended to limit the embodiments of the present disclosure.

Unless otherwise defined, all technical and scientific terms used herein have the same meaning as commonly understood by those skilled in the technical field of the present disclosure. The terms used herein are only for the purpose of describing the embodiments of the present disclosure, and is not intended to limit the present disclosure.

In the following description, reference is made to “some embodiments”, which describe a subset of all possible embodiments. However, it can be understood that “some embodiments” may refer to the same subset or different subsets of all possible embodiments, and may be combined with each other without conflict.

It should be noted that the terms “first\ second\ third” involved in embodiments of the present disclosure are only used to distinguish similar objects and do not represent a specific order. It can be understood that such used “first\ second\ third” may be interchanged in specific order or sequence where permitted, so that the embodiments of the present disclosure described herein may be implemented in an order other than those illustrated or described herein.

A point cloud is a three-dimensional representation of a surface of an object. The point cloud (data) on the surface of the object may be collected through photoelectric radar, lidar, laser scanner, multi-view camera and other acquisition devices.

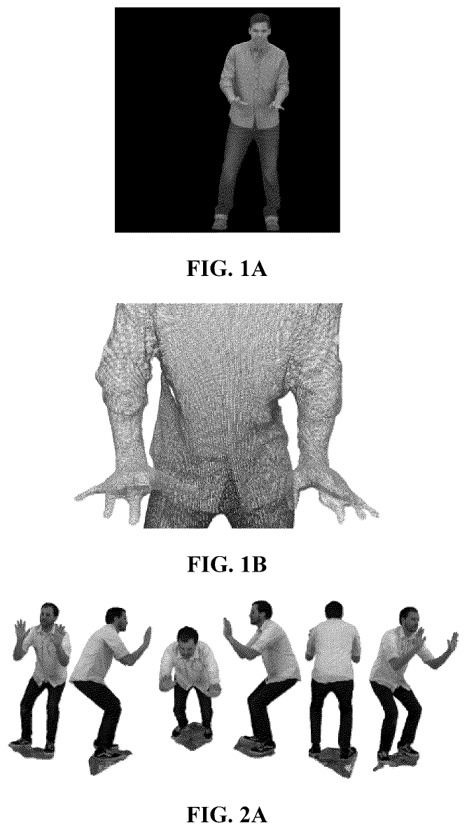

The point cloud is a set of irregularly distributed discrete points in space that express the spatial structure and surface attribute of three-dimensional objects or scenes. FIG. 1A illustrates a three-dimensional point cloud image and FIG. 1B illustrates a partial enlarged view of the three-dimensional point cloud image. It can be seen that the surface of the point cloud is composed of densely distributed points.

The two-dimensional image contains information expression at each pixel and has a regular distribution. Therefore, there is no need to record its position information additionally. However, the distribution of points in the point cloud in the three-dimensional space is random and irregular. Therefore, it is necessary to record the respective position of each point in the space, so as to completely express the point cloud. Similar to two-dimensional images, there exists corresponding attribute information at each position in the acquisition process, which is usually an RGB colour value. The colour value reflects the colour of the object. For a point cloud, in addition to colour information, a common type of the attribute information corresponding to each point is the reflectance value, which reflects the surface material of the object. Therefore, the point cloud data usually includes position information of the point and attribute information of the point. The position information of the point may also be referred to as the geometric information of the point. For example, the geometric information of the point may be three-dimensional coordinate information (x, y, z) of the point. The attribute information of the point may include colour information and/or reflectance, and the like. For example, the reflectance may be one-dimensional reflectance information (r). The colour information may be information in any colour space, or the colour information may be three-dimensional colour information, such as RGB information. Here, R denotes Red (R), G denotes Green (G), and B denotes Blue (B). As another example, the colour information may be luma chroma (YCbCr, YUV) information. Here. Y represents brightness (Luma), Cb (U) represents blue colour aberration, and Cr (V) represents red colour aberration.

The points in the point cloud obtained according to the principle of laser measurement may include the three-dimensional coordinate information of the points and the reflectance values of the points. For another example, for a point cloud obtained according to a principle of photogrammetry, each of the points in the point cloud may include three-dimensional coordinate information of the point and colour information of the point. For another example, the points in the point cloud obtained by combining the principles of laser measurement and photogrammetry may include the three-dimensional coordinate information of the points, the reflectance values of the points, and the three-dimensional colour information of the points.

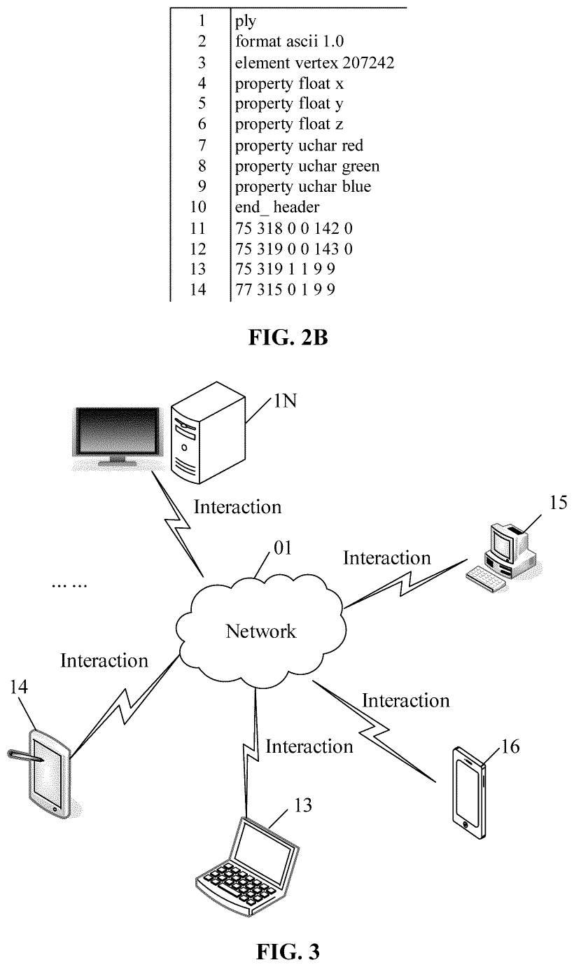

FIGS. 2A and 2B illustrate a point cloud image and data storage format corresponding to the point cloud image. FIG. 2A provides six viewing angles of the point cloud image, and FIG. 2B is composed of a file header information part and a data part. The header information includes a data format, a data representation type, a total number of the points in the point cloud, and a content represented by the point cloud. For example, the point cloud is in the format of “.ply” and represented by ASCII code, with a total number of points of 207242. Each point has three-dimensional coordinate information (x, y, z) and three-dimensional colour information (r, g, b).

The point clouds may be classified, based on the acquisition methods, into a static point cloud, a dynamic point cloud, and a dynamically acquired point cloud.

For the static point cloud, the object is stationary, and the device that acquires the point cloud is also stationary.

For the dynamic point cloud, the object is in motion, but the device that acquires the point cloud is stationary.

For the dynamically acquired point cloud, the device that acquires the point cloud is in motion.

For example, the point cloud is classified into the following two categories based on the application purposes.

First category: a Machine-perceived point cloud, which may be used in scenarios such as autonomous navigation systems, real-time inspection systems, geographic information systems, visual sorting robots, emergency rescue and disaster relief robots.

Second category: human eye-perceived point cloud, which may be used in point cloud application scenarios such as digital cultural heritage, free viewpoint broadcasting, three-dimensional immersive communication, and three-dimensional immersive interaction.

The point cloud may flexibly and conveniently express the spatial structure and surface attribute of three-dimensional objects or scenes. Because the point cloud is obtained by directly sampling real objects, it can provide a strong sense of realism on the premise of ensuring accuracy and is widely used. The application scenario includes the virtual reality games, the computer-aided design, the geographic information systems, the automatic navigation systems, the digital cultural heritage, the free viewpoint broadcasting, the three-dimensional immersive telepresentation, the three-dimensional reconstruction of biological tissues and organs, etc.

The acquisition of the point cloud mainly includes the following manners: computer generation. 3D laser scanning. 3D photogrammetry, etc. The computers may generate the point clouds of virtual three-dimensional objects and scenes. The 3D laser scanning may obtain the point clouds of static real-world three-dimensional objects or scenes, and millions of point clouds may be obtained per second. The 3D photogrammetry may obtain the point clouds of dynamic real-world three-dimensional objects or scenes, and tens of millions of point clouds may be obtained per second. These technologies reduce the cost and time period of the acquisition of the point cloud data, and improve the accuracy of data. The change of acquisition method of the point cloud data makes it possible to acquire a large amount of point cloud data. With the growth of application demand, the processing of massive 3D point cloud data encounters the bottleneck imposed by the storage space and the transmission bandwidth.

Exemplarily, taking a point cloud video with a frame rate of 30 frames per second (fps) as an example, the number of points in each frame of the point cloud is 700.000, and each point has the coordinate information xyz (float) and the colour information RGB (uchar), then the data amount of the 10s point cloud video is about 0.7 million×(4 Byte×3+1 Byte×3)×30 fps×10s=3.15 GB. Here, 1 Byte is 10 bits. For a two-dimensional video with a YUV sampling format of 4:2:0, a frame rate of 24 fps and a resolution of 1280×720, the data amount for 10s is about 1280×720×12 bit×24 fps×10s=0.33 GB, and the data amount for 10s two-view three-dimensional video is about 0.33×2=0.66 GB. It can be seen that the data amount of the point cloud video far exceeds the data amount of the two-dimensional video and three-dimensional video of the same duration. Therefore, in order to better realize the data management, save the storage space for the server, and reduce the transmission traffic and transmission time between the server and the client, the point cloud compression has become a key issue in prompting the development of the point cloud industry.

In other words, because the point cloud is a collection of massive points, storing the point cloud will not only consume a large amount of memory, but also be not conducive to transmission. In addition, there is no such large bandwidth to support the direct transmission of the point cloud at the network layer without compression. Therefore, the point cloud needs to be compressed.

At present, the point cloud coding framework that may compress the point cloud may be a Geometry-based Point Cloud Compression (G-PCC) coding framework or a Video-based Point Cloud Compression (V-PCC) coding framework provided by the Moving Picture Experts Group (MPEG), or may be the Audio Video Coding Standard-Point Cloud Compression (AVS-PCC) coding framework provided by the Audio Video coding Standard (AVS). The G-PCC coding framework may be used to compress the first type of static point cloud and the third type of the dynamically acquired point cloud, which may be based on the point cloud compression test platform (Test Model Compression 13. TMC13). The V-PCC coding framework may be used to compress the second type of dynamic point cloud, which may be based on the point cloud compression test platform (Test Model Compression 2. TMC2). Therefore, the G-PCC coding framework is also referred to as the point cloud codec TMC13, and the V-PCC coding framework is also referred to as the point cloud codec TMC2.

The embodiments of the present disclosure provide a network architecture of a point cloud encoding and decoding system including a decoding method and an encoding method. FIG. 3 illustrates a schematic diagram of a network architecture of the point cloud encoding and decoding system according to the embodiment of the present disclosure. As illustrated in FIG. 3, the network architecture includes one or more electronic devices (i.e., electronic device 13 to electronic device IN) and a communication network 01. The electronic device 13 to electronic device IN may conduct video interaction through the communication network 01. The electronic device may be various types of devices having point cloud encoding and decoding functions in the process of implementation. For example, the electronic device may include a mobile phone, a tablet computer, a personal computer, a personal digital assistant, a navigator, a digital telephone, a video telephone, a television, a sensing device, a server, and the like, which is not limited in the embodiments of the present disclosure. The decoder or encoder in the embodiments of the present disclosure may be the electronic device described above.

The electronic device in the embodiments of the present disclosure has the point cloud encoding and decoding function, and generally includes a point cloud encoder (i.e., an encoder) and a point cloud decoder (i.e., a decoder).

The following describes the related technology by taking the G-PCC coding framework as an example.

It may be understood that in the point cloud G-PCC encoding and decoding framework, the point cloud data to be encoded is first partitioned into multiple slices by slice partitioning. In each slice, the geometric information of the point cloud and the attribute information corresponding to each point are encoded separately.

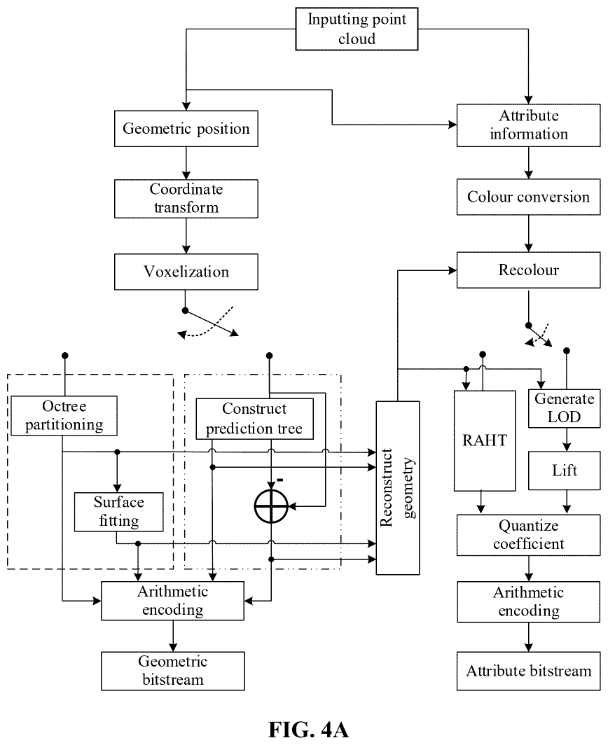

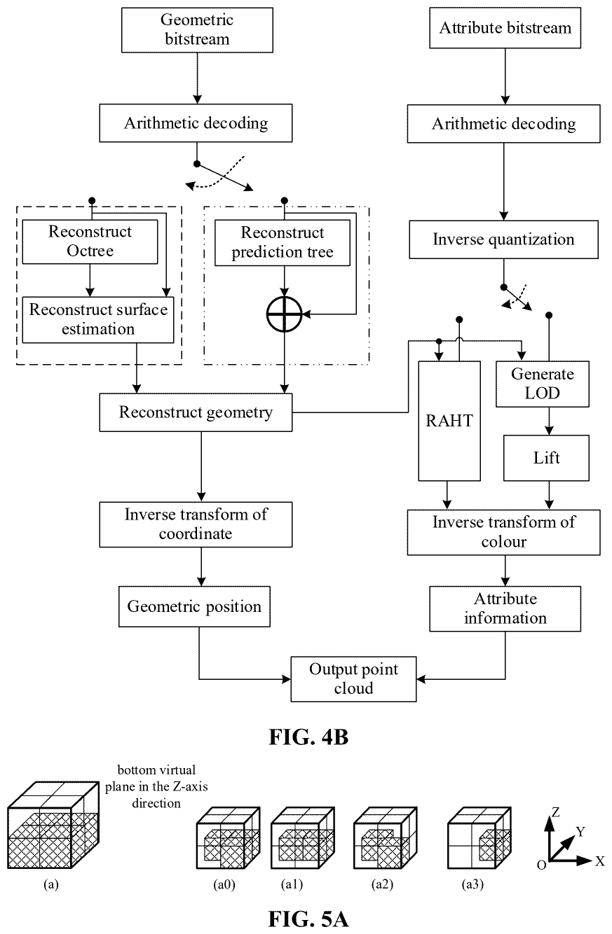

FIG. 4A illustrates a schematic diagram of a component framework of a G-PCC encoder. As illustrated in FIG. 4A, in the geometry encoding process, the coordinate transform is performed on the geometric information, so that all the point clouds are contained in a Bounding Box and then quantized. This operation of quantization mainly plays the role of scaling. Due to quantization and rounding, the geometric information of some point clouds is the same, and whether to remove duplicate points is decided based on the parameters. The process of quantizing and removing duplicate points is also referred to as the voxelization process. Then the octree partitioning or the construction of a prediction tree is performed on the bounding box. In this process, the points in the partitioned leaf nodes are arithmetically encoded to generate a binary geometric bitstream. Alternatively, the intersection points (Vertex) generated by the partition are arithmetically encoded (surface fitting is performed based on the intersection point) to generate a binary geometric bitstream. In the process of attribute encoding, after the geometry encoding is completed and the geometric information is reconstructed, it is necessary to perform colour conversion first to convert the colour information (i.e. attribute information) from the RGB colour space to the YUV colour space. Then, the point cloud is recoloured by using the reconstructed geometric information so that the unencoded attribute information corresponds to the reconstructed geometric information. The attribute encoding is mainly performed for the colour information. In the process of encoding the coulor information, there are mainly two transform methods. One is the distance-based lifting transform that relies on the Level of Detail (LOD) partitioning, and the other one is the direct Region Adaptive Hierarchal Transform (RAHT). These two methods will convert the colour information from the spatial domain to the frequency domain, obtain the high-frequency coefficients and the low-frequency coefficients through transform. Finally, the coefficients are quantized, and then arithmetically encoding is performed on the quantized coefficients to generate binary attribute bitstreams.

FIG. 4B illustrates a schematic diagram of a component framework of a G-PCC decoder. As illustrated in FIG. 4B, firstly, for the acquired binary bitstream, the geometric bitstream and the attribute bitstream in the binary bitstream are decoded independently and respectively. When decoding the geometric bitstream, the geometric information of the point cloud is obtained by arithmetic decoding-reconstructing octree/reconstructing prediction tree-reconstructing geometry-inverse transform of coordinates. When decoding the attribute bitstream, the attribute information of the point cloud is obtained by arithmetic decoding-inverse quantization-LOD partition/RAHT-inverse transform of colour, and the point cloud data to be encoded is restored based on the geometric information and the attribute information (i.e. output the point cloud).

It should be noted that, as illustrated in FIG. 4A or FIG. 4B, the current geometry coding and decoding of the G-PCC may be divided into the Octree geometry coding and decoding (identified by a dashed line frame) and the prediction tree-based geometry coding and decoding (identified by a dotted line frame).

The Octree geometry encoding (OctGeomEnc) includes the following operations. Firstly, coordinate transform is performed on the geometric information so that all point clouds are contained in a bounding box, and then quantization is performed. The operation of quantization mainly plays the role of scaling. Because of the quantization and rounding, the geometric information of some points is the same. Whether to remove duplicate points is decided based on the parameters. The process of quantizing and removing duplicate points is also referred to as Voxelization process. Next, the tree partitioning (such as octree, quadtree, binary tree, etc.) is continuously performed on the bounding box in the order of breadth-first traversal, and the occupancy code of each node is encoded. In the related art, a company proposed an implicit geometry partition method. Firstly, the bounding box (2^{d}^{ₓ}, 2^{d}^{_{y}}, 2^{d}^{_{z}}) of the point cloud is calculated. It is assumed that dₓ>d_{y}>d_{z} and the bounding box corresponds to a cuboid. When performing the geometric partitioning, firstly, the binary tree partitioning is continuously performed based on the x-axis to obtain two child nodes. When the condition dₓ=d_{y}>d_{z} is met, the quad tree partitioning is continuously performed based on the x and y axes to obtain four child nodes. Finally, when the condition dₓ=d_{y}=d_{z} is met, the octree partitioning is continuously performed until the leaf nodes obtained through partitioning are unit cubes of 1×1×1, at which point the partitioning stops. The points in the leaf nodes are encoded to generate a binary bitstream. In the process of binary tree/quadtree/octree partitioning, two parameters (i.e., K and M) are introduced. The parameter K indicates the maximum number of the binary tree partitioning/quadtree partitioning before the octree partitioning is performed. The parameter M is configured to indicate that the corresponding minimum block side length is 2^{M} when performing the binary tree partitioning/quadtree partitioning. K and M must meet the following conditions: assuming that dₘₐₓ=max(dₓ, d_{y}, d_{z}) and dₘᵢₙ=min(dₓ, d_{y}, d_{z}), the parameter K meets the condition that K≥dₘₐₓ−dₘᵢₙ and the parameter M meets the condition that M≥dₘᵢₙ. The reason why the parameters K and M meet the above conditions is that in the process of the geometric implicit partitioning of the G-PCC at present, the priority of the partitioning methods is binary tree, quadtree and octree. When the node block size does not meet the condition of binary tree/quadtree, the octree partitioning is continuously performed on the node until the smallest unit 1×1×1 of leaf nodes are obtained through the partition. The OctGcomEnc mode can effectively encode the geometric information of point cloud by using the correlation between neighbouring points in space. However, for some flat nodes or nodes with planar characteristics, the efficiency of the encoding of the geometric information of the point cloud can be further improved by using the planar encoding.

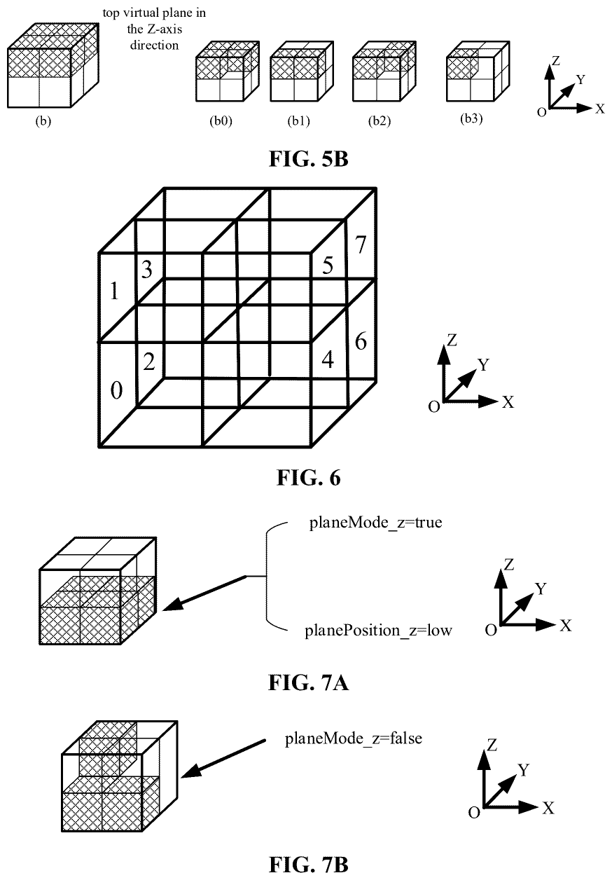

Exemplarily. FIG. 5A and FIG. 5B provide schematic diagrams of a position of a plane. FIG. 5A illustrates a schematic diagram of a position of the bottom virtual plane in the Z-axis direction, and FIG. 5B illustrates a schematic diagram of a position of the top virtual plane in the Z-axis direction. As illustrated in FIG. 5A, (a), (a0)), (a1), (a2), and (a3) here all belong to the positions of the bottom virtual plane in the Z-axis direction. Taking (a) as an example, it can be seen that the occupied four child nodes in the current node are all located at the position of the bottom virtual plane of the current node in the Z-axis direction, so it may be considered that the current node belongs to a Z-plane and is a bottom virtual plane in the Z-axis direction. Similarly, as illustrated in FIG. 5B, (b), (b0), (b1), (b2), and (b3) here all belong to the positions of the top virtual plane in the Z-axis direction. Taking (b) as an example, it may be seen that the four occupied child nodes in the current node are located at the position of the top virtual plane of the current node in the Z-axis direction, so it may be considered that the current node belongs to a Z-plane and is a top virtual plane in the Z-axis direction.

Further, taking (a) in FIG. 5A as an example, the efficiency of the octree encoding is compared with the efficiency of the planar encoding. FIG. 6 provides a schematic diagram of a sequence of node encoding, that is, node coding is performed in the sequence of 0, 1, 2, 3, 4, 5, 6, and 7 illustrated in FIG. 6. Here, if the octree encoding method is adopted for (a) in FIG. 5A, the occupancy information of the current node is represented as: 11001100. However, if the planar encoding method is adopted, firstly, an identifier needs to be encoded to indicate that the current node is a plane in the Z-axis direction, and secondly, if the current node is a plane in the Z-axis direction, the position of the plane of the current node needs to be represented. Secondly, only the occupancy information of the bottom virtual plane node (that is, the occupancy information of the four child nodes 0, 2, 4, and 6) in the Z-axis direction needs to be encoded. Therefore, only 6 bits need to be encoded to encode the current node based on the planar encoding method, which can reduce the representation by 2 bits compared with the octree encoding of related technologies. Based on this analysis, planar encoding has significant encoding efficiency compared with the octree encoding. Therefore, for an occupied node, if the planar encoding is used for encoding in a certain dimension, firstly, the planar mode (i.e., planarMode) information and the plane position (PlanePos) information of the current node in this dimension need to be represented, and secondly, the occupancy information of the current node needs to be encoded based on the plane information of the current node. Exemplarily. FIG. 7A illustrates a schematic diagram of planar mode information. As illustrated in FIG. 7A, the current node is a bottom virtual plane in the Z-axis direction. Correspondingly, the value of the plane mode information is true or 1, that is, planarMode_z=true. The plane position information is bottom virtual plane (low), that is. PlancPosition_z=low. FIG. 7B illustrates another schematic diagram of the planar mode information. As illustrated in FIG. 7B, the current node is not one plane in the Z-axis direction. Correspondingly, the value of the plane mode information is false or 0, that is, planarMode_z=false.

It should be noted that for PlaneMode_i: 0 denotes that the current node is not a plane in the i-axis direction, and 1 denotes that the current node is a plane in the i-axis direction. If the current node is a plane in the i-axis direction, for PlanePosition_i: 0 denotes that the current node is a plane in the i-axis direction and the plane position is a bottom virtual plane, and 1 denotes that the current node is a top virtual plane in the i-axis direction. Here, i denotes a coordinate dimension, which may be the X-axis direction, the Y-axis direction, or the Z-axis direction, so i=0, 1, 2.

In the G-PCC standard, when judging whether a node meets the planar encoding condition and when the node meets the planar encoding condition, it is necessary to perform prediction encoding for the plane mode information and plane position information of the node.

In the embodiments of the present disclosure, there are three kinds of judgment conditions for judging whether a node meets the judgment condition of the planar encoding in the current G-PCC standard, which are described in detail one by one below.

### 1. Judgment According to the Plane Probability of the Node in Each Dimension.

(1) Determine the local area density (local_node_density) of the current node.
(2) Determine the probability Prob (i) of the current node in each dimension.

When the local area density of the node is less than the threshold Th (e.g., Th=3), the plane probabilities Prob (i) of the current node in three coordinate dimensions are compared with the thresholds Th0, Th1, and Th2. Here, Th0<Th1<Th2 (e.g., Th0=0.6, Th1=0.77, Th2=0.88). Eligibleᵢ (i=0, 1, 2) may be used to represent whether planar encoding is started in each dimension: Eligibleᵢ=Prob (i)>=threshold.

It should be noted that the threshold is adaptively changed, for example, when Prob (0)>Prob (1)>Prob (2), Eligibleᵢ is set as follows:

$$\begin{matrix}{Eligible}_{0} = Prob ( 0 ) >= Th 0 ; \\ {Eligible}_{1} = Prob ( 1 ) >= Th 1 ; \\ {Eligible}_{2} = Prob ( 2 ) >= Th 2.\end{matrix}$$

When Prob (1)>Prob (0)>Prob (2), Eligibleᵢ is set as follows:

$$\begin{matrix}{Eligible}_{0} = Prob ( 0 ) >= Th 0 ; \\ {Eligible}_{1} = Prob ( 1 ) >= Th 1 ; \\ {Eligible}_{2} = Prob ( 2 ) >= Th 2.\end{matrix}$$

Here, the update of Prob (i) is as follows:

$${Prob ( i )}_{n e w} = ( L \times P r o b ( i ) + δ ( coded node ) ) / L + 1 \qquad ( 1 )$$

Here, L=255. In addition, if the coded node is a plane, δ (coded node) is 1. Otherwise δ (coded node) is 0.

Here, the update of local_node_density is as follows:

$$local\_node {\_density}_{{n e w}_{}} = local\_node \_density + 4 * numSiblings \qquad ( 2 )$$

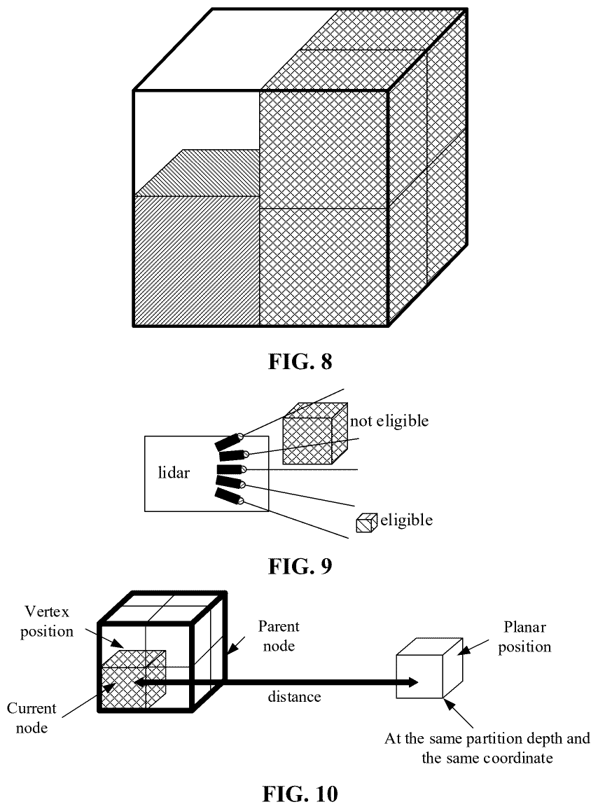

Here, local_node_density is initialized to be 4, and numSiblings is the number of sibling nodes of this node. Exemplarily, FIG. 8 illustrates a schematic diagram of sibling nodes of a current node. As illustrated in FIG. 8, the current node is a node filled with slashes and the node filled with grids is a sibling node, so the number of sibling nodes of the current node is 5 (including the current node itself).

### 2. Determination of Whether the Nodes of the Current Layer Meet the Planar Encoding According to the Point Cloud Density of the Current Layer

The density of the points of the current layer is used to determine whether to perform planar encoding on the nodes of the current layer. Assuming that the number of points in the current point cloud to be encoded is pointCount, the number of points that have been reconstructed by the Infer Direct Coding Model (IDCM) encoding is numPointCountRecon. Because the octree is encoded based on the order of breadth-first traversal, the number of to-be-encoded nodes in the current layer may be assumed as nodeCount, and then whether planar encoding is started for the current layer is assumed to be planarEligibleKOctreeDepth, specifically: planarEligibleK OctreeDepth=(pointCount−numPointCountRecon)<nodeCount×1.3.

Here, if (pointCount−numPointCountRecon) is less than nodeCount×1.3, planarEligibleK OctreeDepth i is true. If (pointCount−numPointCountRecon) is not less than nodeCount×1.3, planarEligibleKOctreeDepth is false. In this way, when planarEligibleKOctreeDepth is true, the planar encoding is performed on all nodes in the current layer. Otherwise, the planar encoding is not performed for all nodes in the current layer, and only the octree encoding is used.

### 3. Determination of Whether the Current Node Meets the Planar Encoding According to the Acquisition Parameters of the Lidar Point Cloud

FIG. 9 illustrates a schematic diagram of an intersection of lidars with a node. As illustrated in FIG. 9, the node filled with grids is traversed by two Laser rays (Laser) at the same time, so the current node is not a plane in the vertical direction of the Z-axis. The node filled with slashes is too small to be crossed by two Lasers at the same time. Therefore, it is possible that the node filled with the slashes is a plane in the Z-axis vertical direction.

Further, the prediction encoding may be performed on the plane mode information and the plane position information for a node meeting the planar encoding condition.

Firstly, the prediction encoding is performed on the plane mode information.

Here, only three pieces of context information are used for encoding, that is, the context for the plane mode on each coordinate dimension is designed separately.

Secondly, the prediction encoding is performed on the plane position information.

It should be understood that, for the encoding of non-Lidar point cloud plane position information, the prediction encoding of the plane position information may include the following operations.
(a) Prediction is performed by using the occupancy information of the neighbouring nodes to obtain the plane position information of the current node. The plane position information of the current node includes the following three elements: predicted as bottom virtual plane, predicted as top virtual plane and cannot be predicted.
(b) The spatial distance between the node (which is at the same partitioning depth and at the same coordinates as the current node) and the current node is divided into two types: “close” and “far”.
(c) If the node at the same partition depth and at the same coordinates as the current node is a plane, the plane position of the node is determined.
(d) Coordinate dimensions (i=0, 1, 2).

It should be noted that, in the embodiments of the present disclosure, after the spatial distance between the node at the same partitioning depth and at the same coordinates as the current node and the current node is determined, if the spatial distance is less than a preset distance threshold, it may be determined that the spatial distance is “close”. Alternatively, if the spatial distance is greater than a preset distance threshold, it may be determined that the spatial distance is “far”.

Exemplarily. FIG. 10 illustrates a schematic diagram of the neighbouring node at the same partitioning depth and at the same coordinates. As illustrated in FIG. 10, the bold large cube represents the parent node, and the small cube filled with grids in the large cube represents the current node. The intersection position (vertex position) of the current node is illustrated. The small cube filled with white represents the neighbouring node at the same partitioning depth and the same coordinates. The distance between the current node and the neighbouring node is the spatial distance, which may be determined as “close” or “far”. In addition, if the neighbouring node is a plane, the plane position of the neighbouring node is also required.

In this way, as illustrated in FIG. 10, if the current node is a small cube filled with grids, the neighbouring node which is small cube filled with white is found at the same octree partitioning depth level and the same vertical coordinates, and the distance between the two nodes is judged to be “close” or “far”, and the plane position of the node is referred to.

Further, in the embodiments of the present disclosure. FIG. 11 illustrates schematic diagrams of current nodes located at positions of the bottom virtual plane of parent nodes. As illustrated in FIG. 11, (a), (b), (c) illustrates examples of three kinds of current nodes located at the positions of the bottom virtual plane of the parent node. Specific instructions are as follows.
(1) If any one of the child nodes 4 to 7 of the node filled with dots is occupied, but all the nodes filled with grids are not occupied, it is very likely that there is a plane in the current node (filled with slashes), and the plane position is low.
(2) If none of the child nodes 4 to 7 of the node filled with dots is occupied, but any node filled with grids is occupied, it is very likely that there is a plane in the current node (filled with slashes), and the plane position is high.
(3) If the child nodes 4 to 7 of the node filled with dots are all empty nodes, and the nodes filled with grids are all empty nodes, the plane position cannot be inferred, so it is marked as unknown.
(4) If any one of the child nodes 4 to 7 of the node filled points is occupied, and any node filled with grids is occupied, in this case, the plane position cannot be inferred, so it is marked as unknown.

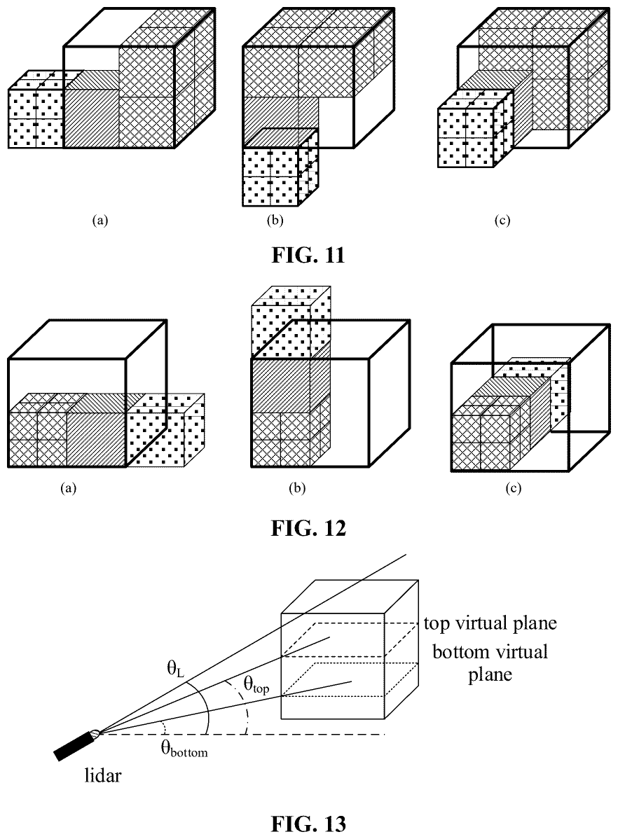

In the embodiments of the present disclosure. FIG. 12 illustrates schematic diagrams of current nodes located at positions of the top virtual plane of parent nodes. As illustrated in FIG. 12. (a), (b), (c) illustrate examples of three kinds of current nodes located at the positions of the top virtual plane of the parent node. Specific explanation is as follows.
(1) If any one of the child nodes 4 to 7 of the node filled with grids is occupied, but the nodes filled with dots are not occupied, it is very likely that there is a plane in the current node (filled with slashes), and the plane position is low.
(2) If none of the child nodes 4 to 7 of the node filled with grids is occupied, but the nodes filled with dots are occupied, it is very likely that there is a plane in the current node (filled with slashes), and the plane position is high.
(3) If the child nodes 4 to 7 of the node filled with grids are all unoccupied, and the nodes filled with dots are unoccupied, in this case, the plane position cannot be inferred, so it is marked as unknown.
(4) If one of the child nodes 4 to 7 of the node filled with grids is occupied, and the nodes filled with dots are occupied, in this case, the plane position cannot be inferred, so it is marked as unknown.

It should also be understood that for the encoding of the plane position information of the lidar point cloud, FIG. 13 illustrates a schematic diagram of prediction encoding of plane position information of the lidar point cloud. As illustrated in FIG. 13, when the emission angle of the lidar is θ_{bottom}, it may be mapped to a bottom virtual plane. When the emission angle of the lidar is θₜₒₚ, it may be mapped to a top virtual plane.

That is, the plane position of the current node is predicted by using the lidar acquisition parameters, and the position is quantized into multiple ranges by using the position where the current node intersects with the lasers, and the multiple ranges finally serve as the context information of the plane position of the current node. The specific calculation process is as follows: assuming that the coordinates of the lidar are (x_{Lidar}, y_{Lidar}, z_{Lidar}) and the geometric coordinates of the current node are (x, y, z), firstly, the vertical tangent value tan θ of the current node relative to the lidar is calculated, and the calculation formula is as follows:

$$tan θ = \frac{z - {z}_{Lidar}}{\sqrt{{( x - {x}_{Lidar} )}^{2} + {( y - {y}_{Lidar} )}^{2}}} \qquad ( 3 )$$

Further, because each laser has a certain offset angle relative to the lidar, it is necessary to calculate the relative tangent value tan θ_{corr,L} of the current node relative to the laser. The specific calculation formula is as follows:

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 4 )$$

Finally, the relative tangent value tan θ_{corr,L} of the current node can be used to predict the plane position of the current node, and the specific processes are as follows. Assuming that the tangent value of the lower boundary of the current node is tan (θ_{bottom}) and the tangent value of the upper boundary is tan (θₜₒₚ), the plane position is quantized into four quantization ranges according to tan θ_{corr,L}, that is, the context information of the plane position is determined.

However, the OctGeomEnc mode only has an efficient compression rate for the correlated points in space, while for the isolated points in geometric space, using the Direct Coding Model (DCM) can greatly reduce the complexity. For all nodes in the octree, the use of DCM is not represented by flag bit information, but is inferred by the parent node of the current node and neighbour information. There are three ways to determine whether the current node has DCM encoding qualification, as follows:
(1) The current node has no sibling child nodes, that is, the parent node of the current node has only one child node, and the parent node of the parent node of the current node has only two occupied child nodes, that is, the current node has only one neighbouring node at most.
(2) The parent node of the current node has only one occupied child node, that is, the current node, and the six neighbouring nodes that share a plane with the current node are all empty nodes.
(3) The number of sibling nodes of the current node is greater than 1.

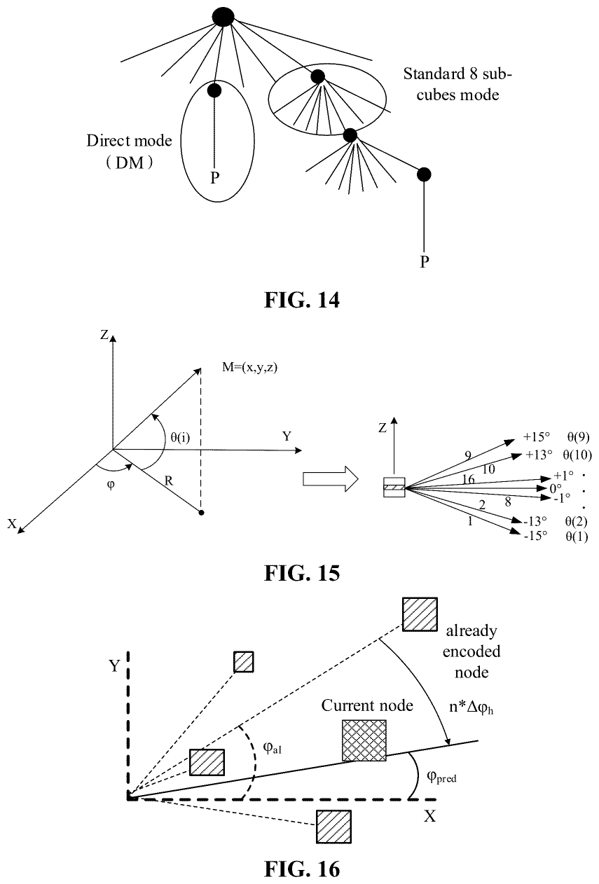

Exemplarily. FIG. 14 provides a schematic diagram of IDCM encoding. If the current node does not have the DCM encoding qualifications, the octree partitioning will be performed on the current node. If the current node has the DCM encoding qualifications, the number of points included in the node will be further determined. When the number of points is less than a threshold (for example, 2), the DCM encoding will be performed on the node. Otherwise, the octree partitioning will be performed continuously. When the DCM encoding mode is applied, it is first necessary to encode whether the current node is a true isolated point, which is denoted as IDCM_flag. When IDCM_flag is true, the current node adopts the DCM encoding, otherwise the current node still adopts the octree encoding. When the current node meets the DCM encoding, it is necessary to encode the DCM encoding mode of the current node. At present, there are two DCM modes, namely: (a) only one point exists (or multiple points, but they are repeated points): (b) two points exist. Finally, it is necessary to encode the respective geometric information of each point. Assuming that the side length of the node is 2d, d bits are needed to encode each component of the geometric coordinates of the node, and this bit information is directly encoded into the bitstream. It should be noted here that when encoding the point cloud of the lidar, the efficiency of the encoding of the geometric information may be further improved by using the lidar acquisition parameters to perform prediction encoding on the coordinate information of three dimensions.

Further, the process of the IDCM encoding will be described in detail below.

When the current node meets the DCM encoding mode, firstly, the number of points numPoints of the current node is encoded. The number of points of the current node is encoded according to different DirectModes.
(1) If the current node does not meet the requirements of the DCM node, it exits directly (i.e, the number of points is greater than 2 points and they are not duplicate points).
(2) If the number of points numPonts included in the current node is less than or equal to 2, the encoding process is as follows.
i) Firstly, whether the numPonts of the current node is greater than 1 is encoded; and
ii) If the current node has only one point and the geometry encoding environment is geometrically lossless encoding, it is necessary to encode that the second point of the current node is not a duplicate point.
   (3) If the number of points numPonts included in the current node is greater than 2, the encoding process is as follows.
i) First, it is encoded that the numPonts of the current node is less than or equal to 1.
ii) Secondly, it is encoded that the second point of the current node is a duplicate point, and whether the number of duplicate points of the current node is greater than 1 is encoded. When the number of duplicate points is greater than 1, exponential Golomb decoding needs to be performed on the remaining number of duplicate points.

After the number of points of the current node is encoded, coordinate information of the points included in the current node is encoded. Lidar point clouds and human eye-faced point clouds will be introduced in detail below.

### 1. Human Eye-Faced Point Cloud

(1) If the current node includes only one point, the geometric information of the three dimensional directions of the point will be directly encoded (Bypass coding).
(2) If the current node includes two points, the preferentially encoded coordinate axis dirextAxis will be obtained first by using the geometric coordinates of the points. It should be noted here that the coordinate axes currently compared only include the x-axis and y-axis and do not include the z-axis. Assuming that the geometric coordinates of the current node are nodePos, the determination method is as follows:

$$directAxis = ! ( nodePos [ 0 ] < nodePos [ 1 ] ) \qquad ( 5 )$$

In other words, the axis having a smaller geometric position of the node coordinates is used as the preferentially encoded coordinate axis dirextAxis. Secondly, the geometric information of the preferentially encoded coordinate axis dirextAxis is encoded as follows. Assuming that the to-be-encoded geometric bit depth corresponding to the preferentially encoded axis is nodeSizeLog2, and assuming that the coordinates of the two points are pointPos [0] and pointPos [1], respectively. The specific encoding process is as follows:

```
  Bool sameBit=true;
  while(nodeSizeLog2&& sameBit){
    intmask=1<< nodeSizeLog2;
    --nodeSizeLog2;
    bool bit0=!!( pointPos[0]& mask)
bool bit1=!!( pointPos[1]& mask)
    sameBits=bit0==bit1;
    entropyCodeSameBit(sameBits); ///<entropy coding
    if(sameBits)
        encodePosBit(bit0);///<Bypass coding
      }
```

After the preferentially encoded coordinate axis dirextAxis is encoded, the geometric coordinates of the current node continue to be directly encoded. Assuming that the remaining encoding bit depth of each point is nodeSizeLog2, the specific encoding process is as follows:

for(int axisIdx=0;axisIdx<3;++axisIdx)
for(int mask=(1<< nodeSizeLog2[axisIdx])>>1;mask;mask>>1)
encodePosBit(!!(pointPos[axisIdx]&mask)).

### 2. Lidar-Faced Point Cloud

If the current node includes two points, the preferentially encoded coordinate axis dirextAxis is obtained first by using the geometric coordinates of the points. Assuming that the geometric coordinates of the current node are nodePos, the determination method is as follows:

$$directAxis = ! ( nodePos [ 0 ] < nodePos [ 1 ] )$$

In other words, the axis having a smaller geometric position of the node coordinates is used as the preferentially encoded coordinate axis dirextAxis. It should be noted here that the coordinate axes currently compared only include the x-axis and y-axis and do not include the z-axis. Secondly, the geometric information of the preferentially encoded coordinate axis dirextAxis is encoded in the following manner. Assuming that the to-be-encoded geometric bit depth corresponding to the preferentially encoded axis is nodeSizeLog2, and assuming that the coordinates of the two points are pointPos [0] and pointPos [1], respectively. The specific encoding process is as follows:

```
  Bool sameBit=true;
  while(nodeSizeLog2&& sameBit){
      int mask=1<< nodeSizeLog2;
      --nodeSizeLog2;
      bool bit0=!!( pointPos[0]& mask)
bool bit1=!!( pointPos[1]& mask)
      sameBits=bit0==bit1;
      entropyCodeSameBit(sameBits);
      if(sameBits)
        encodePosBit(bit0);
    }
```

After the preferentially encoded coordinate axis dirextAxis is encoded, the geometric coordinates of the current node are encoded.

Since the lidar point cloud can obtain the acquisition parameters of the lidar point cloud, the efficiency of the encoding of the geometric information of the point cloud may be further improved by using the geometric coordinate information that can predict the current node. Similarly, firstly, the geometric information nodePos of the current node is used to obtain a directly encoded main axis direction, and secondly, the geometric information of the encoded direction is used to perform prediction encoding on the geometric information of another dimension. Similarly, assuming that the axis direction that is direct encoded is directAxis, and assuming that the to-be-encoded bit depth in the direct encoding is nodeSizeLog2, the encoding method is as follows:

for(int mask=(1<< nodeSizeLog2)>>1;mask;mask>>1);
encodePosBit(!!(pointPos[directAxis]&mask)).

It should be noted here that all the geometric accuracy information in the directAxis direction will be encoded here.

Exemplarily, FIG. 15 provides a schematic diagram of coordinate transform of a point cloud obtained by a rotating lidar. In the Cartesian coordinate system, the coordinates (x, y, z) of each node may be converted to be represented by (R, φ, i). In addition, the Laser Scanner may perform laser scanning at a preset angle, and different θ (i) may be obtained under different values of i. For example, when i is equal to 1, θ(1) may be obtained, and the corresponding scanning angle is −15°. When i is equal to 2, θ(2) may be obtained, and the corresponding scanning angle is −13°. When i is equal to 10, θ(10) may be obtained, and the corresponding scanning angle is +13°. When i is equal to 9, θ(19) may be obtained, and the corresponding scanning angle is +15°.

In this way, after all the precision information in the directAxis coordinate direction is encoded, LaserIdx corresponding to the current point (that is, the pointLaserIdx number in FIG. 15) is calculated first, and the LaserIdx of the current node (that is, nodeLaserIdx) is calculated. Secondly, the LaserIdx of the node (that is, nodeLaserIdx) is used to perform prediction encoding on the LaserIdx of the point (that is, nodeLaserIdx). The calculation method of the LaserIdx of the node or point is as follows. Assuming that the geometric coordinate of the point is pointPos, the starting coordinates of the Laser is LidarOrigin, and assumign that the number of lasers is LaserNum, the tangent value of each Laser is tan θᵢ, and the offset position of each Laser in the vertical direction is Zᵢ, then:

```
    Int bestLaserIdx = 0;
  Int Distoration = INT_MAX;
For(int LaserIdx = 0; LaserIdx < numLaser; ++ LaserIdx){
$int radius = \sqrt{( pointPos [ 0 ] - LidarOrigin [ 0 ] ) 2 + ( pointPos [ 1 ] - LidarOrigin [ 1 ] ) 2}$
    int invRadius = 1/radius
    int Z = pointPos[2] + Zᵢ
    int tanTheta = Z × invRadius
    if(std::abs(tanTheta-tanθᵢ) < Distoration){
      Distoration = std::abs(tanTheta-tanθᵢ);
      bestLaserIdx = LaserIdx;
      }
    }
```

After calculating the LaserIdx of the current point, firstly, the LaserIdx of the current node is used to perform prediction encoding on the pointLaserIdx of the point. After the LaserIdx of the current point is encoded, the prediction encoding is performed on the geometric information of the three dimensions of the current point by using the acquisition parameters of the lidar.

Exemplarily, FIG. 16 illustrates a schematic diagram of the prediction encoding in an X-axis or Y-axis direction. As illustrated in FIG. 16, boxes filled with grids represent the Current node, and boxes filled with slashes represent the already coded nodes. Here, firstly, the LaserIdx corresponding to the current node is used to obtain the predicted value of the corresponding horizontal azimuth (i.e., φ_{pred}). Secondly, the node geometric information corresponding to the current node is used to obtain the horizontal azimuth φ_{node} corresponding to the node. Assuming that the geometric coordinate of the node is nodePos, the calculation method between the horizontal azimuth φ and the node geometric information is as follows:

$$φ = arc tan ( nodePos [ 1 ] / nodePos [ 0 ] ) \qquad ( 6 )$$

By using the acquisition parameters of the lidar, the number of rotation points numPoints of each Laser, which denotes the number of points obtained by rotating each Laser once, may be obtained, and the rotational angular velocity deltaPhi of each Laser may be calculated by using the number of rotation points of each Laser. The calculation method is as follows:

$$delta Phi = \frac{2 π}{n u m P o i n t s} \qquad ( 7 )$$

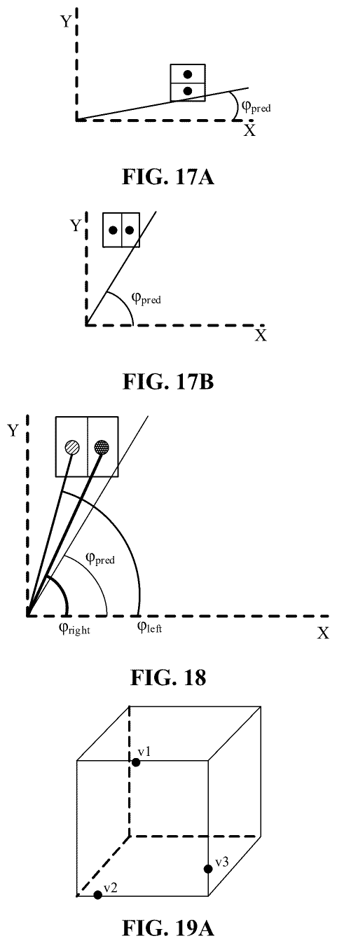

Further, the horizontal azimuth prediction value φ_{predPoint} corresponding to the current point (i.e., a prediction value of the horizontal azimuth illustrated in FIG. 17A and FIG. 17B) is calculated by using the horizontal azimuth φ_{node} of the node and the horizontal azimuth φ_{pred} of the previous encoded point of the Laser corresponding to the current point. Here, FIG. 17A illustrates a schematic diagram of a Y-plane angle prediction through the horizontal azimuth, and FIG. 17B illustrates a schematic diagram of an X-plane angle prediction through the horizontal azimuth. Here, for the horizontal azimuth prediction value φ_{predPoint} corresponding to the current point, the calculation method is as follows:

$${φ}_{p r e d P o i n t} = \frac{φ pred - φ node}{deltaPhi} \times deltaPhi + φ pred \qquad ( 8 )$$

Exemplarily, FIG. 18 illustrates another schematic diagram of the prediction encoding in an X-axis or Y-axis direction. As illustrated in FIG. 18, the portion filled with grids (left side) represents the bottom virtual plane, the portion filled with dots (right side) represents the top virtual plane, φ_{left} denotes the bottom virtual plane horizontal azimuth of the current node, φ_{right} denotes the top virtual plane horizontal azimuth of the current node, and φ_{pred} denotes the horizontal azimuth prediction value corresponding to the current node.

In this way, the prediction encoding is performed on the geometric information of the current node by using the predicted value of the horizontal azimuth φ_{predPoint}, the bottom virtual plane horizontal azimuth φ_{left} of the current node and the top virtual plane horizontal azimuth φ_{right} of the current node. The specific processes are as follows:

int angLel = φ_{left} − φ_{pred};
int angLeR = φ_{right} − φ_{pred};
int context = (angLel ≥ 0&&angLeR ≥ 0)||(angLel < 0&&angLeR < 0)?
0: 2;
int minAngle = std :: min(abs(angLel), abs(angLeR));
int maxAngle = std :: max(abs(angLel), abs(angLeR));
context+= maxAngle > minAngle? 0: 1;
context+= maxAngle > minAngle? 0: 4.

After the LaserIdx of the point is encoded, the LaserIdx corresponding to the current point is used to perform the prediction encoding on the Z-axis direction of the current point, that is, the depth information radius of the radar coordinate system is currently calculated by using the x and y information of the current point. Secondly, the laser LaserIdx of the current point is used to obtain the tangent value of the current point and the offset in the vertical direction, so that the predicted value of the Z-axis direction of the current point (i.e., Z_pred) may be obtained. The specific processes are as follows:

$$\begin{matrix}int radius = \sqrt{{( pointPos [ 0 ] - LidarOrigin [ 0 ] )}^{2} + {( p o i n t P o s [ 1 ] - LidarOrigin [ 1 ] )}^{2}} ; \\ int tan Theta = tan {θ}_{laserIdx ;} \\ int zOffset = {Z}_{laserIdx} ; \\ Z\_pred = radius \times tan Theta - zOffset .\end{matrix}$$

Further, Z_pred is used to perform prediction encoding on the geometric information in the Z-axis direction of the current point to obtain the prediction residual Z_res, and finally Z_res is encoded.

It should be noted that when the nodes are partitioned into leaf nodes, the number of duplicate points in the leaf nodes needs to be encoded in the case of geometrically lossless encoding. Finally, the occupancy information of all nodes is encoded to generate a binary bitstream. In addition, in the G-PCC, a planar encoding mode is currently introduced. In the process of partitioning the geometry, whether the child nodes of the current node are in the same plane is determined. If the child nodes of the current node meet the conditions of the same plane, the plane will be used to represent the child nodes of the current node.

For the octree geometry decoding, before decoding the occupancy information of each node in the order of breadth-first traversal, the decoding end firstly uses the reconstructed geometric information to determine whether the planar decoding or the IDCM decoding is performed on the current node. If the current node meets the condition of planar decoding, the plane mode information and the plane position information of the current node are firstly decoded, and then the occupancy information of the current node is decoded based on the plane information. If the current node meets the condition of the IDCM decoding, whether the current node is a true IDCM node is decoded. If the current node is a true IDCM node, the DCM decoding mode of the current node will be parsed. Secondly, the number of points in the current DCM node is obtained. Finally, the geometric information of each point is decoded. For nodes that meet neither the planar decoding nor the DCM decoding, the occupancy information of the current node is decoded. The occupancy code of each node is obtained through continuously parsing, and the nodes are continuously partitioned until the partitioning is stopped when the unit cubes of 1×1×1 are obtained by partitioning. The number of points contained in each leaf node is obtained through parsing, and finally the geometric reconstruction point cloud information is recovered.

The process of the IDCM decoding is described in detail below.

Similar to the processing process at the encoding end, firstly, the prior information is used to determine whether to start the IDCM for the node. That is, the starting condition of the IDCM is as follows:
(1) The current node has no sibling child nodes, that is, the parent node of the current node has only one child node, and the parent node of the parent node of the current node has only two occupied child nodes, that is, the current node has only one neighbouring node at most.
(2) The parent node of the current node has only one occupied child node, that is, the current node, and the six neighbouring nodes that share a plane with the current node are all empty nodes.
(3) The number of sibling nodes of the current node is greater than 1.

Further, when the node meets the condition of the DCM encoding, firstly, whether the current node is a true DCM node (that is, IDCM_flag) is determined through decoding. When the IDCM_flag is true, the DCM encoding is used for the current node; otherwise, the octree encoding is used.

Secondly, the number of points numPoints of the current node is obtained through decoding.

The specific decoding method is as follows.
i) Firstly, whether the numPonts of the current node is greater than 1 is determined through decoding.
ii) If the numPonts of the current node obtained through decoding is greater than 1, whether the second point is a duplicate point is determined through decoding. If the second point is not a duplicate point, it may be implicitly inferred here that the second type of the DCM mode is met, and the current node includes only two points.
iii) If the numPonts of the current node obtained through decoding is less than or equal to 1, whether the second point is a duplicate point is determined through decoding. If the second point is not a duplicate point, it may be implicitly inferred here that the second type of the DCM mode is met, and the current node includes only one point. If it is obtained through decoding that the second point is a duplicate point, it may be inferred that the third type of the DCM mode is met, and the current node includes multiple points, all of which are duplicate points. Then whether the number of duplicate points is greater than 1 is determined through decoding (entropy decoding). If the number of duplicate points is greater than 1, the number of remaining duplicate points is decoded (decoding by using exponential Columbus).

If the current node does not meet the requirements of the DCM node, it exits directly (i.e. the number of points is greater than 2 and the points are not duplicate points).

After the number of points of the current node is obtained through decoding, the coordinate information of the points included in the current node is obtained through decoding. Lidar point clouds and human eye-faced point clouds will be introduced in detail below.

### 1. Human Eye-Faced Point Cloud

(1) If the current node includes only one point, the geometric information of the three dimensional directions of the point will be directly decoded (Bypass coding).
(2) If the current node includes two points, the preferentially decoded coordinate axis dirextAxis will be obtained first by using the geometric coordinates of the points. It should be noted here that the coordinate axes currently compared only include the x-axis and y-axis, and do not include the z-axis. Assuming that the geometric coordinates of the current node are nodePos, the determination method is as follows:

$$dirextAxis = ! ( nodePos [ 0 ] < nodePos [ 1 ] ) \qquad ( 9 )$$

In other words, the axis having a smaller geometric position of the node coordinates is used as the preferentially decoded coordinate axis dirextAxis. Secondly, the geometric information of the preferentially decoded coordinate axis dirextAxis is decoded as follows. Assuming that the to-be-decoded geometric bit depth corresponding to the preferentially decoded axis is nodeSizeLog2, and assuming that the coordinates of the two points are pointPos [0] and pointPos [1], respectively. The specific coding process is as follows:

```
Bool sameBit=true;
  while(nodeSizeLog2&& sameBit){
    pointPos[0][ dirextAxis]<<1;
    pointPos[1][ dirextAxis]<<1;
    −−nodeSizeLog2;
        int bit=0;
            deEntropyCodeSameBit(sameBits); ///<entropy coding
        if(sameBits){
              bit =decodePosBit( );///<Bypass coding
              pointPos[0][ dirextAxis]|= bit
              pointPos[1][ dirextAxis]|= bit
        }else
              pointPos [1] [dirextAxis] |=1///< The reason here is that during
          encoding, two points are sorted in the direction of the preferentially
          encoded axis, so pointPos[0][dirextAxis] < pointPos[1][dirextAxis] may be
          ensured. Therefore, during decoding, if the bit information of the two
          points is different, it can be inferred that the bit of the first point is 0 and
          the bit of the second point is 1.
      }
```

After the preferentially decoded coordinate axis dirextAxis is decoded, the geometric coordinates of the current node are continued to be directly decoded. Assuming that the remaining encoding bit depth of each point is nodeSizeLog2, and assuming that the coordinate information of the point is pointPos, the specific decoding process is as follows:

```
for(int axisIdx=0;axisIdx<3;++axisIdx)
for(int idx= nodeSizeLog2[axisIdx]; idx; idx−−){
  pointPos[axisIdx]<<1;
  pointPos[axisIdx]|=decodePosBit( );
  }
```

### 2. Lidar-Faced Point Cloud

If the current node includes two points, the preferentially decoded coordinate axis dirextAxis is obtained firstly by using the geometric coordinates of the points. Assuming that the geometric coordinates of the current node are nodePos, the determination method is as follows:

$$dirextAxis = ! ( nodePos [ 0 ] < nodePos [ 1 ] ) \qquad ( 10 )$$

In other words, the axis having a smaller geometric position of the node coordinates is used as the preferentially decoded coordinate axis dirextAxis. It should be noted here that the coordinate axes currently compared only include the x-axis and y-axis and do not include the z-axis. Secondly, the geometric information of the preferentially decoded coordinate axis dirextAxis is decoded in the following manner. Assuming that the to-be-encoded geometric bit depth corresponding to the preferentially decoded axis is nodeSizeLog2, and assuming that the coordinates of the two points are pointPos [0] and pointPos [1], respectively. The specific coding process is as follows:

```
Bool sameBit=true;
while(nodeSizeLog2&& sameBit){
  pointPos[0][ dirextAxis]<<1;
  pointPos[1][ dirextAxis]<<1;
      −−nodeSizeLog2;
      int bit=0;
    deEntropyCodeSameBit(sameBits); ///<entropy coding
      if(sameBits){
          bit =decodePosBit( );///<Bypass coding
          pointPos[0][ dirextAxis]|= bit
          pointPos[1][ dirextAxis]|= bit
      }else
          pointPos [1] [dirextAxis] |=1///< The reason here is that during
        encoding, two points are sorted in the direction of the preferentially
        encoded axis, so pointPos[0][dirextAxis] < pointPos[1][dirextAxis] may
        be ensured. Therefore, during decoding, if the bit information of the two
        points is different, it can be inferred that the bit of the first point is 0 and
        the bit of the second point is 1
      }
```

After the preferentially decoded coordinate axis dirextAxis is decoded, the geometric coordinates of the current node are decoded.

Similarly, firstly, the geometric information nodePos of the current node is used to obtain a directly decoded main axis direction. Secondly, the geometric information of the decoded direction is used to decode the geometric information of another dimension. Similarly, assuming that the directly decoded axis direction is directAxis, and assuming that the to-be-decoded bit depth in direct decoding is nodeSizeLog2, the

```
decoding method is as follows:
  for(int idx= nodeSizeLog2[directAxis]; idx; idx−−){
    pointPos[directAxis]<<1;
    pointPos[directAxis]|=decodePosBit( );
      }
```

It should be noted here that all the geometric accuracy information of the directAxis direction will be decoded here.

After all the accuracy of the directAxis coordinate direction is decoded, firstly, the LaserIdx of the current node, (i.e., nodeLaserIdx) will be calculated. Secondly, the LaserIdx of the node (i.e., nodeLaserIdx) will be used to perform prediction decoding on the LaserIdx of the point (i.e., pointLaserIdx). The calculation method of the LaserIdx of the node or point is the same as that in the encoding end. Finally, the LaserIdx of the current node and the LaserIdx prediction residual information of the node are decoded to obtain ResLaserIdx, and the decoding method is as follows:

$$PointLaserIdx = nodeLaserIdx + ResLaserIdx \qquad ( 11 )$$

After the LaserIdx of the current point is decoded, the prediction decoding is performed on the geometric information of the three dimensions of the current point by using the acquisition parameters of the lidar. The specific algorithm is as follows.

As illustrated in FIG. 11, firstly, the LaserIdx corresponding to the current node is used to obtain the predicted value of the corresponding horizontal azimuth (i.e., φ_{pred}). Secondly, the node geometric information corresponding to the current node is used to obtain the horizontal azimuth φ_{node} corresponding to the node. Assuming that the geometric coordinate of the node is nodePos, the calculation method between the horizontal azimuth φ and the node geometric information is as follows:

$$φ = arc tan ( nodePos [ 1 ] / nodePo s [ 0 ] ) \qquad ( 12 )$$

By using the acquisition parameters of the lidar, the number of rotation points numPoints of each Laser, which denotes the number of points obtained by rotating each Laser once, may be obtained, and the rotational angular velocity deltaPhi of each Laser may be calculated by using the number of rotation points of each Laser. The calculation method is as follows:

$$delta Phi = \frac{2 π}{n u m P o i n t s} \qquad ( 13 )$$

Further, the horizontal azimuth prediction value φ_{predPoint} corresponding to the current point (i.e., a prediction value of the horizontal azimuth illustrated in FIG. 17A and FIG. 17B) is calculated by using the horizontal azimuth φ_{node} of the node and the horizontal azimuth φ_{pred} of the previous encoded point of the Laser corresponding to the current point. The calculation method is as follows:

$${φ}_{p r e d P o i n t} = \frac{φ pred - φ node}{delta Phi} \times delta Phi + φ pred \qquad ( 14 )$$

In this way, the prediction decoding is performed on the geometric information of the current node by using the predicted value of the horizontal azimuth φ_{predPoint}, the bottom virtual plane horizontal azimuth left of the current node and the top virtual plane horizontal azimuth φ_{right} of the current node. The specific processes are as follows:

int angLel = φ_{left} − φ_{pred};
int angLeR = φ_{right} − φ_{pred};
int context = (angLel ≥ 0&&angLeR ≥ 0)||(angLel < 0&&angLeR < 0)?
0: 2;
int absAngleL = abs(angLel);
int absAngleR = abs(angLeR);
context+= absAngleL > absAngleR? 0: 1;
context+= maxAngle > minAngle << 1? 4: 0.

After the LaserIdx of the point is decoded, the LaserIdx corresponding to the current point is used to perform the prediction decoding on the Z-axis direction of the current point. That is, the depth information radius of the radar coordinate system is currently calculated by using the x and y information of the current point, and secondly, the laser LaserIdx of the current point is used to obtain the tangent value of the current point and the offset in the vertical direction, so that the predicted value of the Z-axis direction of the current point (i.e., Z_pred) may be obtained. The specific processes are as follows:

$$\begin{matrix}int radius = \sqrt{( pointPos [ 0 ] - LidarOrigin [ 0 ] ) 2 + ( poi n t P o s [ 1 ] - LidarOrigin [ 1 ] ) 2} ; \\ int tan Theta = tan {θ}_{laserIdx} ; \\ int zOffset = {Z}_{laserIdx} ; \\ Z\_pred = radius \times tan Theta - zOffset .\end{matrix}$$

Further, Z_res and Z_pred obtained through decoding are used to reconstruct and restore the geometric information of the Z-axis direction of the current point.

For geometric information encoding based on triangle soup (trisoup), in the geometric information coding framework based on trisoup, geometric partitioning should also be performed first, but it is different from the geometric information encoding based on binary tree/quadtree/octree. This method does not need to partition the point cloud into unit cubes with a side length of 1×1×1 step by step, but to stop partitioning when the side length of sub-blocks is W. Based on the surface formed by the distribution of point clouds in each block, at most twelve intersections (vertexes) generated by the surface and the twelve edges of the block are obtained. The vertex coordinates of each block are encoded in turn to generate a binary bitstream.

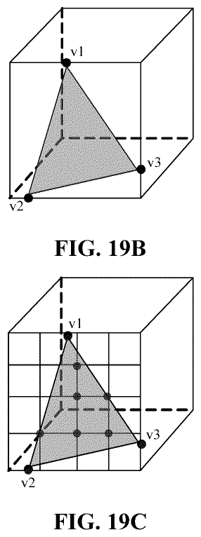

For the point cloud geometric information reconstruction based on the trisoup, when the point cloud geometric information reconstruction is performed at the decoding end, the vertex coordinates are firstly obtained through decoding to complete the reconstruction of the trisoup, and the process is illustrated in FIG. 19A, FIG. 19B and FIG. 19C. There are three vertexes (v1, v2, v3) in the block illustrated in FIG. 19A, and the trisoup is formed by using these three vertexes in a certain order, as illustrated in FIG. 19B. Thereafter, sampling is performed on the trisoup, and the obtained sampling points are used as the reconstructed point cloud in the block, as illustrated in FIG. 19C.

The Predictive geometry coding (PredGeomTree) includes the following operations. Firstly, the input point cloud is sorted. Currently used sorting methods include disorder, Morton order, azimuth order and radial distance order. At the encoding end, the prediction tree structure is established in two different manners, including: KD-Tree (high delay slow mode) and low delay fast mode (calibrating information by using lidars). When calibrating information by using lidars, each point is partitioned into different lasers, and the prediction tree structure is established according to different lasers. Next, based on the prediction tree structure, each node in the prediction tree is traversed, and the geometric position information of the node is predicted by selecting different prediction modes to obtain the prediction residual. The geometric prediction residual is quantized by using quantization parameters. Finally, through the continuous iteration, the prediction residual, prediction tree structure and quantization parameters of the node position information in the prediction tree are encoded to generate the binary bitstream.

For geometry decoding based on the prediction tree, the decoding end reconstructs the prediction tree structure by continuously parsing the bitstream. Then the geometric position prediction residual information and quantization parameters of each prediction node are obtained through parsing, and inverse quantization is performed on the prediction residual to restore the reconstructed geometric position information of each node. Finally, the geometric reconstruction at the decoding end is completed.

After the geometry encoding is completed, the geometric information needs to be reconstructed. At present, the attribute coding is mainly performed for the colour information. Firstly, the colour information is converted from the RGB colour space to the YUV colour space. Then, the point cloud is recoloured by using the reconstructed geometric information so that the unencoded attribute information corresponds to the reconstructed geometric information. In the encoding of the colour information, there are mainly two transform methods. A first transform method is distance-based lifting transformation that relies on the LOD partitioning, and a second transform method is the direct RAHT. Both methods will convert the colour information from the spatial domain to the frequency domain and obtain the high-frequency coefficients and the low-frequency coefficients through transform. Finally, the coefficients are quantized and encoded to generate a binary bitstream. Reference can be made to FIG. 4A and FIG. 4B for details.

Further, when the attribute information is predicted by using the geometric information, the nearest neighbouring search may be performed by using the Morton code, and the Morton code corresponding to each point in the point cloud may be obtained from the geometric coordinates of the point. The specific method for calculating the Morton code is described as follows. For three-dimensional coordinates represented by d-bit binary numbers of each component, the three components may be expressed as:

$$\begin{matrix}x = {\sum }_{ℓ = 1}^{d} {2}^{d - ℓ} {x}_{ℓ} , & y = {\sum }_{ℓ = 1}^{d} {2}^{d - ℓ} {y}_{ℓ} , & z = {\sum }_{ℓ = 1}^{d} {2}^{d - ℓ} {z}_{ℓ}\end{matrix} \qquad ( 15 )$$

Here, [symbol] ∈{0,1} are the binary values corresponding to the highest bit ( [symbol] =1) to the lowest bit ( [symbol] =d) of x, y and z, respectively. For the Morton code M, [symbol] are in turn crosswise arranged starting from the highest bit to the lowest bit for x, y and z. The calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 16 )$$

Here, [symbol] ∈{0,1} are the values from the highest bit ( [symbol] =1) to the lowest bit ( [symbol] =3d) of M, respectively. After the Morton code M of each point in the point cloud is obtained, the points in the point cloud are arranged in ascending order of the Morton codes, and the weight value w of each point is set to 1.

It is also understood that for the G-PCC encoding and decoding framework, the general test conditions are as follows.
(1) There are 4 kinds of test conditions:
Condition 1: the geometric position is limited lossy, and the attributes are lossy:
Condition 2: the geometric position is lossless, and the attributes are lossy:
Condition 3: the geometric position is lossless, and the attributes are limited lossy; and
Condition 4: the geometric position is lossless, and attributes is lossless.
(2) The general test sequence includes four categories: Cat1A, Cat1B, Cat3-fused, and Cat3-frame. The Cat2-frame point cloud only includes the reflectance attribute information. The Cat1A and Cat1B point clouds only include the colour attribute information. The Cat3-fused point cloud includes both the colour attribute information and the reflectance attribute information.
(3) There are two kinds of technical routes in total, which are distinguished by the algorithms used in the geometric compression.

### First Technical Route: Octree Encoding Branch

At the encoding end, the bounding box is partitioned continuously to obtain the sub-cubes, and the non-empty sub-cubes (including points in the point cloud) are continuously partitioned until the partitioned leaf nodes are 1× 1×1 unit cubes. In the case of the geometrically lossless encoding, the number of points included in the leaf nodes needs to be encoded. Finally, the geometric octree encoding is completed to generate a binary bitstream.

At the decoding end, the decoding end obtains the occupancy code of each node through continuously parsing in the order of breadth-first traversal, and the nodes are continuously partitioned until the unit cube of 1×1×1 is obtained. In the case of the geometrically lossless decoding, the number of points contained in each leaf node needs to obtained by parsing. Finally, the geometric reconstruction point cloud information is obtained.

### Second Technical Route: Prediction Tree Encoding Branch

At the encoding side, the prediction tree structure is established in two different ways, including: based on KD-Tree (high delay slow mode) and calibrating information by using lidars (low delay fast mode). When calibrating information by using the lidars, each point is partitioned into different lasers, and the prediction tree structure is established according to different lasers. Next, based on the prediction tree structure, each node in the prediction tree is traversed, and the geometric position information of the node is predicted by selecting different prediction modes to obtain the prediction residual. The geometric prediction residual is quantized by using quantization parameters. Finally, through the continuous iteration, the prediction residual, prediction tree structure and quantization parameters of the node position information in the prediction tree are encoded to generate the binary bitstream.

At the decoding end, the decoding end reconstructs the prediction tree structure by continuously parsing the bitstream. Then the geometric position prediction residual information and quantization parameters of each prediction node are obtained through parsing, and inverse quantization is performed on the prediction residual to restore the reconstructed geometric position information of each node. Finally, the geometric reconstruction at the decoding end is completed.

It should also be noted that, as illustrated in FIG. 4A or FIG. 4B, the current G-PCC encoding framework includes three attribute encoding methods: the Predicting Transform (PT), the Lifting Transform (LT) and the Region Adaptive Hierarchical Transform (RAHT). In the first two mode, the prediction encoding is performed on the point cloud based on the generation order of the LOD, while in the RAHT mode, the attribute information is adaptively transformed from the bottom to the top according to the construction level of the octree. These three encoding methods for the attributes of the point cloud will be described in detail below.

### (a) Prediction Encoding of the Attribute Information of the Point Cloud

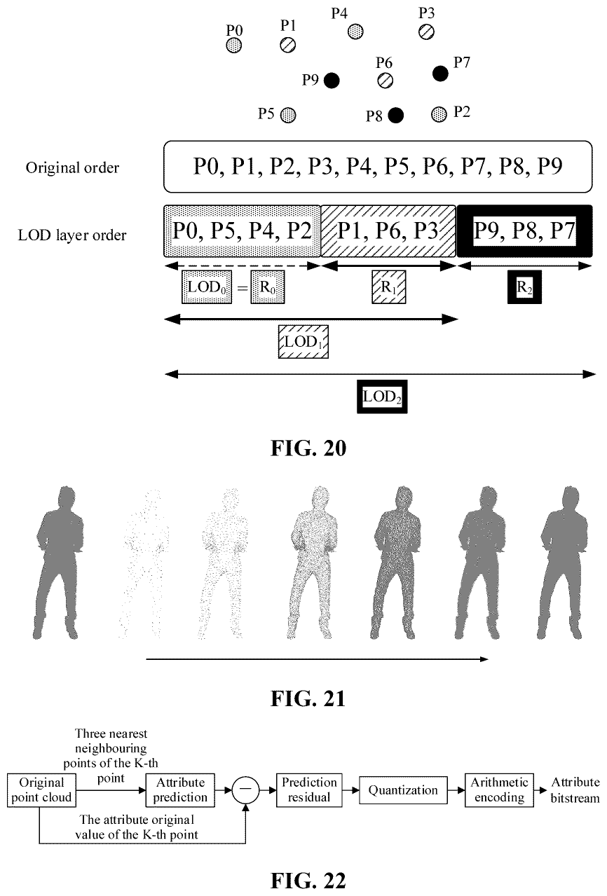

At present, the attribute prediction module of the G-PCC adopts a nearest neighbouring attribute prediction encoding scheme based on Level-of-details (LoDs) structure. The construction methods of the LOD include a distance-based LOD construction scheme, a fixed sampling rate-based LOD construction scheme, an octree-based LOD construction scheme, and the like. In the distance-threshold-based LOD construction scheme, sorting of the Mortons is performed on the point cloud before constructing the LOD to ensure a strong attribute correlation between neighbouring points. FIG. 20 is a schematic diagram of a distance-based LOD construction process. As illustrated in FIG. 20, according to the L Manhattan distances (dl) preset by the user in advance (l=0, 1, . . . L−1), the point cloud is partitioned into L different point cloud detail layers (Rl) (l=0, 1, . . . L−1). Here, (dl) (l=0, 1, . . . L−1) meets dl<dl−1. The construction process of the LOD is described below.
(1) Firstly, all the points in the point cloud are marked as unvisited, and a set V is established to store the visited point sets. (2) For each iteration of l, by traversing the points in the point cloud, the point is ignored if it has been visited. Otherwise the minimum distance D between the current point and the point set V is calculated. The point is ignored if D<dl. Otherwise, the current point is marked as having been visited and the current point is added to the refinement layer Rl and the point set V. (3) The points in the level-of-detail LOD1 are composed of points in the refinement layers R0, R1, R2 . . . R1. (4) The above operations are repeated continuously until all the points are marked as having been visited.

On the basis of the structure of the LOD, the attribute value of each point is linearly weighted predicted by using the reconstructed attribute value of the point in the LOD of the same layer or an upper layer. The maximum number of the reference prediction neighbourings is determined by the high-layer syntax element of the encoder. For the attributes of each point, at the encoding end, rate distortion optimization algorithm is used to select the attributes of N nearest neighbouring points to perform the weighted prediction or select the attribute of a single nearest neighbouring point to perform the prediction. Finally, the selected prediction mode and prediction residual are encoded.

$${Attr}_{i}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} A t {t}_{m} ) \qquad ( 17 )$$

Here, N denotes the number of prediction points in the nearest neighbouring point set of the point i. Pi denotes the combination of N nearest neighbouring points of the point i. Dm denotes the spatial geometric distance between the nearest neighbouring point m and the current point i. Attrm denotes the reconstructed attribute value of the nearest neighbouring point m. Attrᵢ′ denotes the attribute predicted value of the current point i, and the number N of points is a preset value.

In order to trade off the attribute encoding efficiency and the parallel processing between different LOD layers, a switch is introduced in the upper layer syntax element of the encoder to control whether to introduce the LOD intra-layer prediction. If the switch is on, the LOD intra-layer prediction is started, and points within the same LOD layer may be used for the prediction. It should be noted that the LOD intra-layer prediction is always used when the number of the LOD layer is 1.

FIG. 21 is a schematic diagram of a visualization result of a LOD generation process. As illustrated in FIG. 21, a subjective example of a distance-based LOD generation process is provided here. Specifically (from left to right), the points in the first layer represent the outer contour of the point cloud, and with the increase of detail layer, the description of the detail of the point cloud gradually becomes clear.

FIG. 22 is a schematic diagram of an encoding flow of attribute prediction. As illustrated in FIG. 22, regarding the specific processes of the G-PCC attribute prediction, for the original point cloud, firstly, three neighboring points of the K-th point are searched, and then the attribute prediction is performed. According to the difference between the attribute prediction value of the K-th point and the original attribute value of the K-th point, the prediction residual of the K-th point may be obtained. Then, the quantization and arithmetic encoding are performed, and the attribute code rate is generated.

### (i) Selection of an Optimal Prediction Value

After the LOD is constructed, according to the generation sequence of the LOD, firstly, the three nearest neighbouring points of the current point to-be-encoded are found from the encoded data points. The reconstructed attribute values of the three nearest neighbouring points are taken as the candidate prediction values of the current point to-be-encoded. Then, the optimal prediction value is selected according to Rate-Distortion Optimization (RDO). For example, when encoding the attribute value of the point P2 in FIG. 20, the index of the prediction variable of the attribute value of the nearest neighbouring point P4 is set to 1. The indexes of the prediction variable of the attribute value of the next nearest neighbouring point P5 and the third nearest neighbouring point P0 are set to 2 and 3, respectively. The index of the prediction variable of the weighted average of the points P0, P5, and P4 is set to 0, as illustrated in Table 1. Finally, the optimal prediction variable is selected by using RDO. The formula for the weighted average is as follows:

$${\hat{a}}_{i} = Round ( {\sum }_{j = 0}^{2} \frac{{\tilde{w}}_{i j}}{{\sum }_{j = 0}^{2} {\tilde{w}}_{i j}} {\tilde{a}}_{j} ) \qquad ( 18 )$$

Here, \tilde{w}ᵢⱼ denotes the spatial geometry weight of the neighbouring point j to the current point i:

$${\tilde{w}}_{i j} = \frac{1}{{( {x}_{i} - {x}_{i j} )}^{2} + {( {y}_{i} - {y}_{ij} )}^{2} + {( {z}_{i} - {z}_{i j} )}^{2}} \qquad ( 19 )$$

âᵢ denotes the attribute prediction value of the current point i, j denotes the index of the three neighboring points. ãⱼ denotes the attribute value after the reconstruction of the neighbouring point, xᵢ, yᵢ, zᵢ are the geometric position coordinates of the current point i, xᵢⱼ, yᵢⱼ, zᵢⱼ are the geometric coordinates of the neighboring point j.

Exemplarily, Table 1 provides an example sample of candidate prediction values in an attribute encoding.

TABLE 1

| Prediction | |
|---|---|
| Mode | Prediction Value |
| 0 | Weighted average of the attributes of the three |
| | nearest neighbouring points |
| 1 | P4 (the attribute value of the first nearest |
| | neighbouring) |
| 2 | P5 (the attribute value of the second nearest |
| | neighbouring) |
| 3 | P0 (the attribute value of the third nearest |
| | neighbouring) |

### (ii) Attribute Prediction Residuals and Quantization

The attribute prediction value (âᵢ)_{i∈0 . . . k-1} (k is the total number of the points in the point cloud) of the current point i is obtained through the above prediction. Let (aᵢ)_{i∈0 . . . k-1} be the original value of the attribute of the current point, and the attribute residual (rᵢ)_{i∈0 . . . k-1} is:

$${r}_{i} = {a}_{i} - {\hat{a}}_{i} \qquad ( 20 )$$

The prediction residual is further quantized:

$${Q}_{i} = \frac{{r}_{i}}{Q s} \qquad ( 21 )$$

Here, Qᵢ denotes the quantized attribute residual of the current point i. Qₛ denotes a Quantization step (Qₛ), which may be calculated through a Quantization Parameter (QP) specified by the CTC.

(iii) the Encoding End Reconstructs the Attribute Values

The purpose of reconstruction at the encoding end is for the prediction of subsequent points. Before reconstructing the attribute value, the residual should be inversely quantized, \hat{r}ᵢ denotes the inversely quantized residual:

$${\hat{r}}_{i} = {Q}_{i} \times Q s \qquad ( 22 )$$

\hat{r}ᵢ is added to the prediction value âᵢ to obtain the reconstructed value ãᵤ of the point i:

$${\tilde{a}}_{i} = {\hat{r}}_{i} + {\hat{a}}_{i} \qquad ( 23 )$$

At present, there are two kinds of algorithms for the attribute nearest neighbouring search based on the LOD partition: the intra nearest neighbouring search and the inter nearest neighbouring search. The inter nearest neighbouring search algorithm is as follows. The intra nearest neighbouring search may be classified into two algorithms: inter-layer nearest neighbouring search and intra-layer nearest neighbouring search.

### (i) Intra Nearest Neighbouring Search

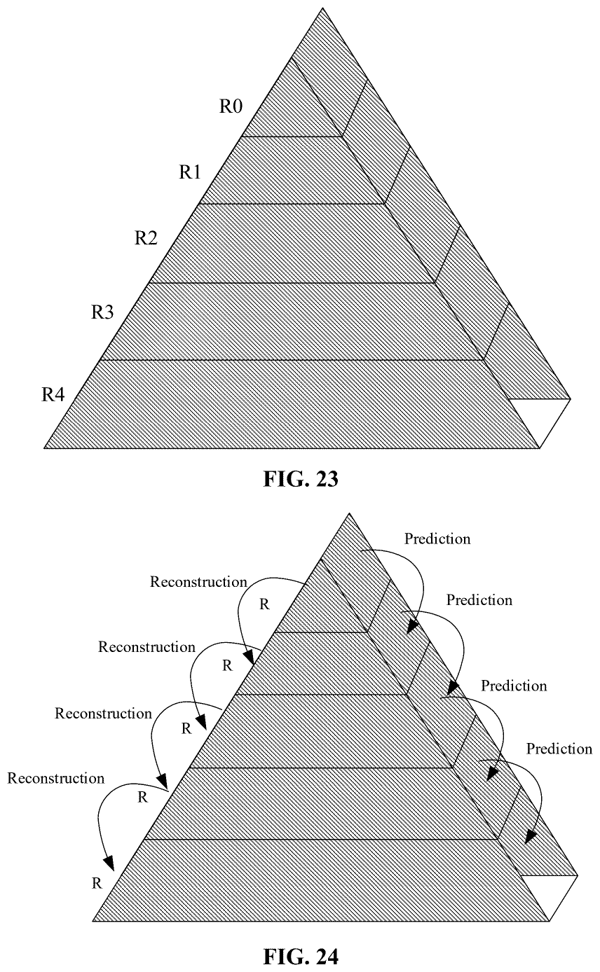

Intra nearest neighbouring search is classified into two algorithms: inter-layer nearest neighbouring search and intra-layer nearest neighbouring search. A pyramid structure is obtained after the LOD partition, as illustrated in FIG. 23.

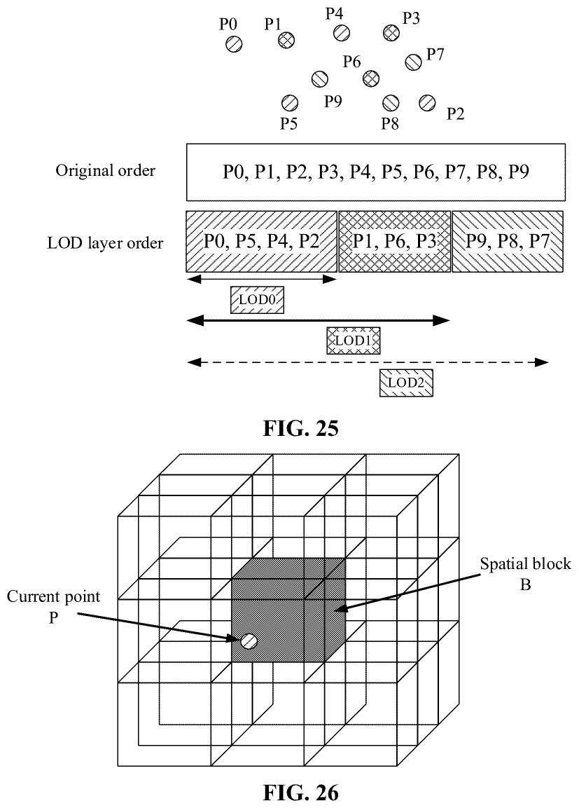

In a specific implementation, the pyramid structure is illustrated in FIG. 24 for the inter-layer nearest neighbouring search. FIG. 25 is a schematic diagram of an LOD construction process for the inter-layer nearest neighbouring search. As illustrated in FIG. 25, different LOD layers are obtained based on geometric information partition, and LOD0, LOD1 and LOD2 are obtained. The points in the LOD0 are used to predict the attributes of the points in the next LOD layer in the process of the inter-layer nearest neighbouring search.

The entire processes of the intra nearest neighbouring search will be introduced in detail below.

Throughout the process of the LOD partition, there are three sets O(k), L(k), and I(k). Here, k is the index of the LOD layer for the LOD partition, and I(k) is the input point set for the current LOD partition. After the LOD partition, an O(k) set and an L(k) set are obtained. The sampling point set is stored in the O(k) set, and L(k) is the point set in the current LOD layer. That is, the entire LOD partition processes are as follows:
(1) Initialization

if k = 0, L(k) ← { }; otherwise, L(k) ← L(k − 1);
O(k) ← { } ;

(2) The sampling points are stored in O(k) by using the LOD partition algorithm, and the rest points are stored in L(k); and
(3) When performing the next iteration, I←O(k).

It should be noted here that since the entire LOD partition process is performed based on the Morton code, O(k), L(k), and I(k) store the indexes of Morton codes corresponding to the points.

When performing the inter-layer nearest neighbouring search (that is, the nearest neighbouring search is performed in the O(k) set for the points within the L(k) set), the specific search algorithm is as follows.

Taking the nearest neighbouring search based on the spatial relationship as an example, when prediction is performed for the current point P, the neighbouring search is performed by using the parent block (Block B) corresponding to the point P. As illustrated in FIG. 26, the points in the coplanar and collinear neighbouring blocks with the current parent block are searched to perform the attribute prediction.

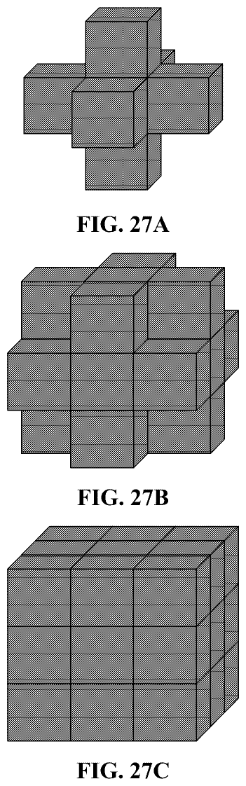

FIG. 27A illustrates a schematic diagram of a coplanar spatial relationship. There are a total of 6 spatial blocks having a relationship with the current parent block. FIG. 27B illustrates a schematic diagram of a coplanar and collinear spatial relationship. There are a total of 18 spatial blocks having a relationship with the current parent block. FIG. 27C illustrates a schematic diagram of a coplanar, collinear, and concurrent spatial relationship. There are a total of 26 spatial blocks having a relationship with the current parent block.

Firstly, the corresponding spatial block is obtained by using the coordinates of the current point. Secondly, the nearest neighbouring search is performed in the previously encoded LOD layer, and the spatial block coplanar, collinear and concurrent with the current block is searched to obtain the N nearest neighbours of the current point.

When the N nearest neighbours of the current point are still not obtained after the coplanar, collinear and concurrent nearest neighbouring search, the N nearest neighbours of the current point will be obtained based on the fast search algorithm. The specific algorithm is as follows.

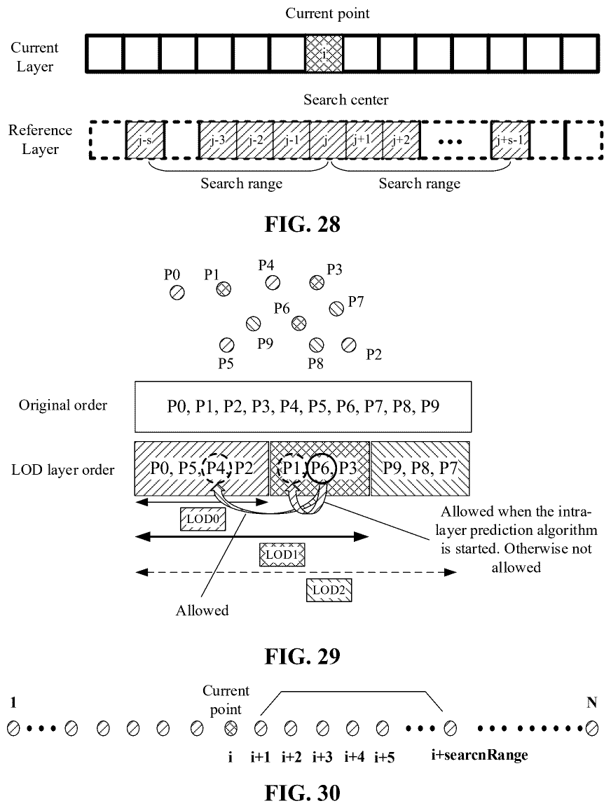

As illustrated in FIG. 28, when the attribute inter-layer prediction is performed, firstly, the Morton code corresponding to the current point is obtained by using the geometric coordinates of the current point to-be-encoded. Secondly, the first reference point (j) in the reference frame that has a greater Morton code than the current point is found based on the Morton code of the current point, and the nearest neighbouring search is performed within the range of [j−searchRange, j+search Range].

Other specific algorithms for updating the nearest neighbours are consistent with the inter nearest neighbouring search algorithm, and will not be described in detail here. The specific algorithms will be mentioned in the inter nearest neighbouring search algorithm.

It should be understood that in the embodiments of the present disclosure, one video frame can be understood as one picture. Exemplarily, the current frame may be understood as a current picture, and the reference frame may be understood as a reference picture.

In another specific implementation, for the intra-layer nearest neighbouring search. FIG. 29 illustrates a schematic diagram of an LOD structure of the nearest neighbouring search in an attribute layer. As illustrated in FIG. 29, if the intra-layer prediction algorithm is enabled (i.e., the syntax element EnableRefferingSamcLoD=1), the nearest neighbouring search within the layer may be allowed. For example, for the LOD1 layer, the nearest neighbouring point of the current point P6 may be P1, and other layers are not allowed. If the syntax element EnableRefferingSameLoD=0 the inter-layer search is allowed in other layers. For example, for the LOD1 layer, the nearest neighbouring point of the current point P6 may be P4. In other words, when the intra-layer prediction algorithm is enabled, the nearest neighbouring search will be performed in the encoded point set of the same layer within the same LOD layer to obtain the N nearest neighbours of the current point (the inter-layer nearest neighbouring search will also be performed).

When the attribute intra-layer prediction is performed, the nearest neighbouring search is performed based on the fast search algorithm. The specific algorithm is illustrated in FIG. 30. The current point is represented by grids. Assuming that the index of the Morton code of the current point is i, the nearest neighbouring search will be performed in [i+1, itsearchRange]. The specific nearest neighbouring search algorithm is consistent with the inter block-based fast search algorithm, which will not be described in detail here.

### (ii) Inter Nearest Neighbouring Search

FIG. 28 is a schematic diagram of an attribute inter-prediction. As illustrated in FIG. 28, when the attribute inter-prediction is performed, firstly, the Morton code corresponding to the current point is obtained by using the geometric coordinates of the current point to-be-encoded. Secondly, the first reference point (j) in the reference frame that has a greater Morton code than the current point is found based on the Morton code of the current point, and the nearest neighbouring search is performed within the range of [j−search Range, j+searchRange].

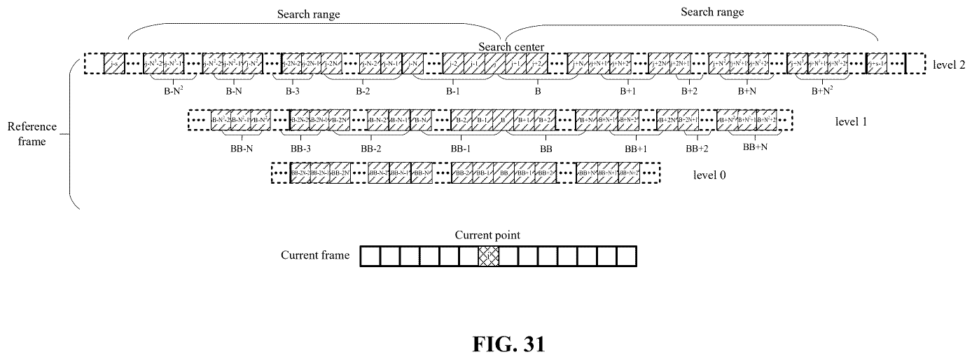

At present, when performing the intra and inter nearest neighbouring search, the neighbouring search is performed based on the block, and reference can be made to FIG. 31 for details. As illustrated in FIG. 31, when performing the neighbouring search on the current point (index of Morton code is i), the points in the reference frame are firstly divided into N (N=3) layers according to the Morton codes. The specific division algorithm is as follows:

The first layer: assuming that the points of the reference frame are num Points, firstly the points in the reference frame are divided into blocks, with M (M=25=32) points per block:

The second layer: based on the first layer, similarly, the blocks of the first layer are also divided into blocks in the order of Morton codes, with M (M=25=32) blocks per block:

The third layer: based on the second layer, similarly, the blocks of the second layer are also divided into blocks in the order of Morton codes, with M (M=25=32) blocks per block:

Finally, the prediction structure illustrated in FIG. 31 is obtained.

The attribute prediction is performed based on the prediction structure illustrated in FIG. 31. Assuming that the index of Morton code of the current point to-be-encoded is i, the first point in the reference frame that has the Morton code greater than or equal to the Morton code of the current point is firstly obtained, and the index is j. Secondly, the block index of the reference point is calculated based on j, and the specific calculation method is as follows:

First layer: BucketSize_0=2⁵= 32;
Second layer: BucketSize_1=2⁵= 32×BucketSize_0=1024;
Third layer: BucketSize_2=2⁵= 32×BucketSize_1=32768.

Assuming that the reference range in the prediction frame of the current point is [j−searchRange, j+searchRange], the starting index of the third layer is calculated by using the j−searchRange, and the termination index of the third layer is calculated by using the j+searchRange. Then, firstly, in the blocks of the third layer, it is determined whether the nearest neighbouring search needs to be performed for some blocks of the second layer. Secondly, in the second layer, it is determined whether the search needs to be performed for each block of the first layer. If the nearest neighbouring search needs to be performed for some blocks of the first layer, determination will be performed point by point for some points in the blocks of the first layer to update the nearest neighbour.

Hereafter, the algorithm of calculating blocks based on index is introduced. Assuming that the index of the Morton code corresponding to the current point is index, the index of the corresponding block of the third layer is:

$$idx\_ 2 = index / BucketSize\_ 2 \qquad ( 24 )$$

After obtaining the index idx_2 of the block of the third layer, the starting index and the termination index of the block corresponding to the current block of the second layer may be obtained by using idx_2:

$$startIdx 1 = idx\_ 2 \times BucketSize\_ 1 \qquad ( 25 )$$

$$endIdx = idx\_ 2 \times BucketSize\_ 1 + BucketSize\_ 1 - 1 \qquad ( 26 )$$

Similarly, based on the same algorithm, the index of the block of the first layer is obtained based on the index of the block of the second layer.

When performing the nearest neighbouring search based on the blocks, firstly, it is determined whether the nearest neighbouring search needs to be performed for the current block, that is, the nearest neighbouring search of the block is filtered. Two variables minPos and maxPos may be obtained for each spatial block, minPos denotes the minimum value of the block, and maxPos denotes the maximum value of the block.

It is assumed that the distance of the farthest point among the N nearest neighbours searched for the current point is Dist, the coordinates of the to-be-encoded point are (x, y, z), and the current block is represented as (minPos, maxPos). Here, minPos is the minimum value on three dimensions of the bounding box and maxPos is the maximum value on three dimensions of the bounding box, the distance D between the current point and the bounding box is calculated as follows:

int dx=int (std:: max (std:: max (minPos [0]-point [0], 0), point [0]-maxPos [0]));
int dy=int (std:: max (std:: max (minPos [1]-point [1], 0), point [1]-maxPos [1]));
int dz=int (std:: max (std:: max (minPos [2]-point [2], 0), point [2]-maxPos [2]));
D=dx+dy+dz;

When D is less than or equal to Dist, the points in the current block will be traversed.

### (b) Lifting Transform Encoding of Point Cloud Attribute Information.

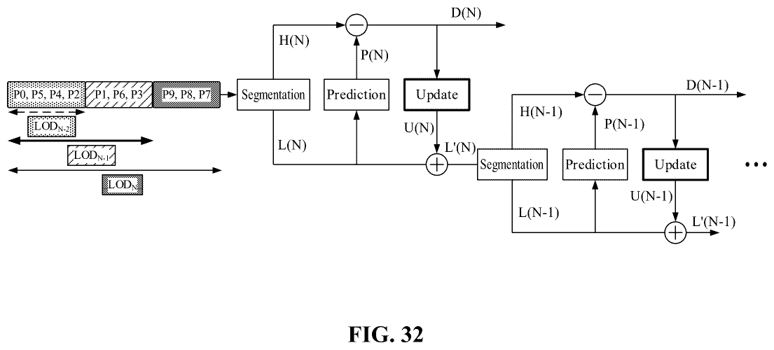

FIG. 32 is a schematic diagram of an encoding flow of a lifting transform. In the lifting transform, prediction encoding is also performed on the attribute of the point cloud based on the LOD. The difference from the prediction transform is that in the lifting transform, the LOD is firstly partitioned into high and low layers, prediction is performed according to the reverse order of the generation of the layers of the LOD, and an update operator is introduced in the prediction process to update the quantization weight of the point in the low-layer LOD, so as to improve the accuracy of prediction. This is because the attribute value of the points in the low-layer LOD will be frequently used to predict the attribute value of the points in the high-layer LOD, and the points in the low-layer LOD should have greater influence.

### Step 1: Segmentation Process.

The segmentation process is to divide the complete LOD layer into a low LOD layer L(N) and a high LOD layer H(N). If a point cloud has three layers of LOD (that is, (LOD₁)_{l=0,1,2}), after the segmentation, LOD₂ is a high LOD layer and is denoted as H(N), and (LOD₁)_{l=0,1} is a low LOD layer and is denoted as L(N).

### Step 2: Prediction Process

The point in the high layer LOD selects the attribute information of the nearest neighbouring point from the low layer as the attribute prediction value P(N) of the current to-be-encoded point, and the prediction residual D(N) is denoted as:

$$D ( N ) = H ( N ) - P ( N ) \qquad ( 27 )$$

### Step 3: Update Process

The attribute prediction residual D(N) in the high-layer LOD is updated to obtain U(N), and the attribute value of the point in the low-layer LOD is lifted by using U(N), as shown in the following formula:

$${L}^{′} ( N ) = L ( N ) + U ( N ) \qquad ( 28 )$$

The above processes will be iterated continuously to the lowest layer LOD according to the order of LOD from high to low.

Because the LOD-based prediction scheme makes the points in the lower layer of LOD have greater influence, the lifting wavelet transform-based transform scheme introduces quantization weights, and the prediction residual is updated according to the prediction residual D(N) and the distance between the prediction point and the neighbouring point. Finally, the quantization weights in the transform process are used to adaptively quantize the prediction residual. It should be noted here that the value of the quantization weight of each point may be determined through the geometric reconstruction at the decoding end, and it is not necessary to encode the quantization weight.

### (c) Region Adaptive Hierarchical Transform.

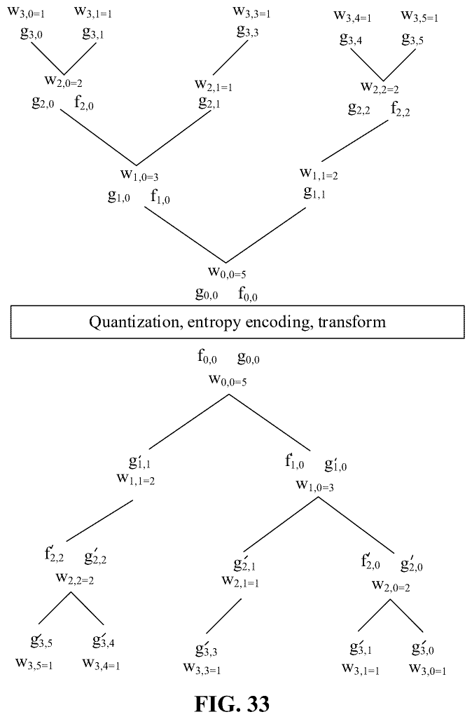

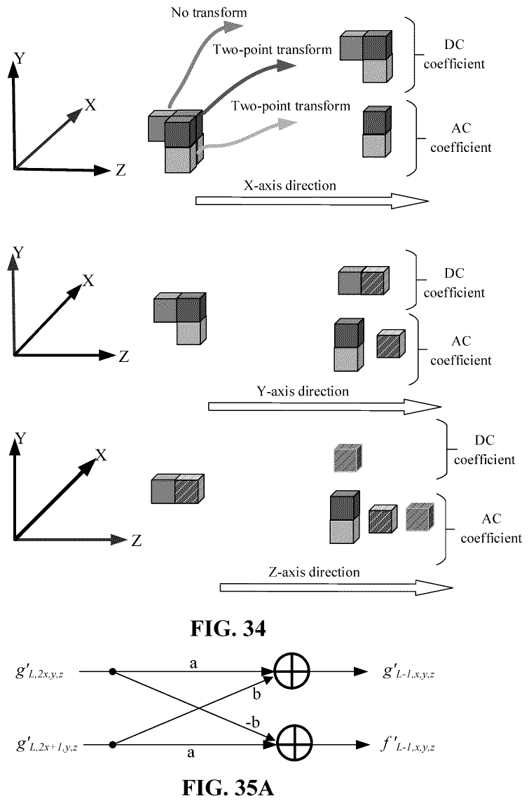

Region adaptive hierarchical transform (RAHT) is a kind of Haar wavelet transform, which can transform the attribute information of the point cloud from spatial domain to frequency domain, and further reduce the correlation between the attributes of the point cloud. The main principle is to transform the nodes of each layer from the three dimensions X, Y, and Z in a bottom-up manner according to the octree structure (as illustrated in FIG. 34), and iterate until the root node of the octree. As illustrated in FIG. 33, the basic principle is that the wavelet transform is performed based on the hierarchical structure of the octree, the attribute information is associated with the octree nodes, the attributes of the occupied nodes of the same parent node are recursively transformed in the bottom-up manner, and the nodes of each layer are transformed from three dimensions X, Y, and Z until the transform reaches the root node of the octree. In the process of hierarchical transform, the low-pass/low-frequency (DC) coefficients obtained after the transform of nodes of the same layer are transferred to the nodes of the next layer for continued transform, and all the high-pass/high-frequency (AC) coefficients may be encoded by the arithmetic encoder.

During the transform process, the transformed DC coefficients (DC components) of the same layer nodes will be transferred to the upper layer for continuous transform, and the transformed AC coefficients (AC components) of each layer will be quantized and encoded. The main transform process will be described below.

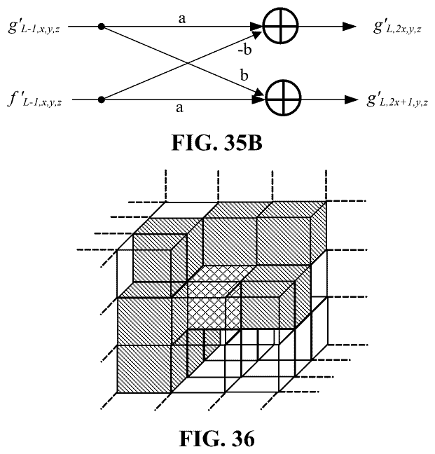

FIG. 35A is a schematic diagram of a process of a RAHT forward transform, and FIG. 35B is a schematic diagram of a process of an RAHT inverse transform. For the transform and inverse transform corresponding to the RAHT, it is assumed that

$${g}_{L , 2 x , y , z}^{′} and {g}_{L , 2 x + 1 , y , z}^{′}$$

are two attribute DC coefficients of two neighboring points of the layer L. After the linear transform, the information of the layer (L−1) is AC coefficient

$${f}_{L - 1 , x , y , z}^{′}$$

and DC coefficient

$${g}_{L - 1 , x , y , z}^{′} .$$

then, no transform will be performed on

$${f}_{L - 1 , x , y , z}^{′}$$

Quantization encoding will be performed directly on

$${f}_{L - 1 , x , y , z}^{′}$$

and the nearest neighbours will continue to be found for the transform of the

$${g}_{L - 1 , x , y , z}^{′} .$$

If the nearest neighbours cannot be found, it will be directly transferred to the layer (L-2). That is, the RAHT transform is only valid for nodes with neighbouring points, and nodes without neighbouring points will be directly transferred to the upper layer. In the above transform process, the weights (the number of non-empty child nodes in the node) corresponding to

$${g}_{L , 2 x , y , z}^{′} and {g}_{L , 2 x + 2 , y , z}^{′}$$

are respectively

$${w}_{L , 2 x , y , z}^{′} and {w}_{L , 2 x + 1 , y , z}^{′}$$

(abbreviated as

$${w}_{0}^{′} and {w}_{1}^{′} ) ,$$

and theweight of

$${g}_{L - 1 , x , y , z}^{′} is {w}_{L - 1 , x , y , z}^{′} ,$$

then the general transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 29 )$$

Here, T_{w0,w1} is the transform matrix:

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 30 )$$

The transform matrix will be updated adaptively with the weights corresponding to the points. The above process will be iteratively updated according to the partition structure of the octree until the root node of the octree.

In a specific implementation, for the region adaptive hierarchical intra prediction transform encoding, prediction may be performed on the basis of the RAHT transform encoding. As illustrated in FIG. 33, the RAHT attribute transform is based on the sequence of the octree levels, and the voxel level is continuously transformed until the root node is obtained, thereby completing the entire hierarchical transform encoding of the attribute. In the predictive transform encoding, the attribute prediction transform coding is also performed based on the hierarchical order of the octree, but the transform is continuously performed from the root node to the voxel level. In the process of each RAHT attribute transform, the attribute prediction transform coding is performed based on 2×2×2 blocks, and the specific process is illustrated in FIG. 36. As illustrated in FIG. 36, it may be seen that the block filled with grids is the current block to-be-encoded, and the blocks filled with slashes are some neighbouring blocks that are coplanar and collinear with the current block to-be-encoded. The attributes of the current block are normalized in the following manner:

$${A}_{node} = {\sum }_{p ∈ node} attribute ( p ) ;$$

$${w}_{node} = {\sum }_{p ϵ node} 1 = \{ p ∈ node \} ;$$

$${a}_{node} = {A}_{node} / {w}_{node} .$$

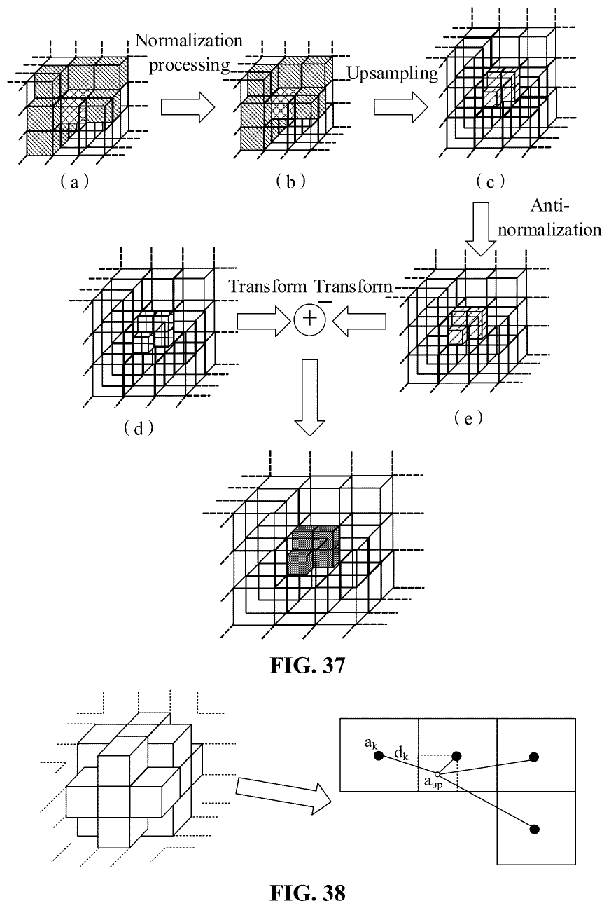

Firstly, the attribute of the current block is obtained through the attributes of the points included in the current block (i.e., Anode). The attributes of points included in the current block are simply summed, and then the attributes of the current block and the number of points in the current block are normalized to obtain the mean value anode of the attributes of the current block. The mean value of the attributes of the current block is used to perform the attribute transform encoding. The specific encoding process is illustrated in FIG. 37.

As illustrated in FIG. 37, the overall flow of the RAHT attribute prediction transform coding is illustrated. Here, (a) is the current block and some coplanar and collinear neighbouring blocks, (b) is the normalized block, (c) is the up-sampled block, (d) is the attribute of the current block, (e) is the attribute of the prediction block obtained by using the neighbouring attribute of the current block for the linear weighted fitting, and finally the attribute transform is respectively performed on the attribute of the prediction block and neighbouring attribute of the current block to obtain DC and AC coefficients. The prediction encoding is performed on the AC coefficients.

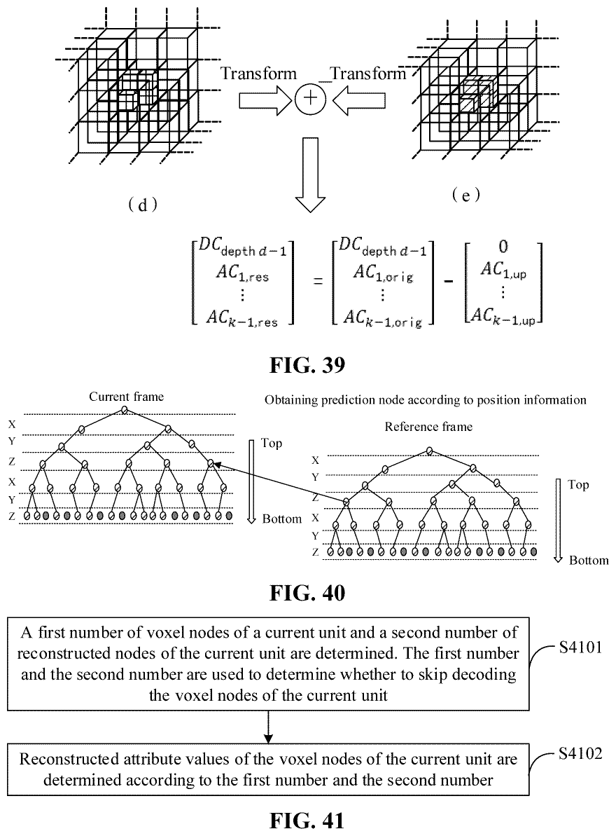

The prediction attribute of the current block may be obtained by performing the linear fitting as illustrated in FIG. 38. As illustrated in FIG. 38, firstly, 19 neighbouring blocks of the current block are obtained. Secondly, the linear weighting prediction is performed on the attribute of each sub-block by using the spatial geometric distance between the neighbouring block and the each sub-block of the current block. Finally, the attribute of the prediction block obtained by linear weighting is transformed. The specific attribute transform is illustrated in FIG. 39.

In FIG. 39, (d) denotes the original attribute value, and the corresponding attribute transform coefficient is as follows:

$$[ \begin{matrix}* \\ {AC}_{1 , orig} \\ ⋮ \\ {AC}_{k - 1 , orig}\end{matrix} ] = {T}_{node} [ \begin{matrix}{A}_{1} , orig / \sqrt{{w}_{1}} \\ ⋮ \\ {A}_{k , orig} / \sqrt{{w}_{k}}\end{matrix} ] \qquad ( 31 )$$

(e) denotes the attribute prediction value, and the corresponding attribute transform coefficient is as follows:

$$[ \begin{matrix}* \\ {AC}_{1 , up} \\ ⋮ \\ {AC}_{k - 1 , up}\end{matrix} ] = {T}_{node} [ \begin{matrix}{A}_{1 , up} / \sqrt{{w}_{1}} \\ ⋮ \\ {A}_{k , up} / \sqrt{{w}_{k}}\end{matrix} ] \qquad ( 32 )$$

The subtraction operation is performed on the original attribute value and the predicted attribute value, and the prediction residual is as follows:

$$[ \begin{matrix}{DC}_{depth d - 1} \\ {AC}_{1 , res} \\ ⋮ \\ {AC}_{k - 1 , res}\end{matrix} ] = [ \begin{matrix}{DC}_{depth d - 1} \\ {AC}_{1 , orig} \\ ⋮ \\ {AC}_{k - 1 , orig}\end{matrix} ] - [ \begin{matrix}0 \\ {AC}_{1 , up} \\ ⋮ \\ {AC}_{k - 1 , up}\end{matrix} ] \qquad ( 33 )$$

In another specific implementation, for the region adaptive hierarchical inter prediction transform coding, in the first solution of the G-PCC attribute inter-prediction coding, the process is similar to that of the intra-prediction coding. Firstly, based on geometric information, the RAHT attribute transform encoding structure is constructed. That is, the voxel level is continuously transformed until the root node is obtained, so that the entire hierarchical transform encoding of the attribute is completed. In this way, an intra encoding structure and an inter ecoding structure are constructed. The inter coding structure of the RAHT attribute is illustrated in FIG. 40.

As illustrated in FIG. 40, firstly, the co-location prediction node of the to-be-encoded node is obtained in the reference frame by using the geometric information of the current to-be-encoded node. Secondly, the prediction attribute of the current to-be-encoded node is obtained by using the geometric information and attribute information of the reference node.

The attribute prediction value of the current to-be-encoded node is obtained according to the following two different manners.
(1) The inter prediction node of the current node is valid. That is, the co-location node exists, and the attribute of the prediction node is directly used as the attribute prediction value of the current to-be-encoded node.
(2) The inter prediction node of the current node is invalid. That is, the co-location node does not exist, and the attribute prediction value of the neighbouring node in the frame is used as the attribute prediction value of the to-be-encoded node.

Finally, the obtained attribute prediction value is used to predict the attribute of the current to-be-encoded node, thereby completing the entire prediction encoding of the attribute.

In another specific implementation, for the region adaptive hierarchical inter prediction transform encoding, the second solution of the G-PCC attribute inter-prediction coding differs from the first solution of the G-PCC attribute inter-prediction coding in that: if the second solution of the inter-prediction coding is enabled, the RAHT attribute transform encoding structure is firstly constructed based on the geometric information of the current to-be-encoded node. That is, the node merge is continuously performed from the voxel level until the root node of the entire RAHT transform tree is obtained, so that the entire hierarchical transform encoding structure of the attribute is completed. Secondly, according to the RAHT transform structure, the partitioning is enabled from the root node to obtain N child nodes of each node (N is less than or equal to 8). In the second solution of the inter-prediction coding, firstly, the attributes of the N child nodes are independently orthogonally transformed by using the RAHT transform to obtain the DC coefficients and the AC coefficients. Then, the attribute inter prediction is performed on the AC coefficients of the N child nodes in the following three manners.
(1) The inter prediction node of the current node is valid. That is, the co-location node exists, and the attribute of the prediction node is directly used as the attribute prediction value of the current to-be-encoded node.
(2) A node with exactly the same position as the current node may be found from the buffer of the reference picture for the current node. That is, if the co-location node exists, the AC coefficients of M child nodes included in the co-location node are directly used as the attribute prediction values of the AC coefficients of N child nodes of the current node.

If the AC coefficients of the prediction node are not zero, the AC coefficients of the prediction node are directly used as the prediction values.

If the AC coefficients of the prediction node are zero, the AC coefficients of the child node corresponding to the intra prediction are taken as the prediction values.
(3) The inter prediction node of the current node is invalid. That is, the co-location node does not exist, and the attribute prediction value of the neighbouring node in the picture is used as the attribute prediction value of the to-be-encoded node.

Simply put, during the RAHT attribute transform coding of the G-PCC, the encoding and decoding may be performed according to the order from the root node to the child node. Firstly, the geometric information of the current layer node is used to recover the child node of the current layer in the order of Z, Y and X. Secondly, the reconstructed attributes of the parent node layer are used to perform the prediction decoding on the attributes of the nodes of the current layer, so that the attributes of the nodes of the current layer can be recovered until the child node is obtained by transform (i.e., voxel level). However, in the G-PCC, if the number of the nodes of the current layer is exactly the same as the number of child nodes of the nodes of the current layer, it is indicated that each node of the current layer has only one child node, that is, the AC coefficients are not generated for the current layer. However, in the existing encoding solution, it is still necessary to sequentially perform the transform, prediction and the like on the nodes of the current layer, which will increase the complexity of the encoding and decoding of the RAHT attribute transform and introduce redundant operations. Similarly, in the existing RAHT encoding solution, the encoding end and decoding end firstly complete the encoding and decoding of the attribute information of the non-node layer (that is, the size of the node is greater than or equal to 1×1×1), and finally encode and decode the attribute information of the voxel-level nodes. The reason is that there will be a scenario in the point cloud where there are duplicate points in the point cloud: therefore, it is necessary to firstly complete the encoding and decoding of the attribute information of the non-voxel-level points, and then complete the encoding and decoding of the attribute information of the voxel-level points. Since when there do not exist duplicate points in the current coding unit, the attribute information of the voxel-level points is still required to be encoded and obtained by decoding, the time complexity of encoding/decoding of the attribute transform is further improved.

Based on this, the embodiments of the present disclosure provide an encoding method. A first number of voxel nodes of the current unit and the second number of reconstructed nodes of the current unit are firstly determined, and then it is determined whether to skip encoding attribute information of the voxel nodes of the current unit according to the first number and the second number. The embodiments of the present disclosure further provide a decoding method. A first number of voxel nodes of a current unit and a second number of reconstructed nodes of the current unit are determined. The first number and the second number are used to determine whether to skip decoding the voxel nodes of the current unit. Then, reconstructed attribute values of the voxel nodes of the current unit are determined according to the first number and the second number.

In this way, when the attribute reconstruction is performed on each voxel node, the judgment condition of whether the attribute encoding and decoding is performed on each voxel node is optimized. Specifically, if there are no duplicate nodes in the current unit (i.e., the first number is the same as the second number), it is not necessary to encode and decode the voxel nodes of the current unit in this case. In this way, on the basis of ensuring the efficiency of encoding and decoding of the attributes of the point cloud, the time complexity of the encoding and decoding of the attributes of the point cloud can be reduced, and the code rate can be saved, thereby improving the encoding and decoding performance of the point cloud.

Hereinafter, various embodiments of the present disclosure will be described in detail below with reference to the accompanying drawings.

In an embodiment of the present disclosure, with reference to FIG. 41, a flowchart of a decoding method according to an embodiment of the present disclosure is illustrated. As shown in FIG. 41, the method may include operation S4101 to operation 4102.

In operation S4101, a first number of voxel nodes of a current unit and a second number of reconstructed nodes of the current unit are determined. The first number and the second number are used to determine whether to skip decoding the voxel nodes of the current unit.

It should be noted that, in the embodiments of the present disclosure, the decoding method is applied to a point cloud decoder (which may be simply referred to as a “decoder”). The decoding method may be a point cloud decoding method, and specifically, may be a point cloud attribute decoding method for the point cloud attribute, and more specifically, may be a skip decoding method for the RAHT transform prediction of the point cloud attribute. Here, the optimization primarily targets whether to skip decoding the nodes of the current layer and whether to skip decoding the voxel nodes when partitioning to the voxel level, so that the time complexity of the encoding and decoding of the attribute transform can be reduced, and the efficiency of the encoding and decoding of the attribute transform will not be affected.

It should also be noted that in the embodiments of the present disclosure, the current unit may be a current decoding unit that is currently to be decoded, and here, the current unit may be a slice. In some embodiments, the method may further include the following operations. Nodes of the current unit are partitioned to determine at least one layer. When nodes of the last layer are partitioned to the voxel level, the voxel nodes of the current unit and the first number of the voxel nodes are determined.

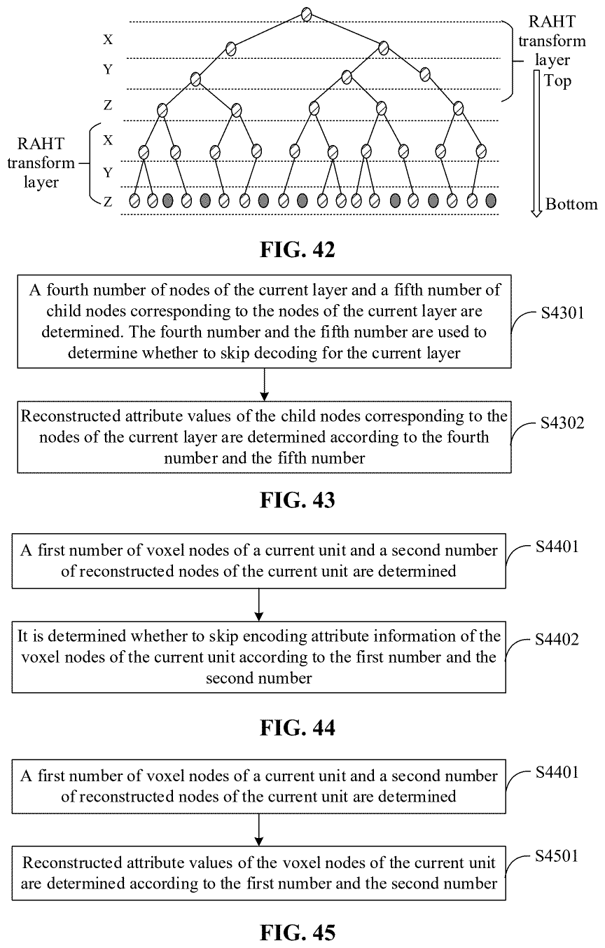

Exemplarily, in the RAHT attribute transform, the order of the RAHT attribute transform involves sequentially partitioning starting from the root node until the partitioning reaches the voxel level. Specifically, the partitioning is stopped until the unit cubes of 1×1×1 are obtained by partitioning, so that the encoding and reconstruction of the attributes of the entire point cloud can be completed. Here, as illustrated in FIG. 42, a layer obtained by performing down-sampling once along the Z-axis. Y-axis, and X-axis is a RAHT transform layer (i.e., a “layer”). Then, when the unit cubes of 1×1×1 are obtained by partitioning, it is indicated that the partitioning reaches the voxel level. In this case, the voxel nodes and the first number of the voxel nodes may be determined.

It should be further noted that, in the embodiments of the present disclosure, the voxel node represents a node corresponding to the voxel level when the partitioning is performed form the root node to the voxel level, and the size of the voxel node is 1×1×1. The reconstructed node represents the node on which the attribute reconstruction is performed in the current unit. Before the attribute decoding is performed on the nodes of the current unit, the geometric information of the nodes of the current unit has been completely obtained by decoding. In this case, the second number of the reconstructed nodes of the current unit may be determined, so that it is possible to determine whether the first number is consistent with the second number. That is to say, in the embodiments of the present disclosure, before the attribute decoding is performed on the voxel nodes, it is necessary to first determine whether the first number is the same as the second number, and then determine whether to skip decoding the voxel nodes of the current unit.

In some embodiments, when the first number is the same as the second number, decoding the voxel nodes of the current unit is skipped.

In some embodiments, when the first number is different from the second number, attribute decoding is performed on duplicate nodes among the voxel nodes, and decoding remaining voxel nodes other than the duplicate nodes among the voxel nodes is skipped.

In the embodiments of the present disclosure, there may be duplicate nodes among the voxel nodes obtained by partitioning the current unit, so that the first number may be inconsistent with the second number. When there are no duplicate nodes among the voxel nodes obtained by partitioning the current unit, the first number is consistent with the second number. Otherwise, when there are duplicate nodes among the voxel nodes obtained by partitioning the current unit, the first number is inconsistent with the second number, and in this case, it is necessary to perform the attribute decoding on the duplicate nodes. Here, the duplicate nodes (which may also be simply referred to as “duplicate points”) refer to multiple nodes having the same geometric information and different pieces of attribute information.

In operation S4102, reconstructed attribute values of the voxel nodes of the current unit are determined according to the first number and the second number.

It should be noted that, in the embodiments of the present disclosure, the reconstructed attribute values of the voxel nodes of the current unit may be directly copied from the reconstructed attribute values of the reconstructed nodes of the current unit. However, the reconstructed attribute values of the duplicate nodes cannot be obtained through copying, and in this case, it is necessary to determine the reconstructed attribute values by decoding the bitstream. That is to say, here, it is determined, through comparison between the magnitude of the first number and the magnitude of the second number, how the reconstructed attribute values of the voxel nodes of the current unit are determined.

In some embodiments, when the first number is the same as the second number, the operation that the reconstructed attribute values of the voxel nodes of the current unit are determined according to the first number and the second number may include the operation that the reconstructed attribute values of the voxel nodes of the current unit are set as reconstructed attribute values of the reconstructed nodes of the current unit.

Exemplarily, when the first number is the same as the second number, decoding the attribute information of the voxel nodes of the current unit may be skipped. In this case, the reconstructed attribute values of the voxel nodes may be directly copied as the reconstructed attribute values of the reconstructed nodes of the current unit.

In some embodiments, when the first number is the different from the second number, the operation that the reconstructed attribute values of the voxel nodes of the current unit are determined according to the first number and the second number may include the following operations. A bitstream is decoded to determine reconstructed attribute values of the duplicate nodes. The reconstructed attribute values of the duplicate nodes are taken as a reconstructed attribute value of a first reconstructed node of the current unit, and reconstructed attribute values of the remaining voxel nodes other than the duplicate nodes among the voxel nodes are set as reconstructed attribute values of remaining reconstructed nodes other than the first reconstructed node of the current unit.

Exemplarily, when the first number is different from the second number, it indicates that there are duplicate nodes among the voxel nodes obtained by partitioning the current unit. In this case, the decoding is performed to determine reconstructed attribute values of the duplicate nodes. Then the reconstructed attribute values of the duplicate nodes are taken as the reconstructed attribute value of the first reconstructed node of the current unit, and the reconstructed attribute values of the remaining voxel nodes other than the duplicate nodes are copied as the reconstructed attribute values of the remaining reconstructed nodes other than the first reconstructed node of the current unit.

Exemplarily, for the multiple nodes (i.e., the duplicate nodes) having the same geometric information and different pieces of attribute information, the encoding end may use a timer to sum the pieces of the attribute information of the multiple nodes, and determine the summed value as the attribute information of the node corresponding to the geometric information. Subsequently, at the decoding end, the timer may also be used to separate the respective piece of attribute information of each one of the multiple nodes from the attribute information, so as to obtain the reconstructed attribute values of the duplicate nodes.

In some embodiments, the operation that the bitstream is decoded to determine the reconstructed attribute values of the duplicate nodes may include the following operations. A timer is set. The timer is started when the decoding to determine the reconstructed attribute values of the duplicate nodes begins. It is determined that all the reconstructed attribute values of the duplicate nodes are determined through the decoding when a timing of the timer reaches a preset value.

It should be noted that when the first number is different from the second number, a third number of the duplicate nodes among the voxel nodes is determined based on a difference between the first number and the second number. The setting of the timer is associated with the third number.

Exemplarily, a timer may be used to determine whether all the reconstructed attribute values of the duplicate nodes are determined through the decoding. In the case that the timer is in the counting mode, when the decoding to determine the reconstructed attribute values of the duplicate nodes begins, the initial value of the timer is 0), and when the timer counts to the third number, all the reconstructed attribute values of the duplicate nodes are determined through the decoding. In the case that the timer is in the countdown mode, when the decoding to determine the reconstructed attribute values of the duplicate nodes begins, the initial value of the timer is the third number, and when the timer counts to 0, all the reconstructed attribute values of the duplicate nodes are determined through the decoding. After all the reconstructed attribute values of the duplicate nodes are determined through the decoding, there are no duplicate nodes among the subsequent voxel nodes, the attribute decoding of these subsequent nodes can be skipped, and the reconstructed attribute values of the subsequent remaining voxel nodes may be directly copied as the reconstructed attribute values of the final remaining reconstructed nodes.

It should be understood that in the embodiments of the present disclosure, at least one layer may include the current layer, and the current layer may be the current to-be-decoded RAHT transform layer, or may be referred to as a “RAHT attribute decoding layer”. FIG. 43 is a schematic flowchart of another decoding method according to an embodiment of the present disclosure. As shown in FIG. 43, the method may include operation S4301 to operation 4302.

In operation S4301, a fourth number of the nodes of the current layer and a fifth number of child nodes corresponding to the nodes of the current layer are determined. The fourth number and the fifth number are used to determine whether to skip decoding for the current layer.

It should be noted that, in the embodiments of the present disclosure, the fourth number of the nodes of the current layer may be first determined, and at the same time, the fifth number of the child nodes corresponding to the nodes of the current layer may be determined. Before the attribute decoding is performed on the nodes of the current layer, since the geometric information of the nodes of the current layer has been determined through the decoding, the number of the nodes of the current layer (i.e., the “fourth number”) and the number of the child nodes of the nodes of the current layer (i.e., the “fifth number”) may be determined according to the geometric information of the nodes of the current layer.

Further, in the embodiments of the present disclosure, it is necessary to first construct the RAHT attribute transform structure based on the geometric information of the points of the point cloud, and the decoding may be performed in the order from the root node to the child node. The geometric information of the nodes of the current layer is used to recover the child nodes of the current layer in the order of Z, Y and X. Secondly, the reconstructed attributes of the nodes of previous layer are used to perform the prediction decoding to obtain the attributes of the nodes of the current layer, so that the reconstructed attribute values of the nodes of the current layer may be obtained by recovering until the transform is performed to the voxel level, thereby obtaining the RAHT attribute transform structure including at least one RAHT transform layer.

It should be noted that, in the embodiments of the present disclosure, the RAHT attribute transform may be performed based on the sequence of the octree levels. Based on the hierarchical order of the octree, the transform may be performed continuously from the voxel level to the root node, thereby constructing the octree. Then, in the predictive transform process, the attribute prediction transform coding is also performed based on the hierarchical order of the octree, but the transform is continuously performed from the root node to the voxel level.

It should be understood that, in the embodiments of the present disclosure, a layer obtained by sequentially down-sampling once along preset directions (e.g., the Z direction, the Y direction, and the X direction) may be defined as a RAHT transform layer, such as the current layer.

It is to be noted that, in the embodiments of the present disclosure, for the current layer, the current layer may include at least one point. Herein, for the at least one point of the current layer, when the decoding is performed on the current layer, the at least one point may be used as the to-be-decoded node of the current layer.

Further, in the embodiments of the present disclosure, each point of the current layer corresponds to one respective piece of geometric information and one respective piece of attribute information. Herein, the geometric information represents the spatial relationship of the point, and the attribute information represents the information related to the attributes of the point.

Herein, the attribute information may be the colour information, the reflectance, or other attributes, which is not limited in the embodiments of the present disclosure. Herein, when the attribute information is the colour information, specifically, the attribute information may be colour information of any colour space. Exemplarily, the attribute information may be the colour information of the RGB space, the colour information of the YUV space, the colour information of the YCbCr space, or the like, which is not limited in the embodiments of the present disclosure.

It should also be noted that in the embodiments of the present disclosure, when the RAHR transform encoding is performed, the attribute transform and the inverse transform of the non-voxel-level nodes are first completed, and then, the transform of the voxel-level nodes is completed. This is because of the phenomenon where the duplicate nodes exist in the point cloud.

Accordingly, in the embodiments of the present disclosure, when the nodes of the current layer are at the non-voxel level, the fourth number may represent the number of occupied nodes of the current layer. The fifth number may then represent the number of occupied child nodes of the nodes of the current layer.

Accordingly, in the embodiments of the present disclosure, when the nodes of the current layer are at the voxel level, the fourth number may represent the number of occupied nodes of the current layer. The fifth number may represent the number of to-be-decoded nodes.

That is to say, in the embodiments of the present disclosure, the fourth number is the number of valid nodes (i.e., the occupied nodes) of the current layer. For the non-voxel-level nodes, the fifth number is the number of valid child nodes (i.e., the occupied child nodes) of the nodes of the current layer. For the voxel-level nodes, the fifth number is the number of to-be-decoded nodes.

Further, in the embodiments of the present disclosure, the geometric information of the nodes of the current layer may be first determined, and the child nodes corresponding to the nodes of the current layer and the fifth number may be determined according to the geometric information.

It should be noted that, in the embodiments of the present disclosure, for the current node of the current layer, when the corresponding child nodes are determined by using the geometric information of the current node, the geometric information of the current node may be used to perform the up-sampling to obtain the occupied child nodes of the current node (the number of child nodes is N, and the maximum value of N is 8).

Exemplarily, in some embodiments, when encoding and decoding is performed on the attribute information of the nodes of the current layer, the number of the nodes of the current layer (i.e., the fourth number) may be first obtained. Moreover, after the child nodes of the nodes of the current layer are recovered using the geometric information of the nodes of the current layer, the number of child nodes of the nodes of the current layer (i.e., the fifth number) may be obtained.

In operation S4302, reconstructed attribute values of the child nodes corresponding to the nodes of the current layer are determined according to the fourth number and the fifth number.

It should be noted that, in the embodiments of the present disclosure, after the fourth number and the fifth number corresponding to the nodes of the current layer are determined, the reconstructed attribute values of the child nodes corresponding to the nodes of the current layer may be further determined according to the fourth number and the fifth number.

Further, in the embodiments of the present disclosure, after the fourth number and the fifth number corresponding to the nodes of the current layer are determined, it is determined, by using the fourth number and the fifth number, whether to skip encoding and decoding the attribute information of the coding layer (i.e., the current layer).

It should be understood that, in the embodiments of the present disclosure, since the RAHT transform is valid only for the nodes having neighbouring points, when the number of the nodes of the current layer is completely consistent with the number of child nodes of the nodes of the current layer, each node of the current layer has only one child node. In this case, the AC coefficients (i.e., the high-frequency coefficients) may not be generated for the current layer. Therefore, the processes of the transform, prediction and the like sequentially performed on the nodes of the current layer may be skipped.

That is to say, in the embodiments of the present disclosure, by using the number of the nodes and the number of child nodes of the current layer, it is possible to adaptively determine whether to skip encoding and decoding for the current layer. The key to determine whether to skip the encoding and decoding processing of the current layer is whether the number of the nodes of the current layer is the same as the number of child nodes, that is, whether the fourth number is the same as the fifth number.

In some embodiments, when the reconstructed attribute values of the child nodes corresponding to the nodes of the current layer are determined according to the fourth number and the fifth number, the method further includes the following operation. When the fourth number is the same as the fifth number, reconstructed attribute values of the nodes of the current layer are determined as the reconstructed attribute values of the child nodes corresponding to the nodes of the current layer.

It should be understood that, in the embodiments of the present disclosure, when the fourth number and the fifth number corresponding to the nodes of the current layer are the same, it may be determined that the number of the nodes of the current layer is the same as the number of child nodes corresponding to the nodes of the current layer. In this case, it may be considered that each node of the current layer corresponds to only one respective child node.

Accordingly, in the embodiments of the present disclosure, since the RAHT transform is valid for only the nodes having neighbouring points, in the process of the RAHT attribute transform, when each node of the current layer corresponds to only one child node, it may be considered that the AC coefficients may not be generated for the current layer. Therefore, the processes of the transform, prediction and the like may not be sequentially performed on the nodes of the current layer, that is, the processing of the current layer is skipped. In this case, the current layer may be referred to as “skip-decoding layer”.

Accordingly, in the embodiments of the present disclosure, when it is determined that the fourth number and the fifth number corresponding to the nodes of the current layer are the same, it is determined that the current layer is the skip-decoding layer. The processes of the transform, prediction and the like sequentially performed on the nodes of the current layer may be skipped, and the reconstructed attribute values of the nodes of the current layer are directly determined as the reconstructed attribute values of the child nodes corresponding to the nodes of the current layer.

That is to say, in the embodiments of the present disclosure, in the process of the RAHT attribute transform, when each node of the current layer corresponds to only one child node, the processes of the transform, prediction and the like may not be sequentially performed on the nodes of the current layer, thereby reducing the complexity of encoding and decoding of the RAHT attribute transform.

Further, in the embodiments of the present disclosure, when the reconstructed attribute values of the child nodes corresponding to the nodes of the current layer are determined according to the fourth number and the fifth number, if the fourth number is the same as the fifth number, it is determined that the current layer is the skip-decoding layer, and it is possible to skip the current layer and proceed to the next layer. Then, the next layer is used as the current layer, and it is continued to determine whether to skip decoding the nodes of the next layer.

Accordingly, in the embodiments of the present disclosure, for the child nodes corresponding to the nodes of the current layer, a sixth number of child nodes of a next layer corresponding to the child nodes may be first determined. Then reconstructed attribute values of the child nodes of the next layer corresponding to the child nodes are determined according to the fifth number and the sixth number.

It should be understood that, in the embodiments of the present disclosure, when the child nodes corresponding to the nodes of the current layer are the non-voxel-level nodes, the sixth number is the number of valid child nodes of the next layer (i.e., the occupied child nodes of the next layer) of the child nodes corresponding to the nodes of the current layer. When the child nodes corresponding to the nodes of the current layer are the voxel-level nodes, the sixth number is the number of to-be-decoded nodes.

It should be noted that, in the embodiments of the present disclosure, after the fifth number and the sixth number are determined, it is determined, by using the fifth number and the sixth number, whether to skip encoding and decoding the attribute information of the coding layer (i.e., the next layer of the current layer).

Exemplarily, in the embodiments of the present disclosure, when the fifth number is the same as the sixth number, the processes of the transform, prediction and the like may not be sequentially performed on the child nodes of the nodes of the current layer (i.e., the processing of the child nodes of the current layer may be skipped), and the reconstructed attribute values of the child nodes corresponding to the nodes of the current layer are determined as the reconstructed attribute values of the child nodes of the next layer of the child nodes corresponding to the nodes of the current layer.

In some embodiments, when the reconstructed attribute values of the child nodes corresponding to the nodes of the current layer are determined according to the fourth number and the fifth number, the method further includes the following operations. When the fourth number and the fifth number corresponding to the nodes of the current layer are different, prediction attribute values of the child nodes corresponding to the nodes of the current layer are determined according to the nodes of the current layer. An RAHT transform is performed based on the prediction attribute values of the child nodes to determine reconstructed values of high-frequency coefficients and low-frequency coefficients corresponding to the nodes of the current layer. An inverse RAHT transform is performed based on the reconstructed values of the high-frequency coefficients and the low-frequency coefficients to determine the reconstructed attribute values of the child nodes.

It should be noted that, in the embodiments of the present disclosure, when the fourth number is different from the fifth number, it may be determined that the number of the nodes of the current layer is different from the number of the child nodes corresponding to the nodes of the current layer. In this case, the AC coefficients are still generated for the current layer. Therefore, the processes of the transform, prediction and the like may be sequentially performed on the nodes of the current layer without skipping the processing of the current layer. In this case, the current layer may be taken as a non-skip-decoding layer.

Further, in some embodiments, the operation that the prediction attribute values of the child nodes corresponding to the nodes of the current layer are determined according to the nodes of the current layer may include the following operations. Neighbouring nodes corresponding to the nodes of the current layer are determined. The prediction attribute values of the child nodes corresponding to the nodes of the current layer are determined according to reconstructed attribute values and a relative distance parameter that correspond to the neighbouring nodes.

It should also be noted that in the embodiments of the present disclosure, the neighbouring nodes may refer to the neighbouring nodes of the current node. The relative distance parameters corresponding to the neighbouring nodes may represent the spatial geometric distances between the child nodes corresponding to the nodes of the current layer and the corresponding neighbouring nodes.

Exemplarily, in the embodiments of the present disclosure, for the current node of the current layer, the current node includes two child nodes denoted as a child node 1 and a child node 2. The relative distance parameters between the current node and the neighbouring nodes may include the spatial geometric distances between the child node 1 and the neighbouring nodes, and may also include the spatial geometric distances between the child node 2 and the neighbouring nodes.

Exemplarily, in the embodiments of the present disclosure, when the prediction attribute values of the child nodes corresponding to the nodes of the current layer are determined according to the nodes of the current layer, for the current node of the current layer, the reconstructed attributes (i.e., the reconstructed attribute values) of the neighbouring nodes of the current node and the spatial geometric distances between the neighbouring nodes and the child node of the current node may be used to perform the linear fitting, and finally the respective prediction attribute value of each child node of the current node may be obtained.

Exemplarily, in the embodiments of the present disclosure, for the current node of the current layer. 19 neighbouring nodes of the current node may be first determined; and then linear weighted prediction is performed on the attributes of each child nodes by using the spatial geometric distances between the neighbouring nodes and the each child node of the current node. Finally, the respective prediction attribute value of each child node may be obtained.

Further, in some embodiments, when the RAHT transform is performed based on the prediction attribute values of the child nodes to determine the reconstructed values of the high-frequency coefficients and the low-frequency coefficients corresponding to the nodes of the current layer, the method may include the following operations. The RAHT transform is performed based on the prediction attribute values of the child nodes to determine prediction values of the high-frequency coefficients and the low-frequency coefficients corresponding to the nodes of the current layer; and the reconstructed values of the high-frequency coefficients corresponding to the nodes of the current layer are determined according to the prediction values of the high-frequency coefficients.

It should be understood that, in the embodiments of the present disclosure, for the current node of the current layer, after the prediction attribute values corresponding to the child nodes of the current node are determined, the RAHT attribute transform may be performed by using the prediction attribute values of the corresponding child nodes, so that the corresponding DC coefficients and AC coefficients may be obtained, that is, the DC coefficients and the AC coefficients corresponding to the current node may be obtained. The DC coefficients are the low-frequency coefficients, and the AC coefficients are the high-frequency coefficients.

It should be noted that, in the embodiments of the present disclosure, for the current node of the current layer, the AC coefficients obtained by performing the RAHT attribute transform using the prediction attribute values corresponding to the child nodes may be understood as the prediction values of the high-frequency coefficients corresponding to the current node.

Further, in some embodiments, when the reconstructed values of the high-frequency coefficients corresponding to the nodes of the current layer are determined according to the prediction values of the high-frequency coefficients, the method may include the following operations. A bitstream is decoded to determine quantized coefficient residuals corresponding to the nodes of the current layer. The reconstructed values of the high-frequency coefficients corresponding to the nodes of the current layer are determined according to the prediction values of the high-frequency coefficients and the quantized coefficient residuals.

Further, in some embodiments, when the reconstructed values of the high-frequency coefficients corresponding to the nodes of the current layer are determined according to the prediction values of the high-frequency coefficients and the quantized coefficient residuals, the method may include the following operations. Inverse quantization is performed on the quantized coefficient residuals to determine inverse quantized residual values corresponding to the nodes of the current layer. The reconstructed values of the high-frequency coefficients corresponding to the nodes of the current layer are determined according to the inverse quantized residual values corresponding to the nodes of the current layer and the prediction values of the high-frequency coefficients corresponding to the nodes of the current layer.

Exemplarily, in the embodiment of the present disclosure, the sum of the inverse quantized residual values corresponding to the nodes of the current layer and the prediction values of the high-frequency coefficients corresponding to the nodes of the current layer may be calculated, and then the reconstructed values of the high-frequency coefficients corresponding to the nodes of the current layer are obtained.

It should also be noted that, in the embodiments of the present disclosure, after the low-frequency coefficients and the reconstructed values of the high-frequency coefficients of the nodes of the current layer are determined, the inverse RAHT transform is performed based on the reconstructed values of the high-frequency coefficients and the low-frequency coefficients, thereby determining the reconstructed attribute values of the child nodes.

Exemplarily, in the embodiments of the present disclosure, it is assumed that

$${g}_{L , 2 x , y , z}^{′} and {g}_{L , 2 x + 1 , y , z}^{′}$$

are two attribute DC coefficients of two neighboring points of the layer L. After the linear transform, the information of the layer (L−1) is AC coefficient

$${f}_{L - 1 , x , y , z}^{′}$$

and DC coefficient

$${g}_{L - 1 , x , y , z}^{′} .$$

Then, no transform will be performed on

$${f}_{L - 1 , x , y , z}^{′} .$$

Quantization encoding will be performed directly on

$${f}_{L - 1 , x , y , z}^{′} .$$

The nearest neighbours will continue to be found for the transform of the

$${g}_{L - 1 , x , y , z}^{′} .$$

If the nearest neighbours cannot be found, it will be directly transferred to the layer (L−2). That is, the RAHT transform is valid only for nodes with neighbouring points, and nodes without neighbouring points will be directly transferred to the upper layer. In the above transform process, the weights (the number of non-empty child nodes in the node) corresponding to

$${g}_{L , 2 x , y , z}^{′} and {g}_{L , 2 x + 2 , y , z}^{′}$$

are respectively

$${w}_{L , 2 x , y , z}^{′} and {w}_{L , 2 x + 1 , y , z}^{′}$$

(abbreviated as

$${w}_{0}^{′} and {w}_{1}^{′} ) ,$$

and the weight of

$${g}_{L - 1 , x , y , z}^{′} is {w}_{L - 1 , x , y , z}^{′} .$$

Then the general transform formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 34 )$$

Here, T_{w0,w1} is the transform matrix, and the transform matrix may be adaptively changed and updated along with the weights corresponding to the points. The forward transform of the RAHT (which may also be referred to as the “forward RAHT transform”) is as illustrated in aforementioned FIG. 35A.

Exemplarily, in the embodiments of the present disclosure, the inverse transform of the RAHT is performed according to the obtained DC coefficients and AC coefficients of the child nodes of the current node, and the reconstructed attribute values of the child nodes of the current node may be recovered. The inverse transform of the RAHT (which may also be referred to as the “backward RAHT transform” or “inverse RAHT transform”) is as illustrated in aforementioned FIG. 35B.

That is to say, in the embodiments of the present disclosure, when the fourth number and the fifth number corresponding to the nodes of the current layer are different, the processes of the transform, prediction and the like may continue to be sequentially performed on the nodes of the current layer. Specifically, for the current node of the current layer, the reconstructed attribute values of the neighbouring nodes of the current node and the spatial geometric distances between the neighbouring nodes to the child nodes of the current node may be used to perform the linear fitting, so as to obtain the prediction attributes of the child nodes of the current node. Then, the RAHT attribute transform is performed by using the prediction attributes of the child nodes to obtain corresponding DC coefficients and AC coefficients. Then, the AC coefficients (i.e., the reconstructed values of the high-frequency coefficients) of the current to-be-decoded node (i.e., current node) are recovered by using the AC coefficients (i.e., prediction values of the high-frequency coefficients) of the prediction node and the AC coefficients (i.e., the coefficient differences) obtained by parsing the bitstream. Finally, the AC coefficients (i.e., the reconstructed values of the high-frequency coefficients) and DC coefficients of the current node may be used to perform the inverse RAHT transform, thereby recovering the reconstructed attribute value of the child nodes of the current node.

Further, in the embodiments of the present disclosure, when the current layer is the non-skip-encoding layer, the processes of the transform, prediction and the like may be sequentially performed on the nodes of the current layer to determine the reconstructed attribute values of the child nodes corresponding to the nodes of the current layer. Then, for the child nodes of the nodes of the current layer, the sixth number of child nodes of the next layer corresponding to the child nodes may be first determined. Then, according to the fifth number and the sixth number, the reconstructed attribute values of the child nodes of the next layer corresponding to the child nodes are determined.

That is to say, in the embodiments of the present disclosure, no matter whether the current layer is the skip-encoding layer, that is, no matter whether the processes of the transform, prediction and the like are sequentially performed on the nodes of the current layer, it is still necessary to continuously repeat the above operations, still determine the number of the nodes of other layers and the corresponding number of the child nodes, and then determine whether to execute the process of skipping decoding processing according to the number of the nodes and the number of corresponding child nodes.

Accordingly, in the embodiments of the present disclosure, the method including the operation S4301 to operation S4302 is continuously repeated from the root node of the RAHT transform to the last node of the leaf node layer of the RAHT in sequence, thereby completing attribute decoding of the entire RAHT transform.

Further, in some embodiments, the method may further include the following operations. A bitstream is decoded to determine prediction mode identification information. When the prediction mode identification information indicates that a skip decoding mode is enabled for the current unit, the operation of determining the first number and the second number is performed, and/or the operation of determining the fourth number and the fifth number is performed.

In the embodiments of the present disclosure, the prediction mode identification information is at least one of following high-layer syntax elements: a syntax element corresponding to an Attribute Parameter Sct (APS) and a syntax element corresponding to Attribute Block Header (ABH) information.

In the embodiments of the present disclosure, when the value of the prediction mode identification information is the first value, it is determined that the skip decoding mode is enabled for the current unit. When the value of the prediction mode identification information is the second value, it is determined that the skip decoding mode is not enabled for the current unit. Hereinafter, whether the skip decoding mode is enabled for the voxel nodes of the current unit and whether the skip decoding mode is enabled for the nodes of the current layer will be described respectively.

In a specific embodiment, the method may further include the following operations. A bitstream is decoded to determine first prediction mode identification information. When the first prediction mode identification information indicates that the skip decoding mode is enabled for the voxel nodes of the current unit, the operation of determining the first number and the second number is performed.

It should be noted that, in the embodiments of the present disclosure, when the value of the first prediction mode identification information is the first value, it is determined that the skip decoding mode is enabled for the voxel nodes of the current unit. When the value of the first prediction mode identification information is the second value, it is determined that the skip decoding mode is not enabled for the voxel nodes of the current unit.

It should also be noted that, in the embodiments of the present disclosure, only when the skip decoding mode is enabled for the voxel nodes of the current unit, the first number and the second number may be further determined in this case, and then it may be determined, according to the magnitudes of the first number and the second number, whether to skip decoding the voxel nodes of the current unit. Specifically, if the first number is consistent with the second number, the decoding to determine the attributes of the voxel-level nodes is skipped: otherwise, a timer is adopted. When the number of remaining duplicate nodes counted by the timer is zero, it represents that there are no duplicate nodes among the subsequent points, the attribute decoding of the subsequent points may be skipped, and the reconstructed attribute values of the subsequent voxel nodes may be directly copied as the reconstructed attribute values of the final remaining reconstructed points.

In another specific embodiment, the method may further include the following operations. A bitstream is decoded to determine second prediction mode identification information. When the second prediction mode identification information indicates that the skip decoding mode is enabled for the nodes of the current layer, the operation of determining the fourth number and the fifth number is performed.

It should be noted that, in the embodiments of the present disclosure, when the value of the second prediction mode identification information is the first value, it is determined that the skip decoding mode is enabled for the nodes of the current layer. When the value of the second prediction mode identification information is the second value, it is determined that the skip decoding mode is not enabled for the nodes of the current layer.

It should also be noted that, in the embodiments of the present disclosure, only when the skip decoding mode is enabled for the nodes of the current layer, the fourth number and the fifth number may be further determined in this case, and then it may be determined, according to the magnitudes of the fourth number and the fifth number, whether to skip decoding the nodes of the current layer, i.e., whether the current layer is the skip-decoding layer. Specifically, if the fourth number is consistent with the fifth number, it is determined that the current layer is the skip-decoding layer, and in this case, it is no longer necessary to perform decoding to obtain the reconstructed attribute values of the child nodes corresponding to the nodes of the current layer. When the fourth number is inconsistent with the fifth number, it is determined that the current layer does not belong to the skip-decoding layer, and in this case, the RAHT prediction and decoding may be performed according to the decoding method in the related art.

It should also be noted that in the embodiments of the present disclosure, the first value is different from the second value, and the first value and the second value may be in the form of parameters or numerics. Specifically, each of the first prediction mode identification information and the second prediction mode identification information may be a parameter written in a profile, or may be a value of a flag, which is not specifically limited herein. In addition, for the first value and the second value, the first value may be set to 1 and the second value may be set to 0). Alternatively, the first value may be set to 0 and the second value may be set to 1. Alternatively, the first value may also be set to true, and the second value may also be set to false. Alternatively, the first value may be set to false, and the second value may be set to true. In the embodiments of the present disclosure, the first value is set to 1 and the second value is set to 0 but, which is not specifically limited.

Exemplarily, in some embodiments, taking the first value being set to 1 and the second value being set to 0 as an example, the bitstream is decoded to determine the value of the second prediction mode identification information. When the value of the second prediction mode identification information is 1, it may be determined that the skip decoding mode is started for the nodes of the current layer, and the fourth number and the fifth number corresponding to the nodes of the current layer may be further determined according to the aforementioned method. When the value of the second prediction mode identification information is 0, it may be determined that the skip decoding mode is not enabled for the nodes of the current layer, and the attribute decoding processing may be performed on the nodes of the current layer according to a common intra prediction method or a common inter prediction method.

That is to say, in the embodiments of the present disclosure, when the value of the first prediction mode identification information determined by the decoding the bitstream is the first value, it is determined that the skip decoding mode is enabled for the voxel nodes of the current unit, and the operation of determining the first number and the second number may be executed (i.e., the decoding flow shown in FIG. 41 may be executed). When the value of the second prediction mode identification information determined by decoding the bitstream is the first value (i.e., when it is determined that the skip decoding mode is enabled for the nodes of the current layer), the flow of determining the fourth number and the fifth number may be executed (i.e., the decoding flow shown in FIG. 43 may be executed).

To sum up, in the embodiments of the present disclosure, when the attribute information is encoded and obtained by decoding, if the number of the nodes of the current layer is consistent with the number of child nodes of the current layer, the current layer is considered to be the skip-encoding layer, and the processes of the transform, prediction, encoding, decoding and the like are not required to be performed on the current layer. In this way, the time complexity of the encoding and decoding of the attribute transform can be reduced, and the efficiency of the attribute coding would not be affected.

Exemplarily, in the implementation of the standard text, a specific SPEC modification is as follows:

### 10.5.2.2 State Variables

The RAHT tree is specified in terms of the following state variables:

The sparse array RahtCoeff of transform block coefficients; RahtCoeff[lvl] [bs] [br] [bv] [i] is the i-th coefficient for the block located at (bs, bt, by) in transform level/v1. Unset elements shall be inferred to be 0.

The array RahtBlkLoc of transform block locations: RahtBlkLoc[lvl] [nIdx] [k] is the location of the nldx-th coded block in transform level lvl.

The array RahtBlkOnt of node counts per tree level: RahtBlkOnt[lvl] is the number of blocks in transform level lvl.

The variable RahtLvlCnt, the number of transform levels.

### 10.5.2.3Transform Block Weight

The weight of the DC transform coefficient for a block located at (bs, bt, bv) in transform level/v/is specified by the expression RahtBlkWeight[lvl] [bs] [br] [bv]. It is equal to the number of points that the coefficient applies to.

The sum of all block weights in any transform level is equal to the number of coded points (PointCnt).

A block's weight is equal to the sum of its child block weights.

```
  RahtBlkWeight[lvl][bs][bt][bv] :=
  RahtBlkWeight = 0
for (ptIdx = 0; ptIdx < PointCnt; ptIdx++)
    RahtBlkWeight += isPointInSubtree[ptIdx]
    Where
  isPointInSubtree[ptIdx] :=
  bs == AttrPos[ptIdx][0] >> lvl
  && bt == AttrPos[ptIdx][1] >> lvl
  && bv == AttrPos[ptIdx][2] >> lvl
```

### 10.5.2.4 Number of Transform Levels and Per-Level Block Order

The root node of the transform tree is the lowest block in the tree with a DC coefficient that spans the entire geometry; i.e. it has a weight equal to the number of coded points, PointCnt.
The tree level containing the root node is RahtRootLvl:
RahtRootLvl:=RahtLvlCnt−1

Within a transform level, blocks are ordered for coefficient coding by ascending Morton-coded block location, as specified by the derivation of RahtBlkLoc. Empty blocks are ignored.

```
for (RahtLvlCnt = 0; !done; RahtLvlCnt++)
  for (mIdx = 0, nIdx = 0, wSum = 0; wSum < PointCnt; mIdx++) {
  (bs, bt, bv) = FromMorton(mIdx)
    wSum += RahtBlkWeight[RahtLvlCnt][bs][bt][bv]
  if (RahtBlkWeight[RahtLvlCnt][bs][bt][bv] == 0)
    continue
    RahtBlkCnt[RahtLvlCnt]++
  RahtBlkLoc[RahtLvlCnt][nIdx][0] = bs
  RahtBlkLoc[RahtLvlCnt][nIdx][1] = bt
  RahtBlkLoc[RahtLvlCnt][nIdx][2] = bv
  nIdx++
    done = RahtBlkWeight[RahtLvlCnt][bs][bt][bv] == PointCnt
  }
```

### 10.5.2.5 2×2×2 Transform Block Coefficient Weights

Transform coefficient weights are specified for each directional stage of the two-point transform for 2×2×2 transform blocks by the expression RahtCoeffWeightM[lvl] [stage] [bs] [bt] [bv] [m]; the parameter(s):
bs, bt and bv specify a transform block location in tree level lvl, lvl>0;
m specifies the transform coefficient index in forward transform stage stage.
RahtCoeffWeightM[lvl] [stage] [bs] [bt] [bv] [m]:=RahtCoeffWeight[lvl] [stage] [s] [t] [v]
   where

```
s := 2 × bs + FromMorton[m][0]
  t := 2 × bt + FromMorton[m][1]
  v := 2 × bv + FromMorton[m][2]
```

Within a block, coefficient weights are determined iteratively starting from its child block weights (stage 0) to the transform block coefficient weights of stage 3. At each transform stage and for each pair of inverse-transformed values a and b, the weight for the DC (wL) and AC (wH) coefficient is the sum of the weights for a and b. If the weight for either a or b is 0, the AC coefficient weight is 0.

The expression RahtCoeffWeight[lvl] [stage] [s] [t] [v] specifies the derivation of a weight in transform stage stage for the coefficient corresponding to the block located at (s, t, v) in tree level lvl−1.

```
  RahtCoeffWeight[lvl][stage][s][t][v] :=
  stage == 0 ? RahtBlkWeight[lvl − 1][s][t][v] :
  stage == 1 ? v % 2 == 0 ? wL[0][0][1] : wH[0][0][−1] :
  stage == 2 ? t % 2 == 0 ? wL[0][1][0] : wH[0][−1][0] :
  stage == 3 ? s % 2 == 0 ? wL[1][0][0] : wH[−1][0][0] : na
where
  wL[ds][dt][dv] := wSum[ds][dt][dv]
  wH[ds][dt][dv] := wSum[ds][dt][dv] × wHnz[ds][dt][dv]
  wSum[ds][dt][dv] := wP[s][t][v] + wP[s + ds][t + dt][v + dv]
  wHnz[ds][dt][dv] := wP[s][t][v] × wP[s + ds][t + dt][v + dv] > 0
  wP[s][t][v] := RahtCoeffWeight[lvl][stage − 1][s][t][v]
  RahtBlkWeight[lvl][s][t][v] = RahtCoeffWeight[lvl][3][2 × s][2 × t][2 ×
  v]; lvl > 0.
```

In the example of FIG. 18, block B has stage 0 coefficient weights of 1, 3 and 1; stage 1 and 2 weights of 1, 4 and 1; and stage 3 weights of 5, 4 and 5. RahtCoeffWeight[1] [1] [3] [0] [2] would be 4.

### 10.5.3 Coefficient Order 10.5.3.1 General

Subclause 10.5.3 specifies the correspondence between coded transform coefficients and the transform tree.

Starting from the root of the transform tree and proceeding in breadth-first order, coefficients are coded for each transform block; all transform blocks within one tree level are coded before those of the next level. Within a tree level, blocks shall be traversed in ascending Morton order of block location.

The order of coefficients within a transform block is specified by 10.5.3.2 for 2×2×2 blocks (tree levels greater than 0) and 10.5.3.3 for blocks of co-located points (tree level 0).

The mapping from the coded order to the transform tree is specified in terms of the following variables:

```
  Lvl, the index of the mapped transform level.
  CoeffIdx, the index into the decoded coefficient array AttrCoeff for the
  next mapped coefficient.
  CoeffIdx = 0
for (Lvl = RahtLvlCnt; Lvl ≥ 0; Lvl−−) {
  if (Lvl > 0) {
  ... /* See 10.5.3.2 */
    if(RahtBlkCnt[Lvl]== RahtBlkCnt[Lvl])
      continue
    } else if(RahtBlkCnt[Lvl]!= PointCnt)
  {
  ... /* See 10.5.3.3 */
  }
}
```

That is to say, in the decoding method proposed in the embodiments of the present disclosure, when the RAHT decoding is performed on the attributes, at each RAHT transform layer, it is determined whether the current RAHT transform layer belongs to the skip-encoding layer (i.e., it is determined whether to skip the processes of the transform, prediction, and the like performed on the current layer) by determining whether the number of the nodes of the current layer is consistent with the number of child nodes of the current layer. When the number of the nodes of the current layer is consistent with the number of child nodes of the current layer, it is considered that the current layer belongs to the skip-encoding layer, and the processes of the transform, prediction, encoding, decoding and the like are not required to be performed. In this way, the time complexity of the encoding and decoding of the attribute transform can be reduced, and the efficiency of the attribute coding will not be affected.

The present embodiment provides a decoding method where a decoding method of skipping the current layer is proposed. It is adaptively determined whether to skip decoding for the current layer by using the number of the nodes of the current layer and the number of the child nodes of the current layer, so that the time complexity of encoding and decoding can be reduced on the premise of ensuring that the efficiency of the encoding and decoding remains unchanged. In addition, a decoding method of skipping the voxel-level nodes is also proposed herein. Firstly, the number of the voxel nodes and the number of reconstructed nodes may be obtained. When the number of the reconstructed nodes is consistent with the number of the voxel nodes, it is considered that there are no duplicate nodes in the current unit, and the decoding to obtain the attributes of the voxel-level nodes may also be skipped. In this way, on the basis of ensuring the efficiency of the attribute encoding and decoding of the point cloud, the time complexity of attribute encoding and decoding of the point cloud can be reduced, and the code rate can be saved, thereby improving the encoding and decoding performance of the point cloud.

In an embodiment of the present disclosure, with reference to FIG. 44, a flowchart of an encoding method according to an embodiment of the present disclosure is shown. As shown in FIG. 44, the method may include operation S4401 to operation 4402.

In operation S4401, a first number of voxel nodes of a current unit and a second number of reconstructed nodes of the current unit are determined.

It should be noted that, in the embodiments of the present disclosure, the encoding method is applied to a point cloud encoder (which may be simply referred to as an “encoder”). The encoding method may be a point cloud encoding method, and specifically, may be a point cloud attribute encoding method for the point cloud attribute, and more specifically, may be a skip encoding method for the RAHT transform prediction of the point cloud attribute. Here, it is mainly optimized whether to skip encoding the nodes of the current layer and whether to skip encoding the voxel nodes when the partitioning is performed to the voxel level, so that the time complexity of the encoding and decoding of the attribute transform can be reduced, and the efficiency of the encoding and decoding of the attribute transform will not be affected.

It should also be noted that in the embodiments of the present disclosure, the current unit may be a current encoding unit that is currently to be encoded, and here, the current unit may be a slice. In some embodiments, the method may further include the following operations. Nodes of the current unit are partitioned to determine at least one layer. When nodes of the last layer are partitioned to the voxel level, the voxel nodes of the current unit and the first number of the voxel nodes are determined.

Exemplarily, in the RAHT attribute transform, the order of the RAHT attribute transform involves sequentially partitioning starting from the root node until the partitioning reaches the voxel level. Specifically, the partitioning is stopped until the unit cubes of 1×1×1 are obtained by partitioning, so that the encoding and reconstruction of the attributes of the entire point cloud can be completed. Here, as illustrated in FIG. 42, a layer obtained by performing down-sampling once along the Z-axis. Y-axis, and X-axis is a RAHT transform layer (i.e., a “layer”). Then, when the unit cubes of 1×1×1 are obtained by partitioning, it is indicated that the partitioning reaches the voxel level. In this case, the voxel nodes and the first number of the voxel nodes may be determined.

It should be further noted that, in the embodiments of the present disclosure, the voxel node represents a node corresponding to the voxel level when the partitioning is performed form the root node to the voxel level, and the size of the voxel node is 1×1×1. The reconstructed node represents the node on which the attribute reconstruction is performed in the current unit. Before the attribute encoding is performed on the nodes of the current unit, the geometric information of the nodes of the current unit has been completely encoded. In this case, the second number of reconstructed nodes of the current unit may be determined, so that it is possible to determine whether the first number is consistent with the second number.

In operation S4402, it is determined whether to skip encoding attribute information of the voxel nodes of the current unit according to the first number and the second number.

It should be noted that, in the embodiments of the present disclosure, before the attribute encoding is performed on the voxel nodes, it is necessary to first determine whether the first number is the same as the second number, thereby determining whether to skip encoding the voxel nodes of the current unit.

In some embodiments, when the first number is the same as the second number, encoding attribute information of the voxel nodes of the current unit is skipped.

In some embodiments, when the first number is different from the second number, attribute encoding is performed on duplicate nodes among the voxel nodes, and encoding attribute information of remaining voxel nodes other than the duplicate nodes among the voxel nodes is skipped.

In the embodiments of the present disclosure, there may be duplicate nodes among the voxel nodes obtained by partitioning the current unit, so that the first number may be inconsistent with the second number. When there are no duplicate nodes among the voxel nodes obtained by partitioning the current unit, the first number is consistent with the second number. Otherwise, when there are duplicate nodes among the voxel nodes obtained by partitioning the current unit, the first number is inconsistent with the second number, and in this case, it is necessary to perform the attribute encoding on the duplicate nodes. Here, the duplicate nodes (which may also be simply referred to as “duplicate points”) refer to multiple nodes having the same geometric information and different pieces of attribute information.

In some embodiments, the operation that the attribute encoding is performed on the duplicate nodes among the voxel nodes may include the following operations. Encoding processing is performed on the attribute information of the duplicate nodes, and obtained encoded bits are signalled into a bitstream.

It should be noted that, in the embodiments of the present disclosure, when the encoding processing is performed on the attribute information of the duplicate node, the method may include the following operations. A timer is set. The timer is started when the encoding processing on the attribute information of the duplicate nodes begins, and it is determined that all pieces of the attribute information of the duplicate nodes are encoded when a timing of the timer reaches a preset value.

It should be noted that in the embodiments of the present disclosure, when the first number is different from the second number, a third number of the duplicate nodes among the voxel nodes is determined based on a difference between the first number and the second number. The setting of the timer is associated with the third number.

Exemplarily, a timer may be used to determine whether all the reconstructed attribute values of the duplicate nodes are encoded. In a case that the timer is in the counting mode, when the encoding processing on the reconstructed attribute values of the duplicate nodes begins, the initial value of the timer is 0). When the timer counts to the third number, all the reconstructed attribute values of the duplicate nodes are encoded. In a case that the timer is in the countdown mode, when the encoding processing on the reconstructed attribute values of the duplicate nodes begins, the initial value of the timer is the third number, and when the timer counts to 0 all the reconstructed attribute values of the duplicate nodes are encoded in this case. After all the reconstructed attribute values of the duplicate nodes are encoded, there are no duplicate nodes among the subsequent voxel nodes, and the attribute encoding of these subsequent nodes can be skipped.

Further, in some embodiments, with reference to FIG. 45, after the operation S4401, the method may further include operation S4501.

In operation S4501, reconstructed attribute values of the voxel nodes of the current unit are determined according to the first number and the second number.

It should be noted that, in the embodiments of the present disclosure, the reconstructed attribute values of the voxel nodes of the current unit may be directly copied from the reconstructed attribute values of the reconstructed nodes of the current unit. However, the reconstructed attribute values of the duplicate nodes cannot be obtained through copying. That is, here, it is determined, through comparison between the magnitude of the first number and the magnitude of the second number, how the reconstructed attribute values of the voxel nodes of the current unit are determined.

In some embodiments, when the first number is the same as the second number, the operation that the reconstructed attribute values of the voxel nodes of the current unit are determined according to the first number and the second number may include the operation that the reconstructed attribute values of the voxel nodes of the current unit are set as reconstructed attribute values of the reconstructed nodes of the current unit. Exemplarily, when the first number is the same as the second number, encoding the attribute information of the voxel nodes of the current unit may be skipped, and in this case, the reconstructed attribute values of the voxel nodes may be directly copied as the reconstructed attribute values of the reconstructed nodes of the current unit.

In some embodiments, when the first number is the different from the second number, the operation that the reconstructed attribute values of the voxel nodes of the current unit are determined according to the first number and the second number may include the following operations. The reconstructed attribute values of the duplicate nodes are taken as a reconstructed attribute value of a first reconstructed node of the current unit, and reconstructed attribute values of the remaining voxel nodes other than the duplicate nodes among the voxel nodes are set as reconstructed attribute values of the remaining reconstructed nodes other than the first reconstructed node of the current unit.

Exemplarily, when the first number is different from the second number, it indicates that there are duplicate nodes among the voxel nodes obtained by partitioning the current unit. In this case, the reconstructed attribute values of the duplicate nodes may be determined. Then the reconstructed attribute values of the duplicate nodes are taken as the reconstructed attribute value of the first reconstructed node of the current unit, and the reconstructed attribute values of the remaining voxel nodes other than the duplicate nodes are copied as the reconstructed attribute values of the remaining reconstructed nodes other than the first reconstructed node of the current unit. In addition, when the first number is different from the second number, it is necessary to encode the attribute information of the duplicate nodes, so that the decoding end is able to decode to determine the reconstructed attribute values of the duplicate nodes.

Exemplarily, for the multiple nodes (i.e., the duplicate nodes) having the same geometric information and different pieces of attribute information, the encoding end may use a timer to sum the pieces of the attribute information of the multiple nodes, and determine the summed value as the attribute information of the node corresponding to the geometric information. Subsequently, when the attribute decoding is performed at the decoding end, the timer may also be used to separate the respective piece of attribute information of each one of the multiple nodes from the attribute information, so as to obtain the reconstructed attribute values of the duplicate nodes.

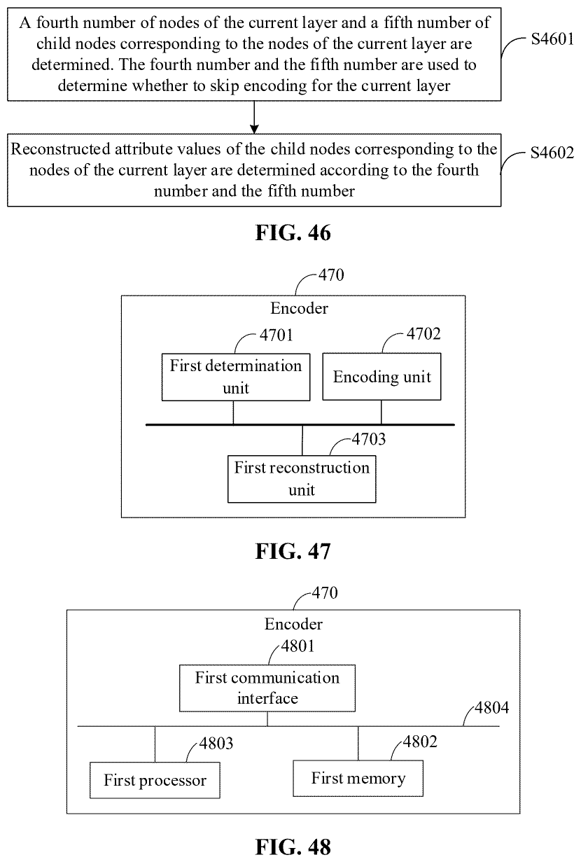

It should further be understood that in the embodiments of the present disclosure, at least one layer includes the current layer, and the current layer may be the current to-be-encoded RAHT transform layer, or referred to as a “RAHT attribute coding layer”. FIG. 46 is a flowchart of another encoding method according to an embodiment of the present disclosure. As shown in FIG. 46, the method may include the following operations.

In operation S4601, a fourth number of the nodes of the current layer and a fifth number of the child nodes corresponding to the nodes of the current layer are determined. The fourth number and the fifth number are used to determine whether to skip the encoding for the current layer.

It should be noted that, in the embodiments of the present disclosure, the fourth number of the nodes of the current layer may be first determined, and at the same time, the fifth number of the child nodes corresponding to the nodes of the current layer may be determined. Before the attribute encoding is performed on the nodes of the current layer, since the geometric information of the nodes of the current layer has been encoded, the number of the nodes of the current layer (i.e., the “fourth number”) and the number of the child nodes of the nodes of the current layer (i.e., the “fifth number”) may be determined according to the geometric information of the nodes of the current layer.

Further, in the embodiments of the present disclosure, it is necessary to first construct the RAHT attribute transform structure based on the geometric information of the points in the point cloud, and the encoding may be performed in the order from the root node to the child node. The geometric information of the nodes of the current layer is used to recover the child nodes of the current layer in the order of Z, Y and X. Then, the reconstructed attributes of the nodes of previous layer are used to perform the prediction encoding on the attributes of the nodes of the current layer, so that the reconstructed attribute values of the nodes of the current layer may be recovered until the transform is performed to the voxel level, thereby obtaining the RAHT attribute transform structure including at least one RAHT transform layer.

It should be noted that, in the embodiments of the present disclosure, the RAHT attribute transform may be performed based on the sequence of the octree levels. Based on the hierarchical order of the octree, the transform may be performed continuously from the voxel level to the root node, thereby constructing the octree. Then, in the predictive transform process, the attribute prediction transform coding is also performed based on the hierarchical order of the octree, but the transform is continuously performed from the root node to the voxel level.

It should be understood that, in the embodiments of the present disclosure, a layer obtained by sequentially down-sampling once along preset directions (e.g., the Z direction, the Y direction, and the X direction) may be defined as a RAHT transform layer, such as the current layer.

It is to be noted that, in the embodiments of the present disclosure, for the current layer, the current layer may include at least one point. Herein, for the at least one point of the current layer, when the encoding is performed on the current layer, the at least one point may be used as the to-be-encoded node of the current layer.

Further, in the embodiments of the present disclosure, each point of the current layer corresponds to one piece of geometric information and one piece of attribute information. Herein, the geometric information represents the spatial relationship of the point, and the attribute information represents the information related to the attributes of the point.

Herein, the attribute information may be the colour information, the reflectance, or other attributes, which is not limited in the embodiments of the present disclosure. Herein, when the attribute information is the colour information, specifically, the attribute information may be colour information of any colour space. Exemplarily, the attribute information may be the colour information of the RGB space, the colour information of the YUV space, the colour information of the YCbCr space, or the like, which is not limited in the embodiments of the present disclosure.

It should also be noted that in the embodiments of the present disclosure, when the RAHR transform encoding is performed, the attribute transform and the inverse transform of the non-voxel-level nodes are first completed, and then, the transform of the voxel-level nodes is completed. This is because of the phenomenon where the duplicate nodes exist in the point cloud.

Accordingly, in the embodiments of the present disclosure, when the nodes of the current layer are at the non-voxel level, the fourth number may represent the number of occupied nodes of the current layer. The fifth number may then represent the number of occupied child nodes of the nodes of the current layer.

Accordingly, in the embodiments of the present disclosure, when the nodes of the current layer are at the voxel level, the fourth number may represent the number of occupied nodes of the current layer. The fifth number may then represent the number of to-be-encoded nodes.

That is to say, in the embodiments of the present disclosure, the fourth number is the number of valid nodes (i.e., the occupied nodes) of the current layer. For the non-voxel-level nodes, the fifth number is the number of valid child nodes (i.e., the occupied child nodes) of the nodes of the current layer. For the voxel-level nodes, the fifth number is the number of to-be-encoded nodes.

Further, in the embodiments of the present disclosure, the geometric information of the nodes of the current layer may be first determined, and the child nodes corresponding to the nodes of the current layer and the fifth number may be determined according to the geometric information.

It should be noted that, in the embodiments of the present disclosure, for the current node of the current layer, when the corresponding child nodes are determined by using the geometric information of the current node, the geometric information of the current node may be used to perform the up-sampling to obtain the occupied child nodes of the current node (the number of the child nodes is N, and the maximum value of N is 8).

Exemplarily, in some embodiments, when encoding and decoding is performed on the attribute information of the nodes of the current layer, the number of the nodes of the current layer (i.e., the fourth number) may be first obtained. Moreover, after the child nodes of the nodes of the current layer are recovered using the geometric information of the nodes of the current layer, the number of the child nodes of the nodes of the current layer (i.e., the fifth number) may be obtained.

In operation S4602, reconstructed attribute values of the child nodes corresponding to the nodes of the current layer are determined according to the fourth number and the fifth number.

It should be noted that, in the embodiments of the present disclosure, after the fourth number and the fifth number corresponding to the nodes of the current layer are determined, the reconstructed attribute values of the child nodes corresponding to the nodes of the current layer may be further determined according to the fourth number and the fifth number.

Further, in the embodiments of the present disclosure, after the fourth number and the fifth number corresponding to the nodes of the current layer are determined, it is determined, by using the fourth number and the fifth number, whether to skip encoding and decoding the attribute information of the encoding layer (i.e., the current layer).

It should be understood that, in the embodiments of the present disclosure, since the RAHT transform is valid for only the nodes having neighbouring points, when the number of the nodes of the current layer is completely consistent with the number of the child nodes of the nodes of the current layer, each node of the current layer has only one child node. In this case, the AC coefficients (i.e., the high-frequency coefficients) may not be generated for the current layer. Therefore, the processes of the transform, prediction and the like sequentially performed on the nodes of the current layer may be skipped.

That is to say, in the embodiments of the present disclosure, by using the number of the nodes and the number of the child nodes of the current layer, it is possible to adaptively determine whether to skip encoding and decoding for the current layer. The key to determine whether to skip the encoding and decoding processing of the current layer is whether the number of the nodes of the current layer is the same as the number of the child nodes, that is, whether the fourth number is the same as the fifth number.

In some embodiments, when the reconstructed attribute values of the child nodes corresponding to the nodes of the current layer are determined according to the fourth number and the fifth number, the method further include the following operation. When the fourth number is the same as the fifth number, reconstructed attribute values of the nodes of the current layer are determined as the reconstructed attribute values of the child nodes corresponding to the nodes of the current layer.

It should be understood that, in the embodiments of the present disclosure, when the fourth number and the fifth number corresponding to the nodes of the current layer are the same, it may be determined that the number of the nodes of the current layer is the same as the number of the child nodes corresponding to the nodes of the current layer. In this case, it may be considered that each node of the current layer corresponds to only one respective child node.

Accordingly, in the embodiments of the present disclosure, since the RAHT transform is valid for only the nodes having neighbouring points, in the process of the RAHT attribute transform, when each node of the current layer corresponds to only one respective child node, it may be determined that the AC coefficients may not be generated for the current layer. Therefore, the processes of the transform, prediction and the like may not be sequentially performed on the nodes of the current layer, that is, the processing of the current layer is skipped, which can be referred to as “skip-encoding layer”.

Accordingly, in the embodiments of the present disclosure, when it is determined that the fourth number and the fifth number corresponding to the nodes of the current layer are the same, it is determined that the current layer is the skip-encoding layer, the processes of the transform, prediction and the like sequentially performed on the nodes of the current layer may be skipped, and the reconstructed attribute values of the nodes of the current layer are directly determined as the reconstructed attribute values of the child nodes corresponding to the nodes of the current layer.

That is to say, in the embodiments of the present disclosure, in the process of the RAHT attribute transform, when each node of the current layer corresponds to only one child node, the processes of the transform, prediction and the like may not be sequentially performed on the nodes of the current layer, thereby reducing the complexity of encoding and decoding of the RAHT attribute transform.

Further, in the embodiments of the present disclosure, when the reconstructed attribute values of the child nodes corresponding to the nodes of the current layer are determined according to the fourth number and the fifth number, if the fourth number is the same as the fifth number, it is determined that the current layer is the skip-encoding layer, and it is possible to skip the current layer and proceed to the next layer. Then the next layer is used as the current layer, and it is continued to determine whether to skip encoding the nodes of the next layer.

Accordingly, in the embodiments of the present disclosure, for the child nodes corresponding to the nodes of the current layer, a sixth number of the child nodes of a next layer corresponding to the child nodes may be first determined. Then reconstructed attribute values of the child nodes of the next layer corresponding to the child nodes are determined according to the fifth number and the sixth number.

It should be understood that, in the embodiments of the present disclosure, when the child nodes corresponding to the nodes of the current layer are the non-voxel-level nodes, the sixth number is the number of valid child nodes of the next layer (i.e., the occupied child nodes of the next layer) of the child nodes corresponding to the nodes of the current layer. When the child nodes corresponding to the nodes of the current layer are the voxel-level nodes, the sixth number is the number of to-be-encoded nodes.

It should be noted that, in the embodiments of the present disclosure, after the fifth number and the sixth number are determined, it is determined, by using the fifth number and the sixth number, whether to skip encoding and decoding the attribute information of the encoding layer (i.e., the next layer of the current layer).

Exemplarily, in the embodiments of the present disclosure, when the fifth number is the same as the sixth number, the processes of the transform, prediction and the like may not be sequentially performed on the child nodes of the nodes of the current layer (i.e., the processing of the child nodes of the current layer may be skipped), and the reconstructed attribute values of the child nodes corresponding to the nodes of the current layer are determined as the reconstructed attribute values of the child nodes of the next layer of the child nodes corresponding to the nodes of the current layer.

In some embodiments, when the reconstructed attribute values of the child nodes corresponding to the nodes of the current layer are determined according to the fourth number and the fifth number, the method further includes the following operations. When the fourth number and the fifth number corresponding to the nodes of the current layer are different, prediction attribute values of the child nodes corresponding to the nodes of the current layer are determined according to the nodes of the current layer. An RAHT transform is performed based on the prediction attribute values of the child nodes to determine reconstructed values of high-frequency coefficients and low-frequency coefficients corresponding to the nodes of the current layer. An inverse RAHT transform is performed based on the reconstructed values of the high-frequency coefficients and the low-frequency coefficients to determine the reconstructed attribute values of the child nodes.

It should be noted that, in the embodiments of the present disclosure, when the fourth number is different from the fifth number, it may be determined that the number of the nodes of the current layer is different from the number of the child nodes corresponding to the nodes of the current layer. In this case, the AC coefficients are still generated for the current layer. Therefore, the processes of the transform, prediction and the like may be sequentially performed on the nodes of the current layer without skipping the processing of the current layer. In this case, the current layer may be taken as a non-skip-encoding layer.

Further, in some embodiments, the operation that the prediction attribute values of the child nodes corresponding to the nodes of the current layer are determined according to the nodes of the current layer may include the following operations. Neighbouring nodes corresponding to the nodes of the current layer are determined. The prediction attribute values of the child nodes corresponding to the nodes of the current layer are determined according to reconstructed attribute values and a relative distance parameter that correspond to the neighbouring nodes.

It should also be noted that in the embodiments of the present disclosure, the neighbouring nodes may refer to the neighbouring nodes of the current node. The relative distance parameters corresponding to the neighbouring nodes may represent the spatial geometric distances between the child nodes corresponding to the nodes of the current layer and the corresponding neighbouring nodes.

Exemplarily, in the embodiments of the present disclosure, for the current node of the current layer, the current node includes two child nodes (i.e., a child node 1 and a child node 2). The relative distance parameters between the current node and the neighbouring nodes may include the spatial geometric distances between the child node 1 and the neighbouring nodes, and may also include the spatial geometric distances between the child node 2 and the neighbouring nodes.

Exemplarily, in the embodiments of the present disclosure, when the prediction attribute values of the child nodes corresponding to the nodes of the current layer are determined according to the nodes of the current layer, for the current node of the current layer, the reconstructed attributes (i.e., the reconstructed attribute values) of the neighbouring nodes of the current node and the spatial geometric distances between the neighbouring nodes and the child node of the current node may be used to perform the linear fitting, and finally the respective prediction attribute value of each child node of the current node may be obtained.

Exemplarily, in the embodiments of the present disclosure, for the current node of the current layer, 19 neighbouring nodes of the current node may be first determined; and then linear weighted prediction is performed on the attributes of each child nodes by using the spatial geometric distances between the neighbouring nodes and the each child node of the current node. Finally, the respective prediction attribute value of each child node may be obtained.

Further, in some embodiments, when the RAHT transform is performed based on the prediction attribute values of the child nodes to determine the reconstructed values of the high-frequency coefficients corresponding to the nodes of the current layer and the low-frequency coefficients, the method may include the following operations. The RAHT transform is performed based on the prediction attribute values of the child nodes to determine the low-frequency coefficients and the prediction values of the high-frequency coefficients corresponding to the nodes of the current layer. The RAHT transform is performed based on the attribute values of the child nodes to determine the low-frequency coefficients and the high-frequency coefficients corresponding to the nodes of the current layer. The reconstructed values of the high-frequency coefficients corresponding to the nodes of the current layer are determined according to the prediction values of the high-frequency coefficients corresponding to the nodes of the current layer and the high-frequency coefficients corresponding to the nodes of the current layer.

Further, in some embodiments, when the reconstructed values of the high-frequency coefficients corresponding to the nodes of the current layer are determined according to the prediction values of the high-frequency coefficients corresponding to the nodes of the current layer and the high-frequency coefficients corresponding to the nodes of the current layer, the method may include the following operations. Coefficient residuals corresponding to the nodes of the current layer are determined according to the prediction values of the high-frequency coefficients corresponding to the nodes of the current layer and the high-frequency coefficients corresponding to the nodes of the current layer, and the reconstructed values of the high-frequency coefficients corresponding to the nodes of the current layer are determined according to coefficient residuals corresponding to the nodes of the current layer.

Further, in some embodiments, when the reconstructed values of the high-frequency coefficients corresponding to the nodes of the current layer are determined according to coefficient residuals corresponding to the nodes of the current layer, the method may include the following operations. Inverse quantization is performed on the quantized coefficient residuals. Inverse quantized residual values corresponding to the nodes of the current layer are determined. The reconstructed values of the high-frequency coefficients corresponding to the nodes of the current layer are determined according to the inverse quantized residual values corresponding to the nodes of the current layer and the prediction values of the high-frequency coefficients corresponding to the nodes of the current layer.

It should be noted that, in the embodiments of the present disclosure, for the current node of the current layer, after the prediction attribute values corresponding to the child nodes of the current node are determined, the RAHT attribute transform may be performed by using the prediction attribute values of the corresponding child nodes, so that the corresponding DC coefficients and the AC coefficients may be obtained. The DC coefficients are the low-frequency coefficients, and the AC coefficients are the high-frequency coefficients. In the embodiments of the present disclosure, for the current node of the current layer, the AC coefficients obtained by performing the RAHT attribute transform using the prediction attribute values corresponding to the child nodes may be understood as the prediction values of the AC coefficients corresponding to the current node.

It should further be noted that, in the embodiments of the present disclosure, for the current node of the current layer, the RAHT transform may be performed by using the attribute values of the child nodes to determine the AC coefficients and the DC coefficients corresponding to the nodes of the current layer. In the embodiments of the present disclosure, for the current node of the current layer, the AC coefficients obtained by performing the RAHT attribute transform using the attribute values corresponding to the child nodes may be understood as the original values of the AC coefficients corresponding to the current node.

In this way, coefficient residuals corresponding to the nodes of the current layer may be determined according to the prediction values of the AC coefficients and the original values of the AC coefficients corresponding to the nodes of the current layer. Then, the inverse quantization is performed on the quantized coefficient residuals to determine inverse quantized residual values corresponding to the nodes of the current layer. The reconstructed values of the AC coefficients corresponding to the nodes of the current layer are determined according to the inverse quantized residual values corresponding to the nodes of the current layer and the prediction values of the AC coefficients corresponding to the nodes of the current layer.

Exemplarily, in the embodiment of the present disclosure, the sum of the inverse quantized residual values corresponding to the nodes of the current layer and the prediction values of the AC coefficients corresponding to the nodes of the current layer may be calculated, and then the reconstructed values of the AC coefficients corresponding to the nodes of the current layer can be obtained.

Further, in some embodiments, the method may further include the following operations. Quantization is performed on the coefficient residuals to determine quantized coefficient residuals corresponding to the nodes of the current layer. Encoding processing is performed on the quantized coefficient residuals, and obtained encoded bits are signalled into a bitstream.

It should be noted that, in the embodiments of the present disclosure, the quantized coefficient residuals are signalled into the bitstream, and then the quantized coefficient residuals may be obtained by decoding the bitstream at the decoding end. Then the reconstructed values of the high-frequency coefficients corresponding to the nodes of the current layer may be determined according to the prediction values of the high-frequency coefficients and the quantized coefficient residuals.

It should also be noted that, in the embodiments of the present disclosure, after the low-frequency coefficients and the reconstructed values of the high-frequency coefficients of the nodes of the current layer are determined, the inverse RAHT transform is performed based on the reconstructed values of the high-frequency coefficients and the low-frequency coefficients, thereby determining the reconstructed attribute values of the child nodes.

Exemplarily, in the embodiments of the present disclosure, it is assumed that

$${g}_{L , 2 x , y , z}^{′}$$

and

$${g}_{L , 2 x + 1 , y , z}^{′}$$

are two attribute DC coefficients of two neighboring points of the layer L. Agter the linear transform, the information of the layer (L−1) is AC coefficient

$${f}_{L - 1 , x , y , z}^{′}$$

and DC coefficient

$${g}_{L - 1 , x , y , z}^{′} .$$

Then, no transform will be performed on

$${f}_{L - 1 , x , y , z}^{′} .$$

Quantization encoding will ne performed directly on

$${f}_{L - 1 , x , y , z}^{′} ,$$

and the nearest neighbours will continue to be found for the transform of the

$${g}_{L - 1 , x , y , z}^{′} .$$

If the nearest neighbours cannot be found, it will be directly transferred to the layer (L−2). That is, the RAHT transform is only valid for nodes with neighbouring points, and nodes without neighbouring points will be directly transferred to the upper layer. In the above transform process, the weights (the number of non-empty child nodes in the node) corresponding to

$${g}_{L , 2 x , y , z}^{′} and {g}_{L , 2 x + 2 , y , z}^{′}$$

are respectively

$${w}_{L , 2 x , y , z}^{′} and {w}_{L , 2 x + 1 , y , z}^{′}$$

(abbreviated as

$${w}_{0}^{′} and {w}_{1}^{′} ) ,$$

and the weight of

$${g}_{L - 1 , x , y , z}^{′} is {w}_{L - 1 , x , y , z}^{′} ,$$

then the general transoform formula is

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 35 )$$

Here, T_{w0,w1} is the transform matrix, and the transform matrix may be updated adaptively along with the corresponding weights of the point. The forward transform of the RAHT (which may also be referred to as the “forward RAHT transform”) is shown in aforementioned FIG. 35A.

Exemplarily, in the embodiments of the present disclosure, the inverse transform of the RAHT is performed according to the obtained DC coefficients and AC coefficients of the child nodes of the current node, and the reconstructed attribute values of the child nodes of the current node may be recovered. The inverse transform of the RAHT (which may also be referred to as the “backward RAHT transform” or “inverse RAHT transform”) is shown in aforementioned FIG. 35B.

That is to say, in the embodiments of the present disclosure, when the fourth number and the fifth number corresponding to the nodes of the current layer are different, the processes of the transform, prediction and the like may continue to be sequentially performed on the nodes of the current layer. Specifically, for the current node of the current layer, the reconstructed attribute values of the neighbouring nodes of the current node and the spatial geometric distances between the neighbouring nodes and the child nodes of the current node may be used to perform the linear fitting, so as to obtain the prediction attribute values of the child nodes of the current node. Then, the RAHT attribute transform is performed by using the prediction attributes of the child nodes to obtain corresponding DC coefficients and AC coefficients. Moreover, the attributes of the child nodes of the current node may be transformed through the RAHT attribute transform to obtain DC coefficients and AC coefficients. Then, the prediction values of the AC coefficients of the prediction node may be used to predict the AC coefficients of the current node, thereby obtaining the AC prediction residual coefficients (coefficient residual) of the child nodes. Then the quantization encoding may be performed on the coefficient residual. On the other hand, the inverse quantized residual values of the AC prediction residual coefficients and the prediction values of the AC coefficients may be used to recover the reconstructed AC coefficients (the reconstructed values of the high-frequency coefficients) of the current node. Finally, the AC coefficients and the DC coefficients of the current node may be used to perform the inverse RAHT transform, thereby recovering the reconstructed attribute value of the child nodes of the current node.

Further, in the embodiments of the present disclosure, when the current layer is the non-skip-encoding layer, the processes of the transform, prediction and the like may be sequentially performed on the nodes of the current layer to determine the reconstructed attribute values of the child nodes corresponding to the nodes of the current layer. For the child nodes of the nodes of the current layer, the sixth number of the child nodes of the next layer corresponding to the child nodes may be first determined. Then, according to the fifth number and the sixth number, the reconstructed attribute values of the child nodes of the next layer corresponding to the child nodes are determined.

That is to say, in the embodiments of the present disclosure, no matter whether the current layer is the skip-encoding layer, that is, no matter whether the processes of the transform, prediction and the like are sequentially performed on the nodes of the current layer, it is still necessary to continuously repeat the above operations, still determine the number of the nodes of other layers and the corresponding number of the child nodes, and then determine whether to execute the process of skipping encoding processing according to the number of the nodes and the number of corresponding child nodes.

Accordingly, in the embodiments of the present disclosure, the method including the operation S4601 to operation S4602 is continuously repeated from the root node of the RAHT transform to the last node of the leaf node layer of the RAHT in sequence, thereby completing attribute encoding of the entire RAHT transform.

Further, in some embodiments, the method may further include the following operations. Prediction mode identification information is determined. When the prediction mode identification information indicates that a skip encoding mode is enabled for the current unit, the operation of determining the first number and the second number is performed, and/or the operation of determining the fourth number and the fifth number is performed.

In the embodiments of the present disclosure, the prediction mode identification information is at least one of following high-layer syntax elements: a syntax element corresponding to an Attribute Parameter Sct (APS) and a syntax element corresponding to Attribute Block Header (ABH) information.

In the embodiment of the present disclosure, encoding processing may be further performed on the prediction mode identification information, and obtained encoded bits are signalled into a bitstream. When the skip encoding mode is enabled for the current unit, it is determined that the value of the prediction mode identification information is a first value. When the skip encoding mode is not enabled for the current unit, it is determined that the value of the prediction mode identification information is a second value. Hereinafter, whether the skip encoding mode is enabled for the voxel nodes of the current unit and whether the skip encoding mode is enabled for the nodes of the current layer will be described respectively.

In a specific embodiment, the method may further include the following operations. First prediction mode identification information is determined. When the first prediction mode identification information indicates that the skip encoding mode is enabled for the voxel nodes of the current unit, the operation of determining the first number and the second number is performed.

In the embodiments of the present disclosure, encoding processing may be further performed on the first prediction mode identification information, and obtained encoded bits are signalled into a bitstream. When the skip encoding mode is enabled for the voxel nodes of the current unit, it is determined that the value of the first prediction mode identification information is the first value. When the skip encoding mode is not enabled for the voxel nodes of the current unit, it is determined that the value of the first prediction mode identification information is the second value.

It should also be noted that, in the embodiments of the present disclosure, only when the skip encoding mode is enabled for the voxel nodes of the current unit, the first number and the second number may be further determined in this case, and then it may be determined, according to the magnitudes of the first number and the second number, whether to skip encoding the voxel nodes of the current unit. Specifically, if the first number is consistent with the second number, the encoding on the attributes of the voxel-level nodes is skipped. Otherwise, a timer is adopted. When the number of remaining duplicate nodes counted by the timer is zero, it represents that there are no duplicate nodes among the subsequent points. The attribute encoding of the subsequent points may be skipped, and the reconstructed attribute values of the subsequent voxel nodes may be directly copied as the reconstructed attribute values of the final remaining reconstructed points.

In another specific embodiment, the method may further include the following operations. Second prediction mode identification information is determined. When the second prediction mode identification information indicates that the skip encoding mode is enabled for the nodes of the current layer, the operation of determining the fourth number and the fifth number is performed.

In the embodiment of the present disclosure, encoding processing may be further performed on the second prediction mode identification information, and obtained encoded bits are signalled into a bitstream. When the skip encoding mode is enabled for the nodes of the current layer, it is determined that the value of the second prediction mode identification information is a first value. When the skip encoding mode is not enabled for the nodes of the current layer, it is determined that the value of the second prediction mode identification information is a second value.

It should also be noted that, in the embodiments of the present disclosure, only when the skip encoding mode is enabled for the nodes of the current layer, the fourth number and the fifth number may be further determined in this case. Then it may be determined, according to the magnitudes of the fourth number and the fifth number, whether to skip encoding the nodes of the current layer (i.e., whether the current layer is a skip-encoding layer). Specifically, if the fourth number is consistent with the fifth number, it is determined that the current layer is the skip-encoding layer, and in this case, it is no longer necessary to encode the reconstructed attribute values of the child nodes corresponding to the nodes of the current layer. If the fourth number is inconsistent with the fifth number, it is determined that the current layer is not the skip-encoding layer, and in this case, the RAHT prediction and encoding may be performed according to the encoding method in the related art.

It should also be noted that in the embodiments of the present disclosure, the first value is different from the second value, and the first value and the second value may be in the form of parameters or numerics. Specifically, each of the first prediction mode identification information and the second prediction mode identification information may be a parameter written in a profile, or may be a value of a flag, which is not specifically limited herein. In addition, for the first value and the second value, the first value may be set to 1 and the second value may be set to 0). Alternatively, the first value may be set to 0 and the second value may be set to 1. Alternatively, the first value may also be set to true, and the second value may also be set to false. Alternatively, the first value may be set to false, and the second value may be set to true. In the embodiments of the present disclosure, the first value is set to 1 and the second value is set to 0), but, which is not specifically limited.

Exemplarily, in some embodiments, taking the first value being set to 1 and the second value being set to 0 as an example, when the skip encoding mode is enabled for the nodes of the current layer, it is determined that the value of the second prediction mode identification information is 1, and the fourth number and the fifth number corresponding to the nodes of the current layer may be further determined according to the aforementioned method. When the skip encoding mode is not enabled for the nodes of the current layer, it may be determined that the value of the second prediction mode identification information is 0, and the attribute encoding processing may be performed on the nodes of the current layer according to a common intra prediction method or a common inter prediction method.

That is to say, in the embodiments of the present disclosure, when the value of the first prediction mode identification information singalled into the bitstream is the first value, it is determined that the skip encoding mode is enabled for the voxel nodes of the current unit, and the operation of determining the first number and the second number may be executed (i.e., the encoding flow shown in FIG. 44 may be executed). When the value of the second prediction mode identification information signalled into the bitstream is the first value, it is determined that the skip encoding mode is enabled for the nodes of the current layer, and the flow of determining the fourth number and the fifth number may be executed (i.e., the encoding flow shown in FIG. 46 may be executed).

Further, the embodiments of the present disclosure also provide a bitstream. The bitstream is generated by performing bit encoding according to to-be-encoded information, and the to-be-encoded information may include at least one of: prediction mode identification information, attribute information of duplicate nodes of a current unit, and quantized coefficient residuals corresponding to nodes of the current layer. The prediction mode identification information is used to indicate whether a skip encoding mode is enabled for the current unit.

It should be noted that, in the embodiments of the present disclosure, after the encoding end determines the to-be-encoded information, the to-be-encoded information may be signalled into the bitstream. Then, the bitstream is transmitted by the encoding end to the decoding end. At the decoding end, the information, such as the prediction mode identification information may be obtained by decoding the bitstream, so as to determine whether the skip encoding mode is enabled for the current unit.

To sum up, in the embodiments of the present disclosure, when the attribute information is encoded, if the number of the nodes of the current layer is consistent with the number of the child nodes of the current layer, the current layer is considered to be the skip-encoding layer, and it is not necessary to perform the processes of the transform, prediction, encoding, decoding and the like on the current layer. In this way, the time complexity of the encoding and decoding of the attribute transform can be reduced, and the efficiency of the attribute coding would not be affected.

The present embodiment provides an encoding method where an encoding method of skipping the current layer is proposed. It is adaptively determined whether to skip the encoding for the current layer by using the number of the nodes of the current layer and the number of the child nodes of the current layer, so that the time complexity of encoding and decoding can be reduced on the premise of ensuring that the efficiency of the encoding and decoding remains unchanged. In addition, an encoding method of skipping the voxel-level nodes is also proposed herein. Firstly, the number of the voxel nodes and the number of the reconstructed nodes may be determined. When the number of the reconstructed nodes is consistent with the number of the voxel nodes, it is considered that there are no duplicate nodes in the current unit, and encoding the attributes of the voxel-level nodes may also be skipped. In this way, on the basis of ensuring the efficiency of the attribute encoding and decoding of the point cloud, the time complexity of the attribute encoding and decoding of the point cloud can be reduced, and the code rate can be saved, thereby improving the encoding and decoding performance of the point cloud.

In another embodiment of the present disclosure, based on the encoding and decoding method of the aforementioned embodiments, in the embodiments of the present disclosure, the RAHT attribute encoding layer is first defined. At present, the encoding order of the RAHT attribute transform is that the partitioning is started from the root node, until the partitioning is performed to the voxel level (i.e., the unit cubes of 1×1×1 are obtained), thereby completing the attribute encoding and the attribute reconstruction of the entire point cloud. Here, it may be defined that the layer obtained by down-sampling once along the Z direction, the Y direction and the X direction is the RAHT transform layer (i.e., the layer), and the specific process is illustrated in FIG. 42.

Secondly, based on the RAHT attribute encoding layer, an algorithm of skipping the encoding layer is introduced. Firstly, when the attributes of the nodes of the current layer are encoded/decoded, the number of the nodes of the current layer may be obtained. After the child nodes of the nodes of the current layer are recovered by using the geometric information of the nodes of the current layer, the number of the child nodes of the nodes of the current layer may be obtained. It is determined, based on the magnitudes of the number of the nodes of the current layer and the number of the child nodes of the nodes of the current layer, whether the current layer is the skip-encoding layer.

When the number of the nodes of the current layer is consistent with the number of the child nodes of the nodes of the current layer, the current layer is the skip-encoding layer.

Otherwise, the current layer is the non-skip-encoding layer.

In this way, after the start condition of skipping the encoding layer is obtained, a specific algorithm performed by the encoding end includes the following operations.

In operation 1, it is determined whether the number of the nodes of the current layer is consistent with the number of the child nodes of the current layer. When the number of the nodes of the current layer is consistent with the number of the child nodes of the current layer, the current layer is the skip-encoding layer. Otherwise, the current layer is the non-skip-encoding layer.

In operation 2, when the current layer is not the skip-encoding layer, the transform, the prediction and the encoding are performed according to the encoding method in the related art.

In operation 3, when the current layer is the skip-encoding layer, the current layer is directly skipped and the next layer is preceded to.

In operation 4, the above operations are repeated until the encoding is performed at the voxel level.

In operation 5, for the voxel-level nodes, before the attribute encoding is performed on the voxel-level nodes, it is first determined whether the number of the voxel-level nodes of the current encoding unit is consistent with the number of the reconstructed nodes of the current encoding unit. If the number of the voxel-level nodes of the current encoding unit is consistent with the number of the reconstructed nodes of the current encoding unit, encoding the attributes of the voxel-level points is skipped. Otherwise, a timer is adopted. When the number of remaining duplicate points counted by the timer is zero, it represents that there are no duplicate points among the subsequent nodes, and the attribute encoding of the subsequent nodes may also be skipped.

At the decoding end, the specific algorithm includes following operations.

In operation 1, it is determined whether the number of the nodes of the current layer is consistent with the number of the child nodes of the current layer. When the number of the nodes of the current layer is consistent with the number of the child nodes of the current layer, the current layer is the skip-decoding layer. Otherwise, the current layer is the non-skip-decoding layer.

In operation 2, when the current layer is not the skip-decoding layer, the transform, the prediction and the decoding are performed according to the decoding method in the related art.

In operation 3, when the current layer is the skip-decoding layer, the current layer is directly skipped and the next layer is preceded to.

In operation 4, the above operations are repeated until the decoding is performed at the voxel level.

In operation 5, for the voxel-level nodes, before the attribute decoding is performed on the voxel-level nodes, it is first determined whether the number of the voxel-level nodes of the current decoding unit is consistent with the number of the reconstructed nodes of the current decoding unit. If the number of the voxel-level nodes of the current decoding unit is consistent with the number of the reconstructed nodes of the current decoding unit, decoding to obtain the attributes of the voxel-level points is skipped. Otherwise, a timer is adopted. When the number of remaining duplicate points counted by the timer is zero, it represents that there are no duplicate points among the subsequent nodes, and the attribute decoding of the subsequent nodes may also be skipped. The reconstructed attribute values of the subsequent remaining voxel nodes may be directly copied as the reconstructed attribute values of the final remaining reconstructed nodes.

That is to say, in the embodiments of the present disclosure, an encoding method of skipping an encoding layer is proposed here, and it is adaptively determined, by using the number of the nodes of the current layer and the number of the child nodes of the current layer, whether to skip encoding for the current layer. In this way, the time complexity of encoding and decoding can be reduced on the premise of ensuring that the efficiency of the encoding and decoding remains unchanged. Similarly, in the RAHT encoding solution, the encoding end and decoding end first completes the encoding of and decoding for the attribute information of the non-node layer (that is, the size of the node is greater than or equal to 1×1×1), and finally the attribute information of the voxel-level nodes is encoded and the attribute information of the voxel-level nodes is obtained by decoding. Since there are duplicate points in the point cloud, it is necessary to first complete the encoding and decoding of the attribute information of the non-voxel-level points, and then complete the encoding of and decoding for the attribute information of the voxel-level points. In this way, at the encoding end and the decoding end, the number of the voxel-level reconstructed points may be first obtained. When the number of the reconstructed points is consistent with the number of the to-be-reconstructed nodes, it is considered that there do not exist duplicate points in the current encoding unit (such as a slice), and the encoding/decoding to determine the attribute information of the voxel-level points may also be skipped.

Through the aforementioned embodiments, the specific implementations of the aforementioned embodiments are described in detail. It can be seen that according to the technical solutions of the aforementioned embodiments, in the embodiments of the present disclosure, when the RAHT encoding is performed on the attribute information, at each RAHT attribute encoding layer, it is determined whether the current RAHT attribute encoding layer is the skip-encoding layer by determining whether the number of the nodes of the current layer is consistent with the number of the child nodes of the current layer. When the number of the nodes of the current layer is consistent with the number of the child nodes of the nodes of the current layer, the current layer is considered to be the skip-encoding layer, and it is not necessary to perform the processes of the transform, prediction, encoding, decoding and the like. In this way, the time complexity of the encoding/decoding of the attribute transform can be reduced, and the efficiency of the attribute coding will not be affected.

In another embodiment of the present disclosure, based on the same invention concept as the aforementioned embodiments, with reference to FIG. 47, a schematic diagram of a structural composition of an encoder according to an embodiment of the present disclosure is shown. As shown in FIG. 47, the encoder 470) may include a first determination unit 4701 and an encoding unit 4702.

The first determination unit 4701 is configured to determine a first number of voxel nodes of a current unit and a second number of reconstructed nodes of the current unit.

The encoding unit 4702 is configured to determine whether to skip encoding attribute information of the voxel nodes of the current unit according to the first number and the second number.

In some embodiments, the encoding unit 4702 is further configured to: when the first number is the same as the second number, skip encoding the attribute information of the voxel nodes; and when the first number is different from the second number, perform attribute encoding on duplicate nodes among the voxel nodes, and skip encoding attribute information of remaining voxel nodes other than the duplicate nodes among the voxel nodes.

In some embodiments, the encoding unit 4702 is further configured to: perform encoding processing on the attribute information of the duplicate nodes, and signal obtained encoded bits into a bitstream.

In some embodiments, the encoding unit 4702 is further configured to: set a timer; and start the timer when the encoding processing on the attribute information of the duplicate nodes begins, and determine that all pieces of the attribute information of the duplicate nodes are encoded when a timing of the timer reaches a preset value.

In some embodiments, the first determination unit 4701 is further configured to: determine a third number of the duplicate nodes among the voxel nodes based on a difference between the first number and the second number. The setting of the timer is associated with the third number.

In some embodiments, with reference to FIG. 47, the encoder 470) may further include a first reconstruction unit 4703. The first reconstruction unit 4703 is configured to determine reconstructed attribute values of the voxel nodes of the current unit according to the first number and the second number.

In some embodiments, the first reconstruction unit 4703 is further configured to: when the first number is the same as the second number, set the reconstructed attribute values of the voxel nodes of the current unit as reconstructed attribute values of the reconstructed nodes of the current unit.

In some embodiments, the first reconstruction unit 4703 is further configured to: when the first number is different from the second number, take the reconstructed attribute values of the duplicate nodes as a reconstructed attribute value of a first reconstructed node of the current unit, and set reconstructed attribute values of the remaining voxel nodes other than the duplicate nodes among the voxel nodes as reconstructed attribute values of remaining reconstructed nodes other than the first reconstructed node of the current unit.

In some embodiments, the first determination unit 4701 is further configured to: partition nodes of the current unit to determine at least one layer; and when nodes of a last layer are partitioned to a voxel level, determine the voxel nodes of the current unit and the first number of the voxel nodes.

In some embodiments, the at least one layer includes a current layer, and the first determination unit 4701 is further configured to: determine a fourth number of the nodes of the current layer and a fifth number of the child nodes corresponding to the nodes of the current layer. The fourth number and the fifth number are used to determine whether to skip the encoding for the current layer.

The first reconstruction unit 4703 is further configured to: determine reconstructed attribute values of the child nodes corresponding to the nodes of the current layer according to the fourth number and the fifth number.

In the embodiments of the present disclosure, the fourth number is configured to represent a number of occupied nodes of the current layer. The fifth number is configured to represent a number of occupied child nodes or a number of to-be-decoded nodes among the nodes of the current layer.

In some embodiments, the first determination unit 4701 is further configured to: when the fourth number is the same as the fifth number, determine reconstructed attribute values of the nodes of the current layer as the reconstructed attribute values of the child nodes corresponding to the nodes of the current layer.

In some embodiments, the first determination unit 4701 is further configured to: when the fourth number is the same as the fifth number, determine a sixth number of child nodes of a next layer corresponding to the child nodes.

The first reconstruction unit 4703 is further configured to: determine reconstructed attribute values of the child nodes of the next layer corresponding to the child nodes according to the fifth number and the sixth number.

In some embodiments, the first reconstruction unit 4703 is further configured to: when the fourth number is different from the fifth number, determine prediction attribute values of the child nodes corresponding to the nodes of the current layer according to the nodes of the current layer: respectively perform an RAHT transform based on the prediction attribute values of the child nodes and attribute values of the child nodes, so as to determine low-frequency coefficients and reconstructed values of high-frequency coefficients corresponding to the nodes of the current layer; and perform an inverse RAHT transform based on the reconstructed values of the high-frequency coefficients and the low-frequency coefficients to determine the reconstructed attribute values of the child nodes.

In some embodiments, the first determination unit 4701 is further configured to: determine neighbouring nodes corresponding to the nodes of the current layer; and determine the prediction attribute values of the child nodes corresponding to the nodes of the current layer according to reconstructed attribute values and a relative distance parameter that correspond to the neighbouring nodes.

In some embodiments, the first reconstruction unit 4703 is further configured to: perform the RAHT transform based on the prediction attribute values of the child nodes to determine the low-frequency coefficients and prediction values of the high-frequency coefficients corresponding to the nodes of the current layer: perform the RAHT transform based on the attribute values of the child nodes to determine the low-frequency coefficients and the high-frequency coefficients corresponding to the nodes of the current layer; and determine the reconstructed values of the high-frequency coefficients corresponding to the nodes of the current layer according to the prediction values of the high-frequency coefficients corresponding to the nodes of the current layer and the high-frequency coefficients corresponding to the nodes of the current layer.

In some embodiments, the first reconstruction unit 4703 is further configured to: determine coefficient residuals corresponding to the nodes of the current layer according to the prediction values of the high-frequency coefficients corresponding to the nodes of the current layer and the high-frequency coefficients corresponding to the nodes of the current layer; and determine the reconstructed values of the high-frequency coefficients corresponding to the nodes of the current layer according to coefficient residuals corresponding to the nodes of the current layer.

In some embodiments, the first determination unit 4701 is further configured to: perform quantization on the coefficient residuals to determine quantized coefficient residuals corresponding to the nodes of the current layer.

The encoding unit 4702 is further configured to: perform encoding processing on the quantized coefficient residuals, and signal obtained encoded bits into a bitstream.

In some embodiments, the first reconstruction unit 4703 is further configured to: perform inverse quantization on the quantized coefficient residuals to determine inverse quantized residual values corresponding to the nodes of the current layer; and determine the reconstructed values of the high-frequency coefficients corresponding to the nodes of the current layer according to the inverse quantized residual values corresponding to the nodes of the current layer and the prediction values of the high-frequency coefficients corresponding to the nodes of the current layer.

In some embodiments, the first determination unit 4701 is further configured to: determine geometric information of the nodes of the current layer; and determine child nodes corresponding to the nodes of the current layer and the fifth number according to the geometric information.

In some embodiments, the first determination unit 4701 is further configured to: determine prediction mode identification information.

The encoding unit 4702 is further configured to: when the prediction mode identification information indicates that a skip encoding mode is enabled for the current unit, perform the operation of determining the first number and the second number, and/or perform the operation of determining the fourth number and the fifth number.

In some embodiments of the present disclosure, the prediction mode identification information is at least one of following high-layer syntax elements: a syntax element corresponding to an attribute parameter set and a syntax element corresponding to attribute block header information.

In some embodiments, the encoding unit 4702 is further configured to: perform encoding processing on the prediction mode identification information, and signal obtained encoded bits into a bitstream.

It can be understood that in the embodiments of the present disclosure, a “unit” may be a part of a circuit, a part of a processor, a part of a program or software, etc. Of course, the “unit” may also be a module, or may be non-modular. Moreover, the various components in the embodiments of the present disclosure may be integrated in one processing unit, or each unit may exist physically alone, or two or more units may be integrated in one unit. The integrated unit may be implemented either in the form of hardware or in the form of software function module.

If the integrated unit is implemented in the form of software functional modules and sold or used as an independent product, it may also be stored in a computer-readable storage medium. Based on such understanding, technical solutions of the embodiments of the present disclosure substantially or parts making contributions to the related art may be embodied in the form of software. The computer software product is stored in a storage medium, includes several instructions to cause a computer device (which may be a personal computer, a server, a network device, etc.) or a processor to perform all or part of the operations of the method according to the embodiments of the present disclosure. The above storage media include: a U disk, a removable hard disk, a Read-Only Memory (ROM), a Random Access Memory (RAM), a disk or an optical disk and other media that can store program codes.

Therefore, the embodiment of the present disclosure provides a computer-readable storage medium applied to the encoder 470. The computer-readable storage medium is configured to store a computer program that, when executed by a first processor, cause the first processor to implement the method of any of the aforementioned embodiments.

Based on the composition of the encoder 470 and the computer-readable storage medium described above. FIG. 48 shows a schematic diagram of a specific hardware structure of an encoder 470) according to an embodiment of the present disclosure. As shown in FIG. 48, the encoder 470 may include a first communication interface 4801, a first memory 4802 and a first processor 4803. The components are coupled together by a first bus system 4804. It is to be understood that the first bus system 4804 is used to implement the connection communication between these components. In addition to a data bus, the first bus system 4804 includes a power bus, a control bus and a status signal bus. However, for the sake of clarity, the various buses are designated as the first bus system 4804 in FIG. 48.

The first communication interface 4801 is configured to receive and send signal in the process of receiving and sending information with other external network elements.

The first memory 4802 is configured to store computer programs capable of running on the first processor 4803.

The first processor 4803 is configured to run the computer programs to perform the following operations.

A first number of voxel nodes of a current unit and a second number of reconstructed nodes of the current unit are determined.

It is determined whether to skip encoding attribute information of the voxel nodes of the current unit according to the first number and the second number.

It can be understood that the first memory 4802 in the embodiments of the present disclosure may be a volatile memory or a non-volatile memory, or may include both the volatile memory and the non-volatile memory. The non-volatile memory may be an ROM, a Programmable ROM (PROM), an Erasable PROM (EPROM), an Electrically EPROM (EEPROM) or a flash memory. The volatile memory may be a Random Access Memory (RAM) and is used as an external high-speed cache. By way of illustration and not limitation, many forms of RAM are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DRRAM). The first memory 4802 of the systems and methods described in this specification includes but is not limited to these and any other proper types of memories.

The first processor 4803 may be an integrated circuit chip with signal processing capacity. In the implementation process, various operations of the above methods may be completed by integrated logic circuits of hardware in the first processor 4803 or instructions in the form of software. The above first processor 4803 may be a general-purpose processor, a Digital Signal Processor (DSP), an Application Specific Integrated Circuit (ASIC), a Field Programmable Gate Array (FPGA), or other programmable logic devices, discrete gate or transistor logic devices, and discrete hardware components. Various methods, steps, and logical block diagrams disclosed in the embodiments of the disclosure may be implemented or performed. The general-purpose processor may be a microprocessor, any conventional processor, or the like. Steps of the methods disclosed with reference to the embodiments of the disclosure may be directly performed and accomplished by a hardware decoding processor, or may be performed and accomplished by a combination of hardware and software modules in the decoding processor. The software modules may be located in a mature storage medium in the art, such as a random access memory, a flash memory, a read-only memory, a programmable read-only memory or electrically erasable programmable memory, or a register. The storage medium is located in the first memory 4802, and the first processor 4803 reads information in the first memory 4802 and completes the steps in the foregoing methods in combination with hardware of the processor.

It can be understood that the embodiments described herein may be implemented in hardware, software, firmware, middleware, microcode or a combination thereof. For the hardware implementation, the processing unit may be implemented in one or more Application Specific Integrated Circuits (ASIC). Digital Signal Processors (DSP). Digital Signal Processing Devices (DSPD). Programmable Logic Devices (PLD). Field-Programmable Gate Arrays (FPGA), general purpose processors, controllers, microcontrollers, microprocessors, other electronic units or combinations thereof for performing the functions described herein. For software implementations, the technology described herein may be implemented by modules (e.g, procedures, functions, etc.) that perform the functions described herein. The software codes may be stored in memory and executed by a processor. The memory can be implemented in the processor or outside the processor.

Optionally, as another embodiment, the first processor 4803 is further configured to perform the method described in any one of the aforementioned embodiments when running the computer program.

The present embodiments provide an encoder. In the encoder, when the attribute reconstruction is performed on each voxel node, the judgment condition of whether the attribute encoding and decoding is performed on each voxel node is optimized. Specifically, if there are no duplicate nodes in the current unit (i.e., the first number is the same as the second number), the voxel nodes of the current unit are not required to be encoded and decoded in this case. In this way, on the basis of ensuring the efficiency of attribute encoding and decoding of the point cloud, the time complexity of the attribute encoding and decoding of the point cloud can be reduced, and the code rate can be saved, thereby improving the encoding and decoding performance of the point cloud.

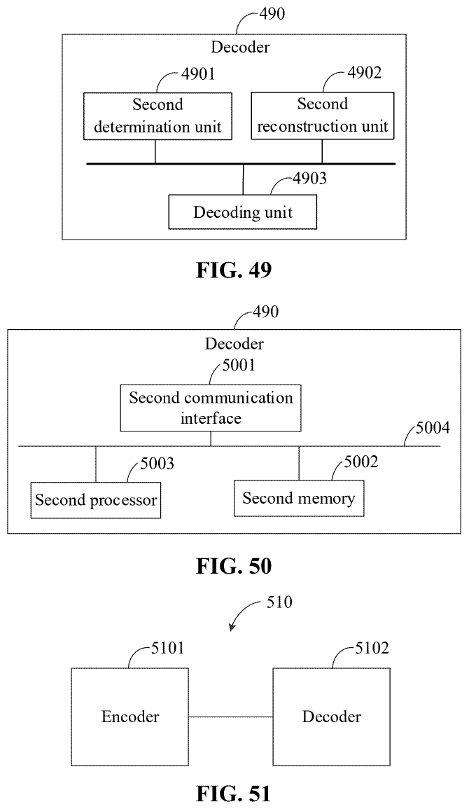

In another embodiment of the present disclosure, based on the same invention concept as the aforementioned embodiments, with reference to FIG. 49, a schematic diagram of a structural composition of a decoder according to an embodiment of the present disclosure is shown. As shown in FIG. 49, the decoder 490) may include a second determination unit 4901 and a second reconstruction unit 4902.

The second determination unit 4901 is configured to determine a first number of voxel nodes of a current unit and a second number of reconstructed nodes of the current unit. The first number and the second number are used to determine whether to skip decoding the voxel nodes of the current unit.

The second reconstruction unit 4902 is configured to determine reconstructed attribute values of the voxel nodes of the current unit according to the first number and the second number.

In some embodiments, with reference to FIG. 49, the decoder 490) may further include a decoding unit 4903. The decoding unit 4903 is configured to skip decoding the voxel nodes of the current unit when the first number is the same as the second number.

In some embodiments, the second reconstruction unit 4902 is further configured to: when the first number is the same as the second number, set the reconstructed attribute values of the voxel nodes of the current unit as reconstructed attribute values of the reconstructed nodes of the current unit.

In some embodiments, the decoding unit 4903 is further configured to: when the first number is different from the second number, perform attribute decoding on duplicate nodes among the voxel nodes, and skip decoding remaining voxel nodes other than the duplicate nodes among the voxel nodes.

In some embodiments, the second reconstruction unit 4902 is further configured to: when the first number is different from the second number, decode a bitstream to determine reconstructed attribute values of the duplicate nodes: take the reconstructed attribute values of the duplicate nodes as a reconstructed attribute value of a first reconstructed node of the current unit, and set reconstructed attribute values of the remaining voxel nodes other than the duplicate nodes among the voxel nodes as reconstructed attribute values of remaining reconstructed nodes other than the first reconstructed node of the current unit.

In some embodiments, the decoding unit 4903 is further configured to: set a timer; start the timer when the decoding to determine the reconstructed attribute values of the duplicate nodes begins, and determine that all the reconstructed attribute values of the duplicate nodes are determined through the decoding when a timing of the timer reaches a preset value.

In some embodiments, when the first number is different from the second number, the second determination unit 4901 is further configured to: determine a third number of the duplicate nodes among the voxel nodes based on a difference between the first number and the second number. The setting of the timer is associated with the third number.

In some embodiments, the second determination unit 4901 is further configured to: partition nodes of the current unit to determine at least one layer, and determine the voxel nodes of the current unit and the first number of the voxel nodes when nodes of a last layer are partitioned to a voxel level.

In some embodiments, the at least one layer includes a current layer, and the second determination unit 4901 is further configured to determine a fourth number of the nodes of the current layer and a fifth number of the child nodes corresponding to the nodes of the current layer. The fourth number and the fifth number are used to determine whether to skip decoding for the current layer.

The second reconstruction unit 4902 is further configured to determine reconstructed attribute values of the child nodes corresponding to the nodes of the current layer according to the fourth number and the fifth number.

In the embodiments of the present disclosure, the fourth number is configured to represent the number of occupied nodes of the current layer. The fifth number is configured to represent the number of occupied child nodes or a number of to-be-encoded nodes among the nodes of the current layer.

In some embodiments, the second reconstruction unit 4902 is further configured to determine reconstructed attribute values of the nodes of the current layer as the reconstructed attribute values of the child nodes corresponding to the nodes of the current layer when the fourth number is the same as the fifth number.

In some embodiments, the second reconstruction unit 4902 is further configured to: when the fourth number is the same as the fifth number, determine a sixth number of the child nodes of a next layer corresponding to the child nodes; and determine reconstructed attribute values of the child nodes of the next layer corresponding to the child nodes according to the fifth number and the sixth number.

In some embodiments, the second reconstruction unit 4902 is further configured to: when the fourth number is different from the fifth number, determine prediction attribute values of the child nodes corresponding to the nodes of the current layer according to the nodes of the current layer: perform an RAHT transform based on the prediction attribute values of the child nodes to determine low-frequency coefficients and reconstructed values of high-frequency coefficients corresponding to the nodes of the current layer; and perform an inverse RAHT transform based on the reconstructed values of the high-frequency coefficients and the low-frequency coefficients to determine the reconstructed attribute values of the child nodes.

In some embodiments, the second determination unit 4901 is further configured to: determine neighbouring nodes corresponding to the nodes of the current layer; and determine the prediction attribute values of the child nodes corresponding to the nodes of the current layer according to reconstructed attribute values and a relative distance parameter that correspond to the neighbouring nodes.

In some embodiments, the second reconstruction unit 4902 is further configured to: perform the RAHT transform based on the prediction attribute values of the child nodes to determine the low-frequency coefficients and prediction values of the high-frequency coefficients corresponding to the nodes of the current layer; and determine the reconstructed values of the high-frequency coefficients corresponding to the nodes of the current layer according to the prediction values of the high-frequency coefficients.

In some embodiments, the decoding unit 4903 is further configured to decode a bitstream to determine quantized coefficient residuals corresponding to the nodes of the current layer.

The second determination unit 4901 is further configured to determine the reconstructed values of the high-frequency coefficients corresponding to the nodes of the current layer according to the prediction values of the high-frequency coefficients and the quantized coefficient residuals.

In some embodiments, the second reconstruction unit 4902 is further configured to: perform inverse quantization on the quantized coefficient residuals to determine inverse quantized residual values corresponding to the nodes of the current layer; and determine the reconstructed values of the high-frequency coefficients corresponding to the nodes of the current layer according to the inverse quantized residual values corresponding to the nodes of the current layer and the prediction values of the high-frequency coefficients corresponding to the nodes of the current layer.

In some embodiments, the second determination unit 4901 is further configured to: determine geometric information of the nodes of the current layer; and determine child nodes corresponding to the nodes of the current layer and the fifth number according to the geometric information.

In some embodiments, the decoding unit 4903 is further configured to: decode a bitstream to determine prediction mode identification information; and when the prediction mode identification information indicates that a skip decoding mode is enabled for the current unit, perform the operation of determining the first number and the second number, and/or perform the operation of determining the fourth number and the fifth number.

In some embodiments of the present disclosure, the prediction mode identification information is at least one of following high-layer syntax elements: a syntax element corresponding to an attribute parameter set and a syntax element corresponding to attribute block header information.

It can be understood that in the embodiments of the present disclosure, a “unit” may be a part of a circuit, a part of a processor, a part of programs or software, etc. Of course the “unit” may also be a module, or may be non-modular. Moreover, the various components in the embodiments of the present disclosure may be integrated in one processing unit, or each unit may exist physically alone, or two or more units may be integrated in one unit. The integrated unit may be implemented either in the form of hardware or in the form of software function module.

If an integrated module according to embodiments of the disclosure is implemented in the form of a software functional module and sold or used as an independent product, it may also be stored in a computer-readable storage medium. Based on such understanding, the present embodiment provides a computer-readable storage medium applied to the decoder 490, and the computer-readable storage medium is configured to store a computer program that, when executed by a second processor, causes the second processor to implement the method described in any one of the preceding embodiments.

Based on the composition of the decoder 490) and the computer-readable storage medium described above, with reference to FIG. 50, a schematic diagram of a specific hardware structure of a decoder 490 according to an embodiment of the present disclosure is illustrated. As shown in FIG. 50, the decoder 490 may include a second communication interface 5001, a second memory 5002 and a second processor 5003. The components are coupled together by a second bus system 5004. It is to be understood that the second bus system 5004 is used to implement the communication connection between these components. In addition to a data bus, the second bus system 5004 includes a power bus, a control bus and a status signal bus. However, for the sake of clarity, the various buses are designated in FIG. 50 as the second bus system 5004.

The second communication interface 5001 is configured to receive and send signal in the process of receiving and sending information with other external network elements.

The second memory 5002 is configured to store computer programs that can run on the second processor 5003.

The second processor 5003 is configured to run the computer programs to perform the following operations.

A first number of voxel nodes of a current unit and a second number of reconstructed nodes of the current unit are determined. The first number and the second number are used to determine whether to skip decoding the voxel nodes of the current unit.

Reconstructed attribute values of the voxel nodes of the current unit are determined according to the first number and the second number.

Optionally, as another embodiment, the second processor 5003 is further configured to perform the method described in any one of the aforementioned embodiments when the computer program is run.

It is to be understood that the second memory 5002 has the hardware functions similar to those of the first memory 4802, and the second processor 5003 has the hardware functions similar to those of the first processor 4803, which are not described in detail.

The present embodiments provide a decoder. In the decoder, when the attribute reconstruction is performed on each voxel node, the judgment condition of whether the attribute encoding and decoding is performed on each voxel node is optimized. Specifically, if there are no duplicate nodes in the current unit (i.e., the first number is the same as the second number), it is not necessary to encode and decode the voxel nodes of the current unit in this case. In this way, on the basis of ensuring the efficiency of encoding and decoding of the attributes of the point cloud, the time complexity of the encoding and decoding of the attributes of the point cloud can be reduced, and the code rate can be saved, thereby improving the encoding and decoding performance of the point cloud.

In another embodiment of the present disclosure. FIG. 51 shows a schematic diagram of a structural composition of an encoding and decoding system according to an embodiment of the present disclosure. As shown in FIG. 51, the encoding and decoding system 510 may include an encoder 5101 and a decoder 5102.

In the embodiment of the present disclosure, the encoder 5101 may be the encoder described in any one of the aforementioned embodiments, and the decoder 5102 may be the decoder described in any one of the aforementioned embodiments.

It is to be noted that, in the present disclosure, the terms “include”. “contain” or any other variation thereof, are intended to cover a non-exclusive inclusion, such that a process, method, article, or device that includes a list of elements includes not only those elements but also other elements not expressly listed, or also includes elements inherent to such process, method, article, or device. Without more limitations, an element defined by the statement “including a . . . ” does not exclude the presence of additional identical elements in a process, method, article, or apparatus that includes the element.

The aforementioned numbers of the embodiments of the present disclosure are for the purpose of description only and do not represent the advantages or disadvantages of the embodiments

The methods disclosed in several method embodiments provided in the present disclosure can be arbitrarily combined without conflict to obtain new method embodiments.

The features disclosed in several product embodiments provided in the present disclosure can be arbitrarily combined without conflict to obtain new product embodiments.

The features disclosed in several methods or device embodiments provided in the present disclosure can be arbitrarily combined without conflict to obtain new method embodiments or device embodiments.

Embodiments of the present disclosure provide an encoding method, a decoding method, a bitstream, an encoder, a decoder, and a storage medium, which can reduce time complexity of attribute encoding and decoding, improve the efficiency of attribute encoding and decoding of the point cloud, thereby improving encoding and decoding performance of the point cloud.

The technical solutions of the embodiments of the present disclosure may be realized as follows.

In a first aspect, the embodiments of the present disclosure provide a decoding method. The method is applied to a decoder and includes the following operations.

A first number of voxel nodes of a current unit and a second number of reconstructed nodes of the current unit are determined. The first number and the second number are used to determine whether to skip decoding the voxel nodes of the current unit.

Reconstructed attribute values of the voxel nodes of the current unit are determined according to the first number and the second number.

In a second aspect, the embodiments of the present disclosure provide an encoding method. The method is applied to an encoder and includes the following operations.

A first number of voxel nodes of a current unit and a second number of reconstructed nodes of the current unit are determined.

It is determined whether to skip encoding attribute information of the voxel nodes of the current unit according to the first number and the second number.

In a third aspect, the embodiments of the present disclosure provide a bitstream. The bitstream is generated by performing bit encoding according to to-be-encoded information.

The to-be-encoded information includes at least one of: prediction mode identification information, attribute information of duplicate nodes of a current unit, or quantized coefficient residuals corresponding to nodes of the current layer. The prediction mode identification information is used to indicate whether a skip encoding mode is enabled for the current unit.

In a fourth aspect, the embodiments of the present disclosure provide an encoder. The encoder includes a first determination unit and an encoding unit.

The first determination unit is configured to determine a first number of voxel nodes of a current unit and a second number of reconstructed nodes of the current unit.

The encoding unit is configured to determine whether to skip encoding attribute information of the voxel nodes of the current unit according to the first number and the second number.

In a fifth aspect, the embodiments of the present disclosure provide an encoder. The encoder includes a first memory and a first processor.

The first memory is configured to store a computer program executable on the first processor.

The first processor is configured to perform the method of the second aspect when executing the computer program.

In a sixth aspect, the embodiments of the present disclosure provide a decoder. The decoder includes a second determination unit and a second reconstruction unit.

The second determination unit is configured to determine a first number of voxel nodes of a current unit and a second number of reconstructed nodes of the current unit. The first number and the second number are used to determine whether to skip decoding the voxel nodes of the current unit.

The second reconstruction unit is configured to determine reconstructed attribute values of the voxel nodes of the current unit according to the first number and the second number.

In a seventh aspect, the embodiments of the present disclosure provide a decoder. The decoder includes a second memory and a second processor.

The second memory is configured to store a computer program executable on the second processor.

The second processor is configured to perform the method according to the first aspect when executing the computer program.

In an eighth aspect, the embodiments of the present disclosure provide a computer-readable storage medium. The computer-readable storage medium is configured to store a computer program that, when executed, implements the method according to the first aspect or implements the method according to the second aspect.

The embodiments of the present disclosure provide an encoding method, a decoding method, a bitstream, an encoder, a decoder, and a storage medium. Whether at the encoding end or the decoding end, the first number of voxel nodes of the current unit and the second number of reconstructed nodes of the current unit are firstly determined, and then reconstructed attribute values of the voxel nodes of the current unit are determined according to the first number and the second number. The first number and the second number are used to determine whether to skip encoding and decoding the voxel nodes of the current unit. That is, when the attribute reconstruction is performed on each voxel node, the judgment condition of whether the attribute encoding and decoding is performed on each voxel node is optimized. Specifically, if there are no duplicate nodes in the current unit (i.e., the first number is the same as the second number), it is not necessary to encode and decode the voxel nodes of the current unit in this case. In this way, on the basis of ensuring the efficiency of encoding and decoding of the attributes of the point cloud, the time complexity of the encoding and decoding of the attributes of the point cloud can be reduced, and the code rate can be saved, thereby improving the encoding and decoding performance of the point cloud.

The above are only the specific implementations of the present disclosure, but the scope of protection of the disclosure is not limited thereto. Any variation or replacement readily figured out by those skilled in the art within the technical scope disclosed in the disclosure shall fall within the scope of protection of the disclosure. Therefore, the scope of protection of the disclosure is defined by the scope of protection of the claims.

### INDUSTRIAL APPLICABILITY

According to the embodiments of the present disclosure, whether at the encoding end or the decoding end, the first number of the voxel nodes of the current unit and the second number of the reconstructed nodes of the current unit are determined, and then the reconstructed attribute values of the voxel nodes of the current unit are determined according to the first number and the second number. The first number and the second number are used to determine whether to skip encoding and decoding the voxel nodes of the current unit. The fourth number of the nodes of the current layer and the fifth number of the child nodes corresponding to the nodes of the current layer are determined. The reconstructed attribute values of the child nodes corresponding to the nodes of the current layer are determined according to the fourth number and the fifth number. The fourth number and the fifth number are used to determine whether to skip encoding and decoding for the current layer. In this way, it is adaptively determined, by using the number of the nodes of the current layer and the number of the child nodes of the current layer, whether to skip decoding for the current layer. When the number of the reconstructed nodes is consistent with the number of the voxel nodes, it is considered that there are no duplicate nodes in the current unit, and the decoding to obtain the attributes of the voxel-level nodes may also be skipped. Thus, on the basis of ensuring the efficiency of encoding and decoding of the attributes of the point cloud, the time complexity of the encoding and decoding of the attributes of the point cloud can be reduced, and the code rate can be saved, thereby improving the encoding and decoding performance of the point cloud.

1. A decoding method, applied to a decoder, the method comprising:
determining a first number of voxel nodes of a current unit and a second number of reconstructed nodes of the current unit, wherein the first number and the second number are used to determine whether to skip decoding the voxel nodes of the current unit; and
determining reconstructed attribute values of the voxel nodes of the current unit according to the first number and the second number.

2. The method of claim 1, further comprising:
when the first number is the same as the second number, skipping decoding the voxel nodes of the current unit.

3. The method of claim 2, wherein determining the reconstructed attribute values of the voxel nodes of the current unit according to the first number and the second number comprises:
when the first number is the same as the second number, setting the reconstructed attribute values of the voxel nodes of the current unit as reconstructed attribute values of the reconstructed nodes of the current unit.

4. The method of claim 1, further comprising:
when the first number is different from the second number, performing attribute decoding on duplicate nodes among the voxel nodes, and skipping decoding remaining voxel nodes other than the duplicate nodes among the voxel nodes.

5. The method of claim 4, wherein determining the reconstructed attribute values of the voxel nodes of the current unit according to the first number and the second number comprises:
when the first number is different from the second number, decoding a bitstream to determine reconstructed attribute values of the duplicate nodes; and
taking the reconstructed attribute values of the duplicate nodes as a reconstructed attribute value of a first reconstructed node of the current unit, and setting reconstructed attribute values of the remaining voxel nodes other than the duplicate nodes among the voxel nodes as reconstructed attribute values of remaining reconstructed nodes other than the first reconstructed node of the current unit.

6. The method of claim 5, wherein decoding the bitstream to determine the reconstructed attribute values of the duplicate nodes comprises:
setting a timer; and
starting the timer when the decoding to determine the reconstructed attribute values of the duplicate nodes begins, and determining that all the reconstructed attribute values of the duplicate nodes are determined through the decoding when a timing of the timer reaches a preset value.

7. The method of claim 6, wherein when the first number is different from the second number, the method further comprises:
determining a third number of the duplicate nodes among the voxel nodes based on a difference between the first number and the second number, wherein the setting of the timer is associated with the third number.

8. The method of claim 1, wherein determining the first number of the voxel nodes of the current unit comprises:
partitioning nodes of the current unit to determine at least one layer; and
when nodes of a last layer are partitioned to a voxel level, determining the voxel nodes of the current unit and the first number of the voxel nodes.

9. The method of claim 8, wherein the at least one layer comprises a current layer, and the method further comprises:
determining a fourth number of nodes of the current layer and a fifth number of child nodes corresponding to the nodes of the current layer, wherein the fourth number and the fifth number are used to determine whether to skip decoding for the current layer; and
determining reconstructed attribute values of the child nodes corresponding to the nodes of the current layer according to the fourth number and the fifth number.

10. The method of claim 9, wherein
the fourth number is configured to represent a number of occupied nodes of the current layer; and
the fifth number is configured to represent a number of occupied child nodes or a number of to-be-decoded nodes among the nodes of the current layer.

11. The method of claim 9, wherein determining the reconstructed attribute values of the child nodes corresponding to the nodes of the current layer according to the fourth number and the fifth number comprises:
when the fourth number is the same as the fifth number, determining reconstructed attribute values of the nodes of the current layer as the reconstructed attribute values of the child nodes corresponding to the nodes of the current layer.

12. The method of claim 9, wherein determining the reconstructed attribute values of the child nodes corresponding to the nodes of the current layer according to the fourth number and the fifth number comprises:
when the fourth number is the same as the fifth number, determining a sixth number of child nodes of a next layer corresponding to the child nodes; and
determining reconstructed attribute values of the child nodes of the next layer corresponding to the child nodes according to the fifth number and the sixth number.

13. The method of claim 9, wherein determining the reconstructed attribute values of the child nodes corresponding to the nodes of the current layer according to the fourth number and the fifth number comprises:
when the fourth number is different from the fifth number, determining prediction attribute values of the child nodes corresponding to the nodes of the current layer according to the nodes of the current layer:
performing a Region Adaptive Hierarchical Transform (RAHT) transform based on the prediction attribute values of the child nodes to determine low-frequency coefficients and reconstructed values of high-frequency coefficients corresponding to the nodes of the current layer; and
performing an inverse RAHT transform based on the low-frequency coefficients and the reconstructed values of the high-frequency coefficients to determine the reconstructed attribute values of the child nodes.

14. The method of claim 13, wherein determining the prediction attribute values of the child nodes corresponding to the nodes of the current layer according to the nodes of the current layer comprises:
determining neighbouring nodes corresponding to the nodes of the current layer; and
determining the prediction attribute values of the child nodes corresponding to the nodes of the current layer according to reconstructed attribute values and a relative distance parameter that correspond to the neighbouring nodes.

15. The method of claim 13, wherein performing the RAHT transform based on the prediction attribute values of the child nodes to determine the low-frequency coefficients and the reconstructed values of the high-frequency coefficients corresponding to the nodes of the current layer comprises:
performing the RAHT transform based on the prediction attribute values of the child nodes to determine the low-frequency coefficients and prediction values of the high-frequency coefficients corresponding to the nodes of the current layer; and
determining the reconstructed values of the high-frequency coefficients corresponding to the nodes of the current layer according to the prediction values of the high-frequency coefficients.

16. The method of claim 15, wherein determining the reconstructed values of the high-frequency coefficients corresponding to the nodes of the current layer according to the prediction values of the high-frequency coefficients comprises:
decoding a bitstream to determine quantized coefficient residuals corresponding to the nodes of the current layer; and
determining the reconstructed values of the high-frequency coefficients corresponding to the nodes of the current layer according to the prediction values of the high-frequency coefficients and the quantized coefficient residuals.

17. The method of claim 16, wherein determining the reconstructed values of the high-frequency coefficients corresponding to the nodes of the current layer according to the prediction values of the high-frequency coefficients and the quantized coefficient residuals comprises:
performing inverse quantization on the quantized coefficient residuals to determine inverse quantized residual values corresponding to the nodes of the current layer; and
determining the reconstructed values of the high-frequency coefficients corresponding to the nodes of the current layer according to the inverse quantized residual values corresponding to the nodes of the current layer and the prediction values of the high-frequency coefficients corresponding to the nodes of the current layer.

18. The method of claim 9, further comprising:
determining geometric information of the nodes of the current layer; and
determining the child nodes corresponding to the nodes of the current layer and the fifth number according to the geometric information.

19. An encoding method, applied to an encoder, the method comprising:
determining a first number of voxel nodes of a current unit and a second number of reconstructed nodes of the current unit; and
determining whether to skip encoding attribute information of the voxel nodes of the current unit according to the first number and the second number.

20. A non-transitory computer-readable storage medium, having a computer program and a bitstream stored thereon, wherein the computer program, when executed by a processor, enables the processor to perform the following operations to generate the bitstream:
determining a first number of voxel nodes of a current unit and a second number of reconstructed nodes of the current unit; and
determining whether to skip encoding attribute information of the voxel nodes of the current unit according to the first number and the second number.
